(19) United States
(12) Patent Application Publication
(10) Pub. No.: US 2026/0155637 A1
(43) Pub. Date: Jun. 4, 2026

(54) SYSTEMS AND METHODS FOR INSULATING POWER LINES IN SITU

(71) Applicant: 899 INC., S Gulfport, FL (US)

(72) Inventors: Evan Turner, S Gulfport, FL (US); Armando Gallegos, S Gulfport, FL (US); Christian Horgan, S Gulfport, FL (US); Lance Adler, S Gulfport, FL (US)

(73) Assignee: 899 INC., S Gulfport, FL (US)

(21) Appl. No.: 19/459,932

(22) Filed: Jan. 26, 2026

Related U.S. Application Data
(63) Continuation of application No. PCT/US2025/032300, filed on Jun. 4, 2025.
(60) Provisional application No. 63/656,544, filed on Jun. 5, 2024.
(60) Provisional application No. 63/712,562, filed on Oct. 28, 2024.
(60) Provisional application No. 63/750,448, filed on Jan. 28, 2025.

(51) Int. Cl. H02G 1/02; H01B 13/08

(52) U.S. Cl. CPC H02G 1/02; H01B 13/08

(57) ABSTRACT

An apparatus for wrapping material around a utility line is provided, the apparatus comprising one or more wheels configured to engage with the utility line and facilitate controlled movement of the apparatus along a length of the utility line; and a material-wrapping subsystem, wherein the material-wrapping subsystem comprises at least one reel configured to hold at least one roll of material; and at least one motor configured to move the at least one reel in an orbital path around the utility line to wrap the utility line using the at least one roll of material as the apparatus moves along the length of the utility line.

### CROSS-REFERENCE TO RELATED APPLICATIONS

This application is a continuation of PCT application No. PCT/US25/32300, filed 4 Jun. 2025, which claims priority from U.S. provisional application No. 63/656,544, filed Jun. 5, 2024, entitled “MOUNTING AND SUPPORT DEVICE AND METHOD FOR INSULATION OF POWER LINES BY UNMANNED AERIAL SYSTEM”, U.S. provisional application No. 63/712,562, filed Oct. 28, 2024, entitled “SYSTEMS AND METHODS FOR INSULATING POWER LINES IN SITU”, and U.S. provisional application No. 63/750,448, filed Jan. 28, 2025, entitled SYSTEMS AND METHODS FOR INSULATING POWER LINES IN SITU, the contents of each of which are hereby incorporated herein by reference in their entirety.

### FIELD

The present disclosure relates generally to power line insulation, and more specifically to systems and methods for insulating power lines after installation in situ.

### BACKGROUND

On average, wildfires burn 5 million acres of land each year in the United States. In total, the United States government spent nearly $ 4.4 billion fighting wildfires in 2021. Wildfires can disrupt critical infrastructure sectors such as transportation, communications, power and gas services, and water supply, and can lead to a deterioration of air quality, and loss of property, crops, resources, animals, and people. Utility-caused wildfires account for about 10% of all wildfires in the United States.

When a utility line (power line, electrical line, high-voltage line, and/or overhead cable) falls down, the line remains energized until the power is shut off by the utility company. During this time, if vegetation on the ground comes in contact with the live utility line, it can spark a fire. Even if the utility line does not collapse, contact with a tree branch or other vegetation can cause a fire. As an example, a tree branch lying between two conductors can produce high-temperature electrical arcs.

While burying utility lines may prevent nearly all such ignitions and the related power outages they cause, this strategy may be very time-consuming and expensive. It is estimated that the cost for each mile of “undergrounding” is up to $4 million or more, and difficult logistics have prevented widespread adoption of the practice. Therefore, there continues to be a need for new strategies to reduce wildfires caused by the contact between live utility lines and vegetation.

### SUMMARY

Accordingly, disclosed herein are systems and methods for wrapping a utility line with insulating material to reduce the risk that the utility line will start a wildfire. Disclosed systems may include an apparatus that may move along the length of a utility line, incrementally wrapping one or more layers of material around the line. The apparatus may include, for example, an attachment subsystem configured to clamp to the utility line and/or to move the apparatus along the utility line, a material-wrapping subsystem configured to wrap one or more layers of material around the utility line, and/or a material-heating subsystem configured to heat an outer layer of material, for example a heat-shrinkable tape to attach the insulating material to the utility line. The apparatus may further include a material-clamping subsystem configured to apply one or more clamps at the beginning and/or end of wrapped section to hold the material in place, and/or a material-cutting subsystem to cut material that has been wrapped around the utility line. These systems may be operated remotely and/or automatically to ensure one or more layers of material are wrapped around the utility line and held in place. Materials included in such layers may be selected to ensure the gradient in electrical field is sufficiently low and/or that the layers may withstand exposure to atmospheric conditions such as wind, rain, and/or ice buildup.

Disclosed systems may additionally include capabilities to deliver the apparatus to the utility line and/or to align the apparatus with the utility line. For example, disclosed systems may include an unmanned aerial vehicle (UAV) such as a heavy-lift drone that may be used to transport the apparatus to a section of utility line. The UAV may be connected to a winching system that may extend and/or retract a wire connected to an aerial positioning device attached to the apparatus and used to align the apparatus with the utility line using one or more lateral-facing propellers. For example, the winch may control a vertical position of the apparatus while the aerial positioning device may control one or more horizontal positions of the apparatus. The apparatus may be connected to the aerial positioning device using one or more couplings, for example hook-and-loop couplings and/or electromagnetic couplings. Once the apparatus has been positioned above a section of utility line to be coated, for example using the UAV and aerial positioning device, the one or more couplings may be disconnected to detach the apparatus from the aerial positioning device and to install the apparatus onto the utility line.

To operate disclosed systems for wrapping material around utility lines, an operator may first operate the UAV to transport the aerial positioning device and apparatus to a utility line to be wrapped with one or more layers of material. The operator may next operate the aerial positioning system to align the apparatus with the utility line, for example by using the winch to adjust a vertical position of the apparatus and/or one or more of the lateral-facing propellers of the aerial positioning device to adjust one, two, or more horizontal positions of the apparatus. For example, by lowering the apparatus onto the utility line using the winch, the operator may install the apparatus onto the utility line. Once the apparatus is aligned to the utility line, the operator may detach the one or more one couplings connecting the apparatus to the aerial positioning device thereby enabling the apparatus to move along the length of utility line section to be wrapped. To detach the one or more couplings, the operator may move the aerial positioning device to detach, for example, a hook-and-loop coupling. Alternatively or additionally, the operator may detach the one or more couplings by modifying an electrical current flowing to, for example, an electromagnetic coupling. For example, an operator may reduce the current to release the coupling.

To operate the UAV and/or aerial positioning device, an operator may rely on their own eyesight or on one or more cameras located on the UAV and/or aerial positioning device. Once the apparatus is installed on a utility line, the operator may operate the apparatus to move the apparatus along the utility line, wrap one or more materials around the utility line, and/or heat one or more of the one or more materials to attach the one or more materials to the utility line. In this manner, a section of utility line, for example a section located between utility line poles may be coated.

Once the section has been coated, the operator may use disclosed systems to transport the apparatus to another section, for example, a different section of the same line, or a different line between the same two utility line poles. To accomplish this, the operator may operate the UAV to transport the aerial positioning system to the utility line, and may operate the aerial positioning device to align the aerial positioning device with the apparatus. For example, the winching system may be used to adjust a vertical position of the apparatus while the lateral-facing propellers of the aerial positioning device may be used to adjust one, two, or more horizontal positions of the apparatus. The one or more couplings may then be attached and/or connected together to connect the apparatus to the aerial positioning device. For example, to attach a hook-and-loop coupling, the operator may move the aerial positioning device. Alternatively or additionally, the operator may attach an electromagnetic coupling by modifying an electrical current flowing to the coupling. For example, an operator may increase the current to attach the coupling. The operator may then operate the UAV to transport the system including the apparatus to a second utility line as mentioned above or to a maintenance station, for example a maintenance station located on the ground in the vicinity of the utility lines being coated.

In some embodiments, an apparatus for wrapping material around a utility line is provided, the apparatus comprising one or more wheels configured to engage with the utility line and facilitate controlled movement of the apparatus along a length of the utility line; and a material-wrapping subsystem, wherein the material-wrapping subsystem comprises at least one reel configured to hold at least one roll of material; and at least one motor configured to move the at least one reel in an orbital path around the utility line to wrap the utility line using the at least one roll of material as the apparatus moves along the length of the utility line.

In some embodiments, the apparatus further comprises an attachment subsystem comprising an upper bearing and a lower bearing, wherein at least one of the upper bearing or the lower bearing is moveable to clamp the utility line between the upper bearing and the lower bearing. In some embodiments, the apparatus further comprises one or more guide rails for aligning the upper bearing and the lower bearing. In some embodiments, the clamping of the utility line between the upper bearing and the lower bearing removably attaches the apparatus to the utility line. In some embodiments, the upper bearing is attached to an upper block and the lower bearing is attached to a lower block; and the lower block is moved using an actuator to clamp the utility line between the upper bearing and the lower bearing. In some embodiments, at least one of the lower bearing or the upper bearing is rotated by a motor to move the apparatus along the length of the utility line. In some embodiments, the material-wrapping subsystem comprises a drive pulley wheel coupled to the at least one motor; a plurality of driven pulley wheels coupled to the drive wheel; and a plurality of guide wheels attached to the plurality of driven pulley wheels and coupled to a plate mounted to the at least one reel; wherein rotation of the at least one motor causes rotation of the drive pulley wheel, the plurality of driven pulley wheels, the plurality of guide wheels, and the plate mounted to the at least one reel; and wherein rotation of the plate mounted to the at least one reel causes the at least one reel to move in an orbital path around a center point of the material-wrapping subsystem to wrap the utility line using the at least one roll of material. In some embodiments, the material-wrapping subsystem further comprises a timing belt that couples the drive pulley wheel to the plurality of driven pulley wheels; and the plurality of guide wheels, to couple to the plate mounted to the at least one reel, contact a slot within the plate. In some embodiments, the at least one material of the at least one roll of material is selected from the set consisting of: electrically semi-conductive, electrically insulating, heat-shrinkable, durable, waterproof, and anti-abrasion. In some embodiments, the at least one material has two or more of the following properties: electrically semi-conductive, electrically insulating, heat-shrinkable, durable, waterproof and anti-abrasion.

In some embodiments, the at least one material comprises a film or tubing that comprises a fluoropolymer. In some embodiments, the film or tubing comprises at least 50% or more fluoropolymer. In some embodiments, the at least one material comprises at least one of a polyimide or a Passive Radiative Cooling (PRC) film. In some embodiments, the material-wrapping subsystem is configured to wrap the utility line in one or more layers of material. In some embodiments, the one or more materials of the one or more layers of material are selected from the set consisting of: electrically semi-conductive, electrically insulating, heat-shrinkable, durable, waterproof, and anti-abrasion. In some embodiments, the one or more materials comprise a film or tubing that comprises a fluoropolymer. In some embodiments, the film or tubing comprises at least 50% or more fluoropolymer. In some embodiments, the one or more materials comprise at least one of a polyimide or a Passive Radiative Cooling (PRC) film. In some embodiments, the apparatus further comprises a material-heating subsystem placed downstream of the material-wrapping subsystem. In some embodiments, the material-heating subsystem comprises a fan, a heating element, and a nozzle; wherein the fan is configured to blow air across the heating element and through a nozzle; and wherein the nozzle is configured to direct heated air onto the material wrapped around the utility line by the material-wrapping subsystem. In some embodiments, the material-heating subsystem further comprises a plate configured to be placed on a side of the utility line that is opposite to the heating element and to trap heated air directed onto the material wrapped around the utility line. In some embodiments, the plate is configured to be moved into and out of proximity with the utility line using a rack-and-pinion system. In some embodiments, the plate comprises a low-emissivity coating to reflect heat radiating from the heating element. In some embodiments, the apparatus further comprises a material-clamping subsystem configured to place one or more clamps around the material wrapped around the utility line. In some embodiments, the material-clamping subsystem is configured to apply the one or more clamps around at least one of a beginning of the material wrapped around the utility line or an end of the material wrapped around the utility line. In some embodiments, the material-clamping subsystem comprises a clamp pusher comprising a spring-loaded magazine housing one or more clamps; and a linear actuator configured to lift the one or more clamps onto the utility line; and a clamp tightener comprising a tubing; and an actuator configured to squeeze and tighten the one or more clamps around the material wrapped around the utility line. In some embodiments, the apparatus further comprises a material-cutting subsystem, wherein the material-cutting subsystem comprises a linear actuator and a cutting blade; and the material-cutting subsystem is configured to cut the material wrapped around the utility line. In some embodiments, the apparatus further comprises a charging circuit configured to draw parasitic power from the utility line to charge the apparatus. In some embodiments, the apparatus further comprises a rotational battery system, wherein the rotational battery system comprises three batteries; each battery is assigned one state selected from a group comprising: charging, cooling, and powering the apparatus; and the state of each battery is dependent on the state of the other batteries in the rotational battery system.

In some embodiments, a system for transporting and aligning an apparatus for wrapping material around a utility line is provided, the system comprising an unmanned aerial vehicle for transporting the apparatus to the utility line; an aerial positioning device connected to the unmanned aerial vehicle and configured to align the apparatus with the utility line; and one or more couplings for connecting to the apparatus. In some embodiments, the aerial positioning device comprises propellers configured to move the apparatus in at least one horizontal direction to align the apparatus with the utility line. In some embodiments, the aerial positioning device comprises propellers configured to move the apparatus in at least two horizontal directions to align the apparatus with the utility line. In some embodiments, the aerial positioning device further comprises a winch connected to the unmanned aerial vehicle and the aerial positioning device and configured to move the apparatus in a vertical direction to install the apparatus on the utility line or uninstall the apparatus from the utility line. In some embodiments, the one or more couplings comprise at least one of a hook-and-loop coupling or an electromagnetic coupling.

In some embodiments, a method of operating a system for transporting and aligning an apparatus for wrapping material around a utility line is provided, the method comprising operating an unmanned aerial vehicle to transport the apparatus to the utility line; operating an aerial positioning device connected to the unmanned aerial vehicle to align the apparatus with the utility line and install the apparatus onto the utility line; and detaching one or more couplings connecting the apparatus to the aerial positioning device.

In some embodiments, at least one of operating the unmanned aerial vehicle or operating the aerial positioning device is based on at least one of an operator's eyesight or a camera located on at least one of the unmanned aerial vehicle or the aerial positioning device. In some embodiments, operating an aerial positioning device comprises moving the apparatus in at least one horizontal direction to align the apparatus with the utility line. In some embodiments, operating an aerial positioning device comprises moving the apparatus in at least two horizontal directions to align the apparatus with the utility line. In some embodiments, operating an aerial positioning device comprises moving the apparatus in a vertical direction to install the apparatus on the utility line or uninstall the apparatus from the utility line. In some embodiments, detaching the one or more couplings connecting the apparatus to the aerial positioning device comprises moving the aerial positioning device to detach at least one hook-and-loop coupling. In some embodiments, detaching the one or more couplings connecting the apparatus to the aerial positioning device comprises modifying an electrical current flowing to at least one electromagnetic coupling. In some embodiments, the method further comprises operating the apparatus to move the apparatus along the utility line; to wrap at least one material around the utility line; and to heat the least one material to attach it to the utility line. In some embodiments, the method further comprises operating the unmanned aerial vehicle to transport the aerial positioning device to the utility line; operating the aerial positioning device connected to the unmanned aerial vehicle to align the aerial positioning device with the apparatus; attaching the one or more couplings connecting the apparatus to the aerial positioning device; and operating the unmanned aerial vehicle to transport the apparatus to a second utility line or a maintenance station. In some embodiments, the at least one material comprises a film or tubing that comprises a fluoropolymer. In some embodiments, the film or tubing comprises at least 50% or more fluoropolymer.

Disclosed herein is an apparatus for wrapping material around a utility line, the apparatus comprising: one or more wheels configured to engage with the utility line and facilitate controlled movement of the apparatus along a length of the utility line; and a material-wrapping subsystem, wherein the material-wrapping subsystem comprises: at least one reel configured to hold at least one roll of material; and at least one motor configured to move the at least one reel in an orbital path around the utility line to wrap the utility line using the at least one roll of material as the apparatus moves along the length of the utility line.

In some embodiments, the apparatus further comprises: an attachment subsystem comprising an upper bearing and a lower bearing, wherein at least one of the upper bearing or the lower bearing is moveable to clamp the utility line between the upper bearing and the lower bearing. In some embodiments, the apparatus further comprises one or more guide rails for aligning the upper bearing and the lower bearing. In some embodiments, the clamping of the utility line between the upper bearing and the lower bearing removably attaches the apparatus to the utility line. In some embodiments, the upper bearing is attached to an upper block and the lower bearing is attached to a lower block; and the lower block is moved using an actuator to clamp the utility line between the upper bearing and the lower bearing. In some embodiments, least one of the lower bearing or the upper bearing is rotated by a motor to move the apparatus along the length of the utility line.

In some embodiments, the material-wrapping subsystem further comprises: a drive pulley wheel coupled to the at least one motor; a plurality of driven pulley wheels coupled to the drive wheel; and a plurality of guide wheels attached to the plurality of driven pulley wheels and coupled to a plate mounted to the at least one reel; wherein rotation of the at least one motor causes rotation of the drive pulley wheel, the plurality of driven pulley wheels, the plurality of guide wheels, and the plate mounted to the at least one reel; and wherein rotation of the plate mounted to the at least one reel causes the at least one reel to move in an orbital path around a center point of the material-wrapping subsystem to wrap the utility line using the at least one roll of material. In some embodiments, the material-wrapping subsystem further comprises a timing belt that couples the drive pulley wheel to the plurality of driven pulley wheels; and the plurality of guide wheels, to couple to the plate mounted to the at least one reel, contact a slot within the plate.

In some embodiments, the at least one material of the at least one roll of material is selected from the set consisting of: electrically semi-conductive, electrically insulating, heat-shrinkable durable, waterproof, and anti-abrasion. In some embodiments, the at least one material comprises a film or tubing that comprises a fluoropolymer. In some embodiments, the film or tubing comprises at least 50% or more fluoropolymer. In some embodiments, the at least one material comprises at least one of a polyimide or a Passive Radiative Cooling (PRC) film. In some embodiments, the material-wrapping subsystem is configured to wrap the utility line in one or more layers of material. In some embodiments, the one or more materials of the one or more layers of material is selected from the set consisting of: electrically semi-conductive, electrically insulating, heat-shrinkable, durable, waterproof, and anti-abrasion. In some embodiments, the one or more materials comprise a film or tubing that comprises a fluoropolymer. In some embodiments, the film or tubing comprises at least 50% or more fluoropolymer. In some embodiments, the one or more materials comprise at least one of a polyimide or a Passive Radiative Cooling (PRC) film.

In some embodiments, the apparatus further comprises: a material-heating subsystem placed downstream of the material-wrapping subsystem. In some embodiments, the material-heating subsystem comprises one or more laser diodes to heat the material wrapped around the utility line. In some embodiments, the material-heating subsystem comprises resistance wire to heat the material wrapped around the utility line. In some embodiments, material-heating subsystem comprises a fan, a heating element, and a nozzle, wherein the fan is configured to blow air across the heating element and through a nozzle; and wherein the nozzle is configured to direct heated air onto the material wrapped around the utility line by the material-wrapping subsystem.

In some embodiments, the apparatus further comprises a material-clamping subsystem configured to place one or more clamps around the material wrapped around the utility line. In some embodiments, the material-clamping subsystem is configured to apply the one or more clamps around at least one of a beginning of the material wrapped around the utility line or an end of the material wrapped around the utility line. In some embodiments, the material-clamping subsystem comprises: a clamp pusher comprising: a spring-loaded magazine housing one or more clamps; and a linear actuator configured to lift the one or more clamps onto the utility line; and a clamp tightener comprising: a tubing; and an actuator configured to squeeze and tighten the one or more clamps around the material wrapped around the utility line.

In some embodiments, the apparatus further comprises a material-cutting subsystem, wherein: the material-cutting subsystem comprises a linear actuator and a cutting blade; and the material-cutting subsystem is configured to cut the material wrapped around the utility line. In some embodiments, the apparatus further comprises a charging circuit configured to draw parasitic power from the utility line to charge the apparatus.

In some embodiments, the apparatus further comprises a rotational battery system, wherein: the rotational battery system comprises three batteries; each battery is assigned one state selected from a group comprising: charging, cooling, and powering the apparatus; and the state of each battery is dependent on the state of the other batteries in the rotational battery system.

Disclosed herein is a system for transporting and aligning an apparatus for wrapping material around a utility line, the system comprising: an unmanned aerial vehicle for transporting the apparatus to the utility line; an aerial positioning device connected to the unmanned aerial vehicle and configured to align the apparatus with the utility line; and one or more couplings for connecting to the apparatus.

In some embodiments, the aerial positioning device comprises one or more propellers configured to move the apparatus in at least one horizontal direction to align the apparatus with the utility line. In some embodiments, the one or more propellors have a fixed orientation with respect to the aerial positioning device. In some embodiments, the one or more propellors have an adjustable orientation with respect to the aerial positioning device. In some embodiments, the aerial positioning device comprises one or more propellers configured to move the apparatus in at least two horizontal directions to align the apparatus with the utility line. In some embodiments, the aerial positioning device comprises one or more propellers configured to adjust a rotational orientation of the apparatus with the utility line.

In some embodiments, the one or more propellers are oriented perpendicular with respect to an operative axial center-line of the aerial positioning device that is configured to be aligned with the utility line for placement of the apparatus on the utility line, and wherein the one or more propellers are off-center with respect to an operative perpendicular-to-axial center-line of the aerial positioning device. In some embodiments, aerial positioning device comprises a wheel device wheel configured to adjust a rotational orientation of the apparatus with the utility line, the wheel device selected from the set consisting of: a reaction wheel and a momentum wheel. In some embodiments, the aerial positioning device provides no vertical thrust. In some embodiments, the aerial positioning device has a conical shape.

In some embodiments, the aerial positioning device further comprises a winch connected to the unmanned aerial vehicle and the aerial positioning device and configured to move the apparatus in a vertical direction to install the apparatus on the utility line or uninstall the apparatus from the utility line. In some embodiments, the one or more couplings comprise at least one of a hook-and-loop coupling or an electromagnetic coupling. In some embodiments, the one or more couplings comprise one or more pins driven by a servomechanism. In some embodiments, the one or more couplings are provided as part of the aerial positioning device.

Disclosed herein is a method of operating a system for transporting and aligning an apparatus for wrapping material around a utility line, the method comprising: operating an unmanned aerial vehicle to transport the apparatus to the utility line; operating an aerial positioning device connected to the unmanned aerial vehicle to align the apparatus with the utility line and install the apparatus onto the utility line; and detaching one or more couplings connecting the apparatus to the aerial positioning device.

In some embodiments, at least one of operating the unmanned aerial vehicle or operating the aerial positioning device is based on at least one of an operator's eyesight or a camera located on at least one of the unmanned aerial vehicle or the aerial positioning device. In some embodiments, operating an aerial positioning device comprises moving the apparatus in at least one horizontal direction to align the apparatus with the utility line. In some embodiments, operating an aerial positioning device comprises moving the apparatus in at least two horizontal directions to align the apparatus with the utility line. In some embodiments, operating an aerial positioning device comprises moving the apparatus in a vertical direction to install the apparatus on the utility line or uninstall the apparatus from the utility line. In some embodiments, detaching the one or more couplings connecting the apparatus to the aerial positioning device comprises moving the aerial positioning device to detach at least one hook-and-loop coupling.

In some embodiments, detaching the one or more couplings connecting the apparatus to the aerial positioning device comprises modifying an electrical current flowing to at least one electromagnetic coupling. In some embodiments, operating the apparatus to: move the apparatus along the utility line; wrap at least one material around the utility line; and heat the at least one material to attach it to the utility line.

In some embodiments, operating the unmanned aerial vehicle to transport the aerial positioning device to the utility line; operating the aerial positioning device connected to the unmanned aerial vehicle to align the aerial positioning device with the apparatus; attaching the one or more couplings connecting the apparatus to the aerial positioning device; and operating the unmanned aerial vehicle to transport the apparatus to a second utility line or a maintenance station. In some embodiments, the at least one material comprises a film, wrap, or tubing comprising a fluoropolymer. In some embodiments, the film, wrap, or tubing comprises at least 50% or more fluoropolymer.

Disclosed herein is a utility line covered with layers of material, wherein the layers comprise (i) one or more layers comprising a semi-conductive material; (ii) one or more layers comprising an insulating material; and (iii) one or more layers comprising a durable, waterproof, and/or anti-abrasion material, wherein the semi-conductive material comprises an innermost layer closest to the utility line, and the durable, waterproof, and/or anti-abrasion material comprises an outermost layer furthest from the utility line.

In some embodiments, the semi-conductive material, the insulating material, and/or the durable, waterproof, and/or anti-abrasion material is a tape or wrap capable of being wrapped around the utility line. In some of any embodiments, the layers of material prevent or reduce the occurrence of wildfires by lessening the contact of the utility line with vegetation. In some of any embodiments, the utility line is an installed utility line. In some of any embodiments, the utility line is a live utility line. In some of any embodiments, the outermost layer comprises a material comprising at least 10%, 15%, 20%, 25%, 30%, 35%, 40%, 45%, 50%, 55%, 60%, 65%, 70%, 75%, 80%, 85%, 90%, 95% fluoropolymer. In some embodiments, the fluoropolymer comprises one or more of PTFE (polytetrafluoroethylene), PFA (perfluoroalkoxy fluorocarbon), FEP (fluorinated ethylene-propylene), PCTFE (polychlorotrifluoroethylene), ETFE (ethylene tetrafluoroethylene), ECTFE (ethylene chlorotrifluoroethylene), and PVDF (polyvinylidene fluoride). In some of any embodiments, the fluoropolymer comprises ETFE (ethylene tetrafluoroethylene). In some of any embodiments, the outermost layer comprises a material comprising at least 10%, 15%, 20%, 25%, 30%, 35%, 40%, 45%, 50%, 55%, 60%, 65%, 70%, 75%, 80%, 85%, 90%, 95% ETFE.

Disclosed herein is a utility line covered with layers of material, wherein the layers comprise (i) one layer comprising a semi-conductive nylon tape; (ii) three layers comprising a silicone tape; and (iii) one layer comprising a fluoropolymer, wherein the semi-conductive nylon tape comprises the innermost layer closest to the utility line, and the fluoropolymer layer comprises the outermost layer furthest from the utility line.

In some embodiments, the order of the layers of the material from closest to the utility line to furthest from the utility line is: one layer of the semi-conductive nylon tape, three layers comprising a silicone tape, and one layer comprising a fluoropolymer. In some of any embodiments, an inorganic material is integrated into the outermost layer. In some of any embodiments, an inorganic material is layered into the outermost layer. In some of any embodiments, the inorganic material comprises one or more of mica, glass, synthetic mica, large flake muscovite made into a thin flexible film (hand laid mica on kapton), boron nitride, alumina, silica, titanium dioxide, silicon nitride, montmorillonite, calcium silicate, and zinc oxide. In some of any embodiments, the outermost layer is heated to activate self-sealing. In some of any embodiments, the outermost layer is waterproof and abrasion-resistant.

Disclosed herein is a method for reducing the fire danger of a utility line, comprising wrapping one or more layers of materials around the utility line, wherein at least one of the layers of material comprises a material comprising a fluoropolymer. In some embodiments, the material comprising a fluoropolymer comprises a material comprising at least 10%, 15%, 20%, 25%, 30%, 35%, 40%, 45%, 50%, 55%, 60%, 65%, 70%, 75%, 80%, 85%, 90%, 95% fluoropolymer. In some of any embodiments, the fluoropolymer comprises one or more of PTFE (polytetrafluoroethylene), PFA (perfluoroalkoxy fluorocarbon), FEP (fluorinated ethylene-propylene), PCTFE (polychlorotrifluoroethylene), ETFE (ethylene tetrafluoroethylene), ECTFE (ethylene chlorotrifluoroethylene), and PVDF (polyvinylidene fluoride). In some of any embodiments, the fluoropolymer comprises ETFE (ethylene tetrafluoroethylene).

In some of any embodiments, the one or more layers of material further comprise one or more layers of a semi-conductive material and one or more layers of insulating material. In some embodiments, the semi-conductive material is selected from the set consisting of: ethylene propylene rubber (EPR); ethylene propylene diene monomer (EPDM) rubber; and nylon. In some of any embodiments, the insulating material is selected from the set consisting of: rubber, polyethylene, silicone, fiberglass, aluminum, ethylene propylene, thermal-based ceramic powder, polyvinyl chloride, and polyimide.

In some of any embodiments, an inorganic material is integrated into the fluoropolymer layer. In some of any embodiments, an inorganic material is layered into the fluoropolymer layer. In some of any embodiments, the inorganic material comprises one or more of mica, glass, synthetic mica, large flake muscovite made into a thin flexible film (hand laid mica on kapton), boron nitride, alumina, silica, titanium dioxide, silicon nitride, montmorillonite, calcium silicate, and zinc oxide. In some of any embodiments, the fluoropolymer layer is heated to activate self-sealing. In some of any embodiments, the fluoropolymer layer is waterproof and abrasion-resistant.

In some of any embodiments, the wrapping of the materials around the utility line is performed in a factory setting. In some of any embodiments, the wrapping of the materials around the utility line is performed on a pre-existing, installed utility line. In some of any embodiments, the wrapping of the materials around the utility line is performed on a live pre-existing, installed utility line. In some of any embodiments, the primary voltage of the live utility line is over 100V, 200V, 300V, 400V, 500V, 600V, 700V, 800V, 900V, or 1000V. In some of any embodiments, the primary voltage of the live utility line is over 600V.

In some of any embodiments, the wrapping is performed by an apparatus, wherein the apparatus comprises: one or more wheels configured to engage with the utility line and facilitate controlled movement of the apparatus along a length of the utility line; and a material-wrapping subsystem, wherein the material-wrapping subsystem comprises: at least one reel configured to hold at least one roll of material; and at least one motor configured to move the at least one reel in an orbital path around the utility line to wrap the utility line using the at least one roll of material as the apparatus moves along the length of the utility line.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE DRAWINGS

A better understanding of the features and advantages of the present disclosure will be obtained by reference to the following detailed description that sets forth illustrative embodiments, in which the principles of the disclosure are utilized, and the accompanying figures of which:

FIG. 1 depicts a perspective view of a system that may include an unmanned aerial vehicle, an extension arm, and an apparatus for wrapping layers of material (e.g. semi-conductive, insulating, durable) around a utility line, wherein the apparatus travels down the utility line while wrapping the line in layers or multiple materials, according to some embodiments.

FIG. 2A depicts a side view of a system that may include an unmanned aerial vehicle, a winch, an aerial positioning device, and an apparatus for wrapping layers of material, according to some embodiments.

FIG. 2B depicts a system that may include an unmanned aerial vehicle, a winch, an aerial positioning device, an apparatus for wrapping layers of material, and a control device according to some embodiments.

FIG. 3 depicts a perspective view of an apparatus and included subsystems, according to some embodiments.

FIG. 4A depicts a perspective view of an apparatus and included subsystems, according to some embodiments.

FIG. 4B depicts an axial view of an apparatus and included subsystems, according to some embodiments.

FIG. 4C depicts a top view of an apparatus and included subsystems, according to some embodiments.

FIG. 5A depicts a perspective view of a clamping system of the apparatus showing how the apparatus attaches to a utility line, according to some embodiments.

FIG. 5B depicts an axial view of a clamping system of the apparatus showing how the apparatus attaches to a utility line, according to some embodiments.

FIG. 5C depicts a side view of a clamping system of the apparatus showing how the apparatus attaches to a utility line, according to some embodiments.

FIG. 5D depicts a top view of a clamping system of the apparatus showing how the apparatus attaches to a utility line, according to some embodiments.

FIG. 6A depicts a perspective view of a material-wrapping subsystem of the apparatus showing how layers of materials are wrapped around a utility line, according to some embodiments.

FIG. 6B depicts a side view of a material-wrapping subsystem of the apparatus showing how layers of materials are wrapped around a utility line, according to some embodiments.

FIG. 6C depicts an axial view of a material-wrapping subsystem of the apparatus showing how layers of materials are wrapped around a utility line, according to some embodiments.

FIG. 7A depicts a perspective view of a material-wrapping subsystem of the apparatus showing how layers of materials are wrapped around a utility line, according to some embodiments.

FIG. 7B depicts a top view of a material-wrapping subsystem of the apparatus showing how layers of materials are wrapped around a utility line, according to some embodiments.

FIG. 7C depicts a side view of a material-wrapping subsystem of the apparatus showing how layers of materials are wrapped around a utility line, according to some embodiments.

FIG. 8A depicts a perspective view of a material-heating subsystem for heating a heat-shrinkable wrapped material, according to some embodiments.

FIG. 8B depicts an axial view of a material-heating subsystem for heating a heat-shrinkable wrapped material, according to some embodiments.

FIG. 8C depicts a top view of a material-heating subsystem for heating a heat-shrinkable wrapped material, according to some embodiments.

FIG. 9A depicts a perspective view of a material-clamping subsystem of the apparatus showing how a clamp is applied to the utility line, over the layers of wrapped materials, according to some embodiments.

FIG. 9B depicts a perspective view of a material-clamping subsystem of the apparatus showing how a clamp is applied to the utility line, over the layers of wrapped materials, according to some embodiments.

FIG. 9C depicts a side view of a material-clamping subsystem of the apparatus showing how a clamp is applied to the utility line, over the layers of wrapped materials, according to some embodiments.

FIG. 9D depicts a perspective view of a material-clamping subsystem of the apparatus showing how a clamp is applied to the utility line, over the layers of wrapped materials, according to some embodiments.

FIG. 10 depicts a side view of a material-cutting subsystem of the apparatus, wherein the cutting blade is used to cut the materials that had been wrapped around the utility line, according to some embodiments.

FIG. 11A depicts a perspective view of an electronics box located underneath the UAV and the retractable extension arm(s) which serve to attach the UAV to the apparatus, according to some embodiments.

FIG. 11B depicts a side view of an electronics box located underneath the UAV and the retractable extension arm(s) which serve to attach the UAV to the apparatus, according to some embodiments.

FIG. 12A depicts a perspective view of an aerial positioning device, in accordance with some embodiments.

FIG. 12B depicts a side view of an aerial positioning device, in accordance with some embodiments.

FIG. 12C depicts an overhead view of an aerial positioning device, in accordance with some embodiments.

FIG. 12D depicts a bottom view of an aerial positioning device, in accordance with some embodiments.

FIG. 13A depicts a perspective view of a frame and propulsion system of an aerial positioning device, in accordance with some embodiments.

FIG. 13B depicts a side view of a frame and propulsion system of an aerial positioning device, in accordance with some embodiments.

FIG. 13C depicts an overhead view of a frame and propulsion system of an aerial positioning device, in accordance with some embodiments.

FIG. 14A depicts a top perspective view of an attachment system, in accordance with some embodiments.

FIG. 14B depicts a bottom perspective view of an attachment system, in accordance with some embodiments.

FIG. 14C depicts a side view of an attachment system, in accordance with some embodiments.

FIG. 14D depicts a top view of an attachment system, in accordance with some embodiments.

FIG. 15 depicts a computer system, in accordance with some embodiments.

FIG. 16 depicts a side view of the apparatus with a self-balancing system comprising two arms comprising a propeller on each arm, in accordance with some embodiments.

### DETAILED DESCRIPTION

Disclosed herein is an apparatus that may move along the length of a utility line, for example a live or energized utility line and/or a non-energized utility line, while wrapping the utility line in one or more layers of material. Specifically, the layers of material may include materials that serve to insulate the utility line and/or to boost the capacity of the utility line.

For example, materials wrapped around the utility line may include semi-electrically conductive tape that may control partial electrical discharge between the utility line and one or more outer layers of material. Additionally or alternatively, materials wrapped around the utility line may include an electrically insulating layer to create a potential gradient between the utility line which may be energized and/or at high potential and the exterior layers of material which may be at ground potential. In this way, the risk of discharges and/or arcing between the utility line and trees and/or vegetation may be reduced. Additionally or alternatively, materials wrapped around the utility line may include a durable fabric material such as a material with a high abrasion resistance and/or a high tensile strength. For example, this outer layer may take the form of a heat-shrinkable tape that may also provide waterproofing for the layers of material.

This material may be wrapped around the utility line using systems and methods disclosed herein. Following transportation to and installation onto the utility line, an exemplary apparatus may attach to the utility line using an attachment subsystem that may clamp the utility line between two bearings and drive one or more of the bearings using a motor to move along the utility line. An exemplary apparatus may next begin to wrap one or more layers of material around the utility line using a material-wrapping subsystem, for example a system that may use a set of wheels and a timing pulley to move one or more rolls of material in an orbital path around the utility line. An exemplary apparatus may next heat the wrapped one or more layers of material using a material-heating subsystem, for example the exterior heat-shrinkable tape layer, thereby shrinking the tape layer onto the insulating layers below ensuring the insulating layers remain attached to the utility line. To accomplish this, an exemplary material-heating subsystem may include a fan blowing air over a heating element which is then directed onto a wrapped utility line, with the heated air optionally being trapped by a plate moved into place below the utility line, thereby increasing the temperature and improving the thermal uniformity of the material being heated.

An exemplary apparatus may next further attach the material to the utility line using a material-clamping subsystem that may include a pushing component to place a clamp onto the utility line and a tightening component to apply force to a clamp to attach it to the materials surrounding a utility line. Additionally or alternatively, an exemplary apparatus may use a material-cutting subsystem to cut material once a section of utility line has been wrapped. An exemplary material-cutting subsystem may include a cutting blade and a linear actuator to drive the cutting blade such that it intersects with and severs the connection between the one or more rolls of material and the utility line. The housing of the apparatus and each subsystem may have cutouts to receive the utility line and/or enable motion of the various subsystems such as the movement of the one or more rolls of material of the material-wrapping subsystem.

In this manner, disclosed systems may coat one or more sections of utility lines, ensuring the high potential of live electrical lines may be isolated for long utility line stretches, thereby reducing the likelihood energy will discharge to trees and/or other vegetation, in turn reducing the likelihood of the utility line causing a wildfire.

Also disclosed herein is an aerial positioning device which may be joined to an unmanned aerial vehicle (UAV). An exemplary aerial positioning device may be joined to an UAV by way of a winch, wherein the exemplary aerial positioning device may be suspended by a cable beneath the UAV and releasably connected to the apparatus. The exemplary aerial positioning device may release the apparatus on to the utility line to allow the apparatus to wrap the utility line in one or more layers of material. At the completion of the wrapping, the exemplary aerial positioning device may be positioned over the apparatus by way of the UAV, wherein the exemplary aerial positioning device may rigidly connect to the apparatus in order to lift and remove the apparatus from the utility line and move it to another utility line or return it to the ground.

### I. DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a,” “an,” and “the” include plural referents unless the context clearly dictates otherwise. For example, “a” or “an” means “at least one” or “one or more.” It is understood that aspects, embodiments, and variations described herein include “comprising,” “consisting,” and/or “consisting essentially of” aspects, embodiments and variations. The terminology includes the words noted above, derivatives thereof and words of similar import.

The term “about” as used herein refers to the usual error range for the respective value readily known to the skilled person in this technical field. Reference to “about” a value or parameter herein includes (and describes) embodiments that are directed to that value or parameter per se. For example, description referring to “about X” includes description of “X”.

In some embodiments, about a value or parameter intends the value or parameter plus or minus any one of 10 or 9 or 8 or 7 or 6 or 5 or 4 or 3 or 2 or 1 or 0.5 or 0.25 or 0.1 %. For example, in some embodiments, “about X” intends X plus or minus any one of 10 or 9 or 8 or 7 or 6 or 5 or 4 or 3 or 2 or 1 or 0.5 or 0.25 or 0.1% of X.

The terms “utility line”, “power line”, “electrical line” as used herein are intended to include any line, wire, cable, etc. in a power grid through which electricity flows, regardless of the voltage carried by the line and whether such a line, wire, cable, etc. might be conventionally considered part of a transmission system, distribution system, or any other portion of a power grid. In this regard, embodiments of the invention may be used to perform work on any elevated electricity-carrying line, wire, cable, etc.

Directional terminology including, but not limited to, “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Certain terminology is used in the following description for convenience only and is not limiting.

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

All publications, including patent documents, scientific articles and databases, referred to in this application are hereby incorporated herein by reference in their entireties for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

The section headings used herein are for organizational purposes only and are not to be construed as limiting the subject matter described.

### II. APPARATUS

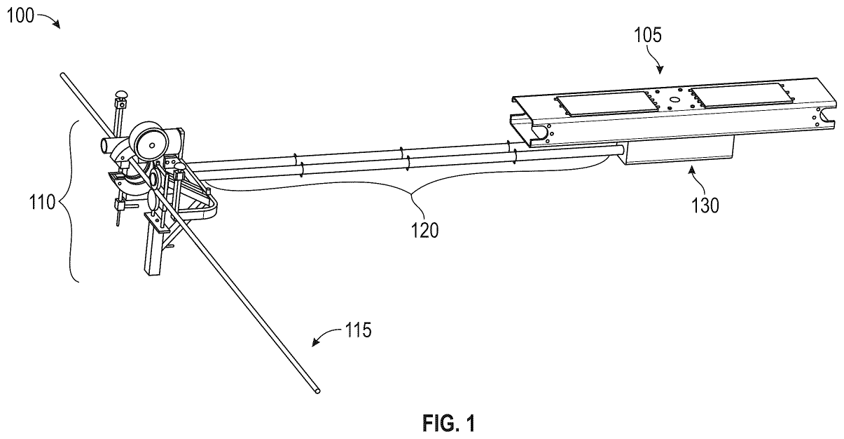

FIG. 1 depicts a perspective view of an exemplary system 100 including an electromechanical apparatus that may wrap various materials around a utility line such as utility line 115. The system 100 may include an unmanned aerial vehicle (UAV) 105, and electromechanical apparatus 110 for wrapping materials around a utility line, a retractable extension arm 120, and a battery system 130. The UAV 105 may be referred to as a drone and/or an unmanned aerial system. In some embodiments, the UAV body 105 is removably attached to the apparatus 110 by way of a retractable extension arm 120. In some embodiments, an electronics box may include the battery system 130 and may be attached below the UAV 105. UAV 105 may be configured to deliver and/or guide apparatus 110 as it travels along the utility line, wrapping material and/or applying heat to shrink the material onto the utility line, as discussed in greater below.

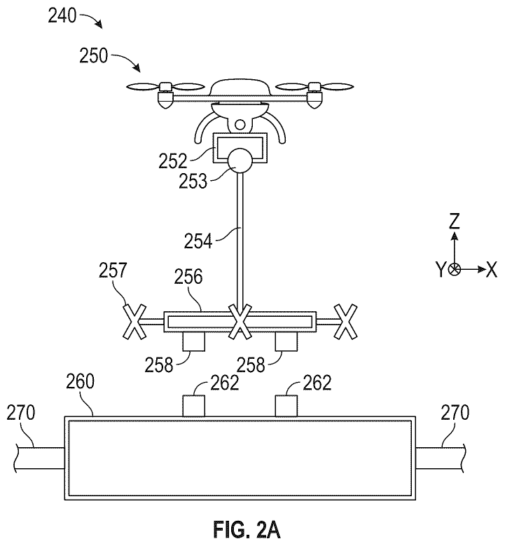

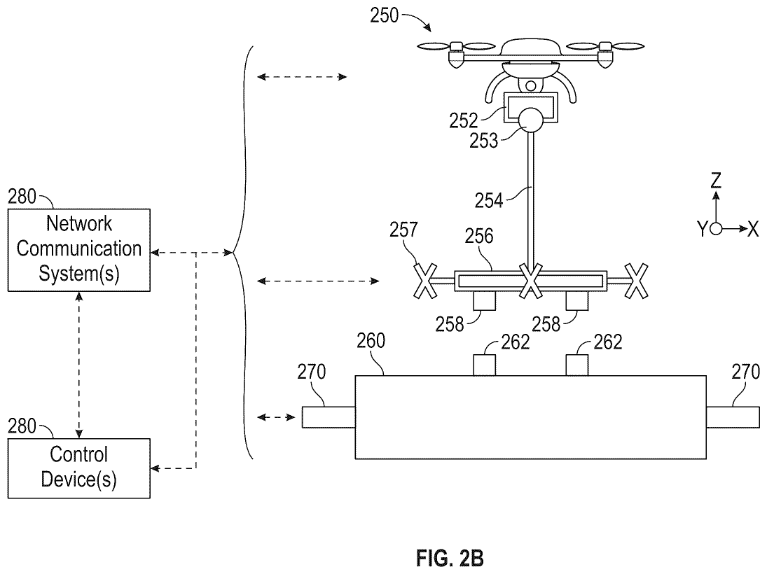

FIG. 2A depicts a side view of an exemplary system 240 including a UAV 250, for example a heavy-lift drone, that is connected to a winch or winching system 252. Winching system 252 may include a motor configured to provide a rotational force, a spool 253 operatively coupled to the motor and rotating in response to commands from the motor, and a wire and/or cable 254 wound around the spool. Wire 254 may be extendable and/or retractable based on rotational movement of the spool. Winch 252 and/or wire 254 may form part of an aerial positioning device 256 and may be connected the device. Winch 252 may thus enable a connection between UAV 250 and aerial positioning device 256, and/or movement of the apparatus in a vertical direction to install the apparatus on the utility line and/or uninstall the apparatus from the utility line. Aerial positioning device 256 may include one or more laterally facing propellers 257 that may enable fine-tuned adjustments along the X and Y axes as shown in FIG. 2A. For example, aerial positioning device 256 may include at least one, at least two, at least three, at least four, at least five, at least 6, at least 7, at least 8, at most 8, at most 7, at most 6, at most 5, at most 4, at most 3, at most 2, and/or at most 1 propeller. Such laterally facing propellers may be configured to move aerial positioning device 256 in at least one horizontal direction and/or in at least two horizontal directions. Aerial positioning device 256 may further include one or more couplings 258 that may connect to one or more couplings 262 on electromechanical apparatus 260. Couplings may include one or more electromagnetic couplings and/or one or more hook-and-loop couplings. For example, couplings 258 may include hook connectors and couplings 262 may include loop or ring connectors into which the hook connectors may interface to enable apparatus 260 to be removably attached to aerial positioning device 256. Electromechanical apparatus 260 may be used to wrap insulating materials in situ around a utility line such as utility line 270 that may or may not be live or energized.

In this way, UAV 250 may transport apparatus 260 to a region above a utility line, winch 252 may controllably lower aerial positioning device 256 and apparatus 260 down to the utility line, and/or aerial positioning device 256 may make fine-tuned adjustments along the X and Y axes using the one or more propellers that make up the aerial positioning device. These fine-tuned adjustments may serve to precisely align apparatus 260 with a utility line such as utility line 270 and may be difficult to accomplish using only the positional control of, for example, UAV 250. Including winch 252 and aerial positioning device 256 in system 240 may additionally serve to enable greater distance between UAV 250, which may be a large heavy-lift drone, and utility lines that may be live and/or at high potential. This distance may prevent any accidental damage to the utility infrastructure resulting from interaction with UAV 250.

Once apparatus 260 is aligned with and mounted to the utility line, the connection between couplings 258 and 262 may be removed, for example by modifying the current powering electromagnets that may form each attachment point, and/or by using winch 252 and/or aerial positioning device 256 to adjust the position of couplings 258 such that the connection between hook and ring connectors may be removed. Apparatus 260 may then travel along a section of utility line wrapping it in insulating material as discussed in greater detail below. To remove apparatus 260 from the utility line, for example for servicing and/or transfer to a different utility line and/or utility line section once wrapping of a particular section is complete, UAV 250 may again be positioned above apparatus 260, aerial positioning device 256 may be lowered using winching system 254, with propellers 257 on aerial positioning device 256 used to align it with apparatus 260. Couplings 258 and 262 may again be engaged to removably attach apparatus 260 to aerial positioning device 256. Once attached, UAV 250 may lift apparatus 260 off the utility line for transferring to its next destination.

FIG. 2B depicts a view of system 240, according to some embodiments, in which the system includes one or more control device(s) 280 that may, independently and/or in cooperation with one or more network communication system(s) 282, control operation (e.g., by sending control signals to) of one or more components of system 240. While multiple control devices 280 and/or multiple network communication systems 282 may be used, this description will refer to a single control device 280 and a single network communication system 282 below.

Control device 280 may be or may comprise any computer-processor-based device configured to provide control signals to one or more components of system 240 including but not limited to UAV 250, aerial positioning device 256, and apparatus 260. Control device 280 may include one or more network communication interfaces configured to send and receive electronic communications, via wired and/or wireless transmission, by any suitable electronic communication protocol (e.g., Bluetooth, WiFi, cellular communication, RF communication, etc.). Control 280 may comprise memory storing instructions configured to cause one or more processors of control device 280 to transmit control signals to the one or more components of system 240. Control device 280 may comprise a dedicated-purpose control device, such as a handheld remote controller, configured to transmit control signals to the one or more components of system 240. Control device 280 may be or comprise a computer system such as a laptop, desktop computer, control terminal computer, smart phone, tablet, or the like.

Control device 280 may comprise one or more input devices configured to receive user inputs from a user. Input devices may include, for example, keys, buttons, touch-sensitive devices, touch-screens, pressure-sensitive devices, a mouse, a keyboard, buttons, knobs, a joystick, an orientation-sensor-based control device, an accelerometer-based control device, a microphone, or the like. Control device 280 may receive user inputs from a user, may process said user inputs to generate control signals for system components, and may transmit those control signals (directly or indirectly) to said system components.

Alternatively or in addition to being configured to receive user inputs and generate control signals based on said user inputs, control device 280 may be configured to receive input data transmitted from one or more other devices or systems and to generate control signals for transmission to other system components based on said received input data.

In some embodiments, one control device 280 may be provided for control of multiple system components. In some embodiments, separate control devices 280 may be provided for control of different system components. For example, one control device 280 may be configured to transmit control signals to UAV 250 while a separate control device 280 may be configured to transmit control signals to apparatus 260. In some embodiments, the apparatus comprises a camera system.

In some embodiments, control device 280 may transmit control signals directly to one or more system components (e.g., UAV 250, aerial positioning device 256, and/or apparatus 260) of system 240. In some embodiments, alternatively or additionally to sending control signals by direct transmission to UAV 50, control device 280 may transmit control signals indirectly to UAV 250, aerial positioning device 256, and/or apparatus 260. Transmitting said control signals indirectly nay comprise transmitting said control signals through one or more other system components of system 240 and/or through one or more other systems. In some embodiments, control signals may be transmitted indirectly from control device 280 to UAV 250, aerial positioning device 256, and/or apparatus 260, via transmission through network communication system 280.

Network communication system 280 may comprise any computer network system configured to receive and transmit electronic communications. In some embodiments, network communication system 280 may comprise one or more servers. In some embodiments, network communication system 280 may comprise one or more communication towers, beacons, and/or the like. In some embodiments, network communication system 280 may comprise any public or private computer network, including but not limited to the internet.

One or more components of system 240 may include one or more sensors that collect data and transmit it (directly or indirectly) to control device 280. Data collected by one or more sensors may be displayed to a user of control device 280 and/or may be used by system 240 to automatically compute control instructions to be used to generate control signals for one or more components of system 240. Sensors may include location sensors, positioning devices, gyroscopes, orientation sensors, altimeters, proximity sensors, sensors configured to detect a status of a wire wrapping process step, temperature sensors, voltage sensors, humidity sensors, or the like. Sensors may be included on UAV 250, aerial positioning device 256, and/or apparatus 260.

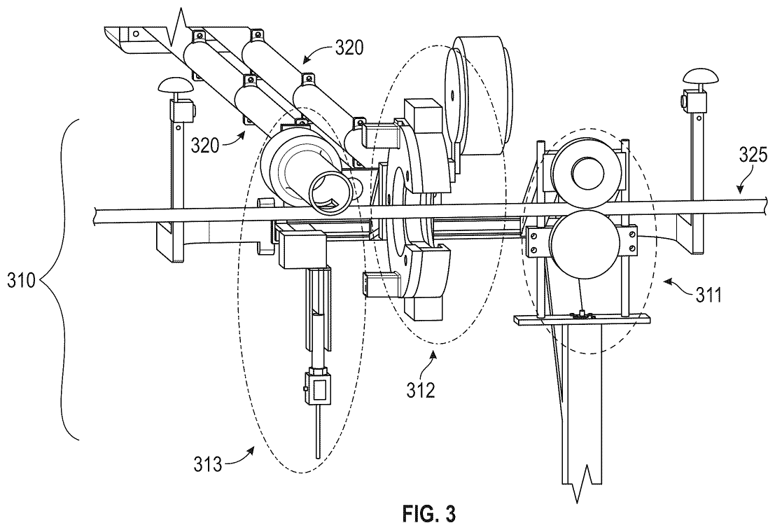

In some embodiments, the electromechanical apparatus may include one or more subsystems. In some embodiments, the apparatus may include one, two, three, or four subsystems. The subsystems may work together to move the apparatus down the length of a utility line while wrapping the utility line in layers of insulating and/or protective materials and then cutting or clamping off the material before the apparatus is removed from the utility line by the UAV and moved to the next location. FIG. 3 depicts a perspective view an exemplary apparatus 310 with three subsystems. A first subsystem may include an attachment subsystem 311. In some embodiments, an attachment subsystem 311 may include a clamping system and a motor. The clamping system may clamp the UAV on a utility line such as utility line 325 while the motor drives the apparatus down the length of the utility line. A second subsystem may include a material-wrapping subsystem 312. In some embodiments, material-wrapping subsystem 312 may include a tape holder to house rolls of various materials to be wrapped around the utility line, an inner gear for wrapping the material, and a motor to power the inner gear.

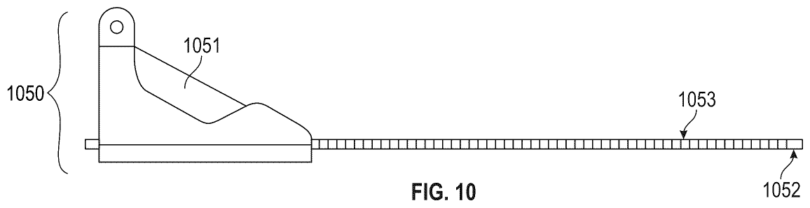

A third subsystem may include a material-clamping subsystem 313. Material-clamping subsystem 313 may include a spring-loaded magazine housing clamps to be fastened around the layers of material wrapped around the utility line in order to prevent slippage/loosening of the layers of material. A fourth subsystem may include a material-cutting subsystem such as that depicted in FIG. 10. In some embodiments, the material-cutting subsystem may cut the various layers of material that have been wrapped around the utility line. In some embodiments, the apparatus may include a material-clamping subsystem or a material-cutting subsystem. In some embodiments, the apparatus may include both a material-clamping subsystem and a material-cutting subsystem.

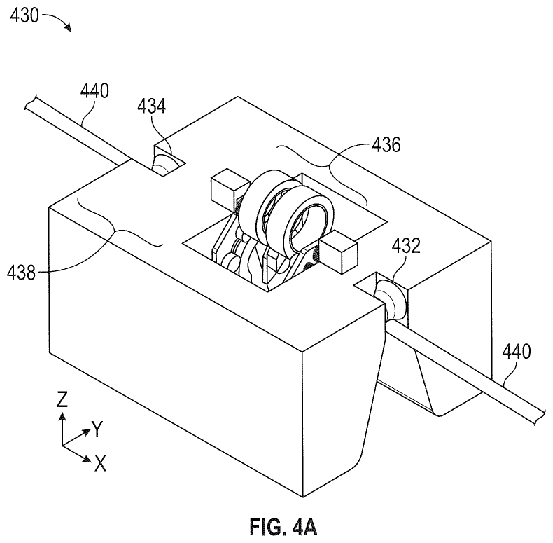

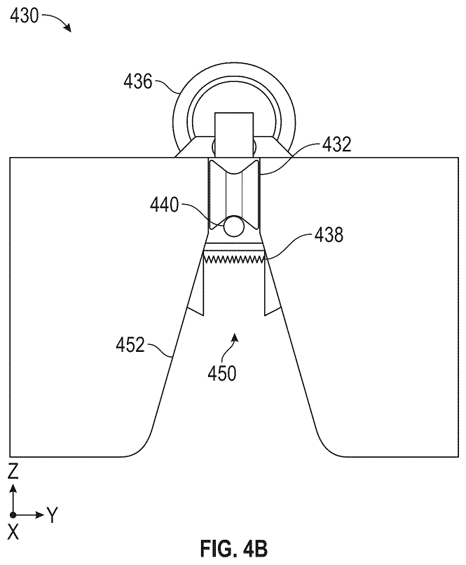

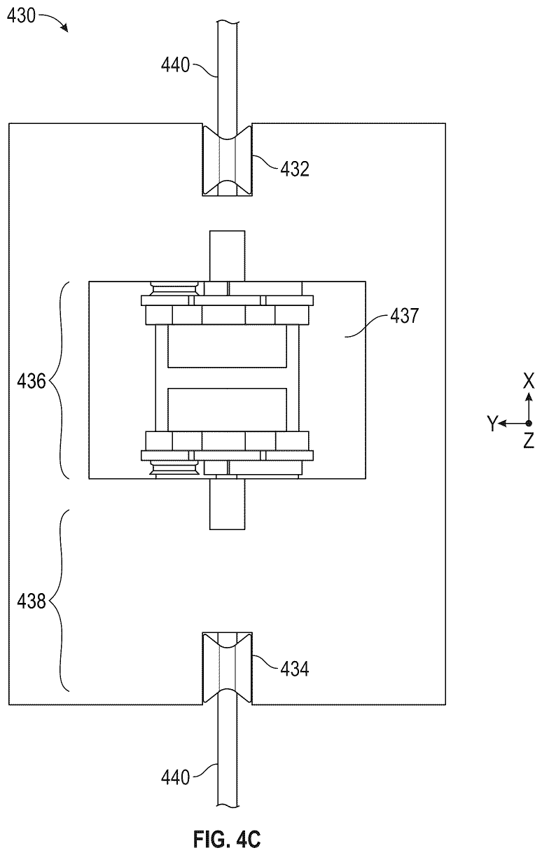

FIG. 4A depicts a perspective view of an exemplary apparatus 430 placed along a utility line 440 with front wheel 432 and/or rear wheel 434 contacting utility line 440. Front wheel 432 and/or rear wheel 434 may therefore engage with the utility line and/or facilitate controlled movement of the apparatus along the length of the utility line. Apparatus 430 may include a material-wrapping subsystem 436 and/or a material-heating subsystem located within apparatus 430 and occupying axial position corresponding to position 438. Exemplary apparatus 430 may additionally include an attachment subsystem and/or a material-clamping subsystem as discussed above in the context of FIG. 3 and/or a material-cutting subsystem as discussed below in the context of FIG. 10. Front wheel 432 and/or rear wheel 434 may be made of an electrically insulating material, for example polyurethane, polyamide (nylon), and/or high-density polyethylene. Use of an electrically insulating material may reduce the likelihood of discharges between a live utility line and apparatus 430. Once in contact with a live utility line apparatus 430 may in fact reach the same floating potential as the utility line, ensuring that no significant potential gradients exist between the apparatus and the utility line.

FIG. 4B depicts an axial view of exemplary apparatus 430 placed along utility line 440 and contacting front wheel 432. As shown, material-wrapping subsystem 436 may be located above utility line 440 while material-heating subsystem 438 including a reflective plate may be located below line 440. Reflective plate may be moved along the Y-axis to allow line 440 pass by during installation and/or removal of apparatus 430 from line 440. Apparatus 430 may further include a U-shaped cutout 450 formed in the front and rear portions of the housing of apparatus 430. Cutout 450 may include angled surfaces such as angled surface 452. These angled surfaces may function as lead-ins and/or guides for utility line 440 during installation of apparatus 430 onto line 440. These angled surfaces may be formed of abrasion-resistant materials and/or materials with a low coefficient of friction to ensure any contact with the utility line does not result in significant damage and/or disruption to the operation of the apparatus. For example, as apparatus 430 is lowered onto line 440, angled surfaces of cutout 450 may ensure apparatus 430 remains centered on line 440. Further, these angled surfaces may align with U-shaped surfaces on front wheel 432 and/or rear wheel 434, enabling line 440 to be centered on front wheel 432 and/or rear wheel 434, thereby centering apparatus 430 on line 440.

U-shaped cutout 450, front wheel 432, rear wheel 434, and/or the openings within material-wrapping subsystem 436 and/or material-heating subsystem 438 that allow the utility line to enter may each be sized such that a variety of utility line diameters and/or sizes may be accepted. Utility lines may vary in size as a function of the amount of current they are designed to carry and/or may have components such as splice connectors and/or repair sleeves attached to them that extend the lines and/or restore structural integrity to damaged lines. By accepting a variety of utility line sizes apparatus 430 may operate on and/or wrap material around a variety of utility lines.

Exemplary apparatus 430 may include components and/or subsystems distributed in a manner such that the center of mass of the apparatus is centered both laterally and axially, for example both along the X-axis and along the Y-axis as depicted in FIG. 4B to minimize the risk of angled and/or unbalanced operation of apparatus 430. The Z-axis position of components and/or subsystems, along with the design of the housing of apparatus 430 may be distributed and/or selected to reduce and/or minimize the cross-sectional area of the apparatus, for example the area in the XZ plane as depicted in FIG. 4B. Such a cross-sectional area reduction and/or minimization may reduce the likelihood the apparatus may be disrupted by exposure to wind forces such as unexpected gusts.

FIG. 4C depicts a top view of exemplary apparatus 430 placed along utility line 440 and contacting front wheel 432 and/or rear wheel 434. Material-wrapping subsystem 436 may be located forward of material-heating subsystem 438 within apparatus 430 such that as apparatus 430 travels along line 440, for example traveling in the positive X-direction, heating may be deployed to heat shrink material that has been wrapped on the utility line. The housing of apparatus 430 may include a cutout 437 within the center of the top and/or bottom of the housing. This cutout may be square in shape and may allow the one or more rolls of material that make up material-wrapping subsystem 436 to complete a full 360-degree rotation around the utility line, thereby wrapping the line in the one or more materials.

Adjacent to and/or within cutout 437 may be one or more capabilities that may enable the one or more rolls material to be attached to the utility line to initiate wrapping, and/or one or more subsystems that may enable the one or more rolls of material to be disconnected from the utility line when wrapping of a section of the line is complete. Such subsystems that may enable the one or more rolls of material to be disconnected from the line may include a material-clamping subsystem and/or a material-cutting subsystem discussed in greater detail below.

Material-wrapping subsystem 436 may include one or more materials, for example including an inner insulating tape and/or an outer heat-shrinkable tape, as apparatus 430 travels along line 440. Once the one or more materials have been wrapped around a section of line 440, material-heating subsystem 438 may heat the one or more materials, for example including the outer heat-shrinkable tape causing the tape to compress onto the inner insulating tape holding it to line 440. Apparatus 430 may continue in this manner along line 440, wrapping and heating section by section to reduce the risk of contact between line 440 with grounded objects such as trees or other vegetation, thereby reducing the risk that line 440 may release energy sufficient to start a forest fire.

In some embodiments, Apparatus 430 comprises a self-balancing system comprising two or more arms 460 extending from the body of the apparatus, wherein each arm comprises one or more laterally facing propellers that may enable the apparatus to make fine-tuned adjustments along the Y axis and assist the apparatus in remaining on the utility line.

### A. Attachment Subsystem

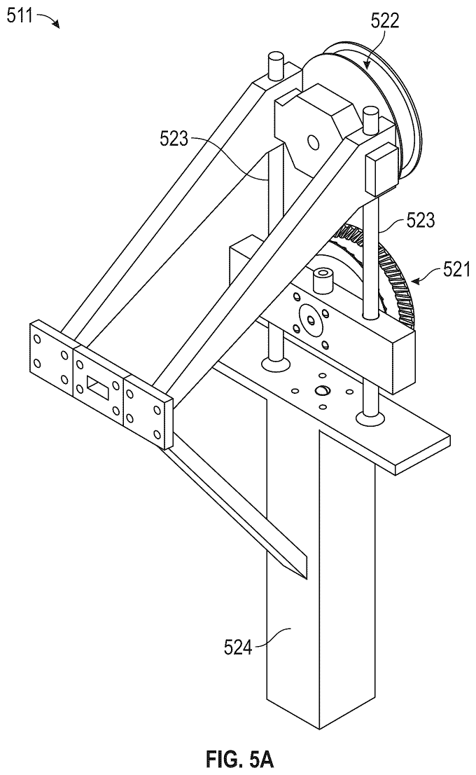

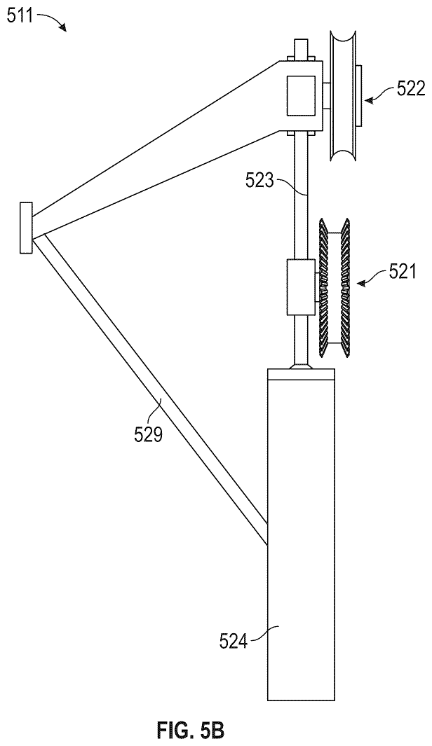

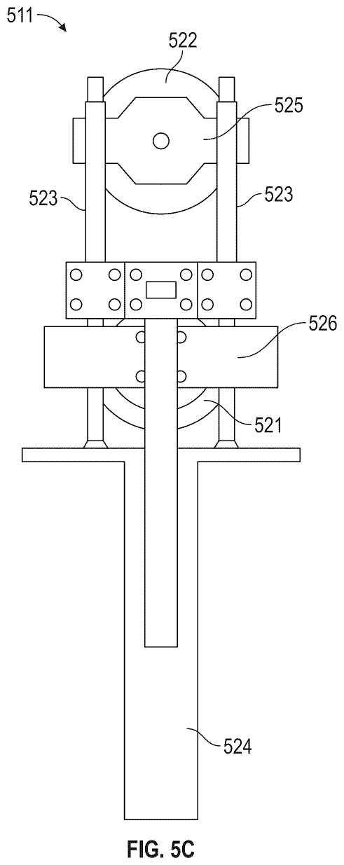

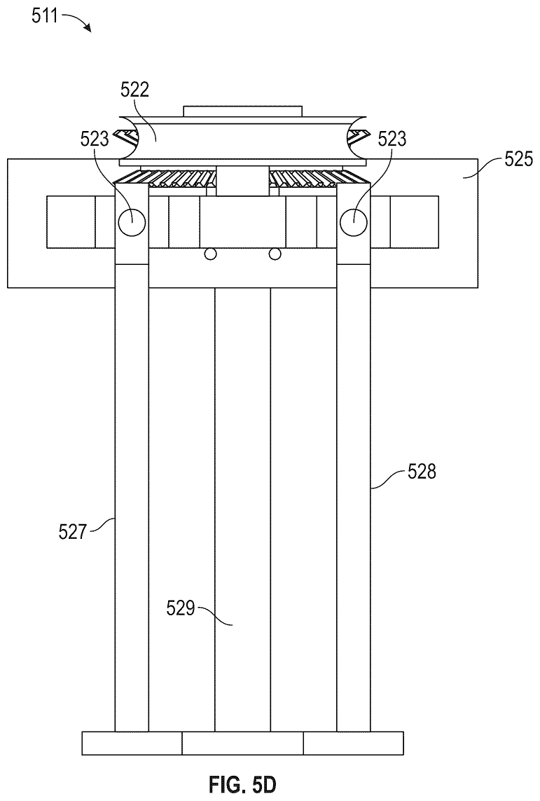

In some embodiments, the electromechanical apparatus may include an attachment subsystem 511. As illustrated in FIG. 5A, attachment subsystem 511 may include a clamping system that may include a lower bearing 521, which may be aligned below a utility line, and an upper bearing 522, which may align above the utility line. In some embodiments, the lower bearing and upper bearing may come together, clamping the utility line between them to affix the apparatus to the utility line. As shown in FIG. 5B, the lower bearing 521 and upper bearing 522 of attachment subsystem 511 may be connected by way of two guide rails 523. The guide rails may keep the upper and lower bearings aligned to properly and tightly clamp the utility line.

As shown in FIG. 5C, the upper bearing 522 of attachment subsystem 511 may be affixed to the rest of the subsystem by way of an upper block 525 and the lower bearing 521 may be affixed to the rest of the subsystem by way of a lower block 526. FIG. 5D illustrates the clamping mechanism of attachment subsystem 511 from above the utility line. FIG. 5D shows that upper and lower block may be attached to the apparatus by three mounts, a left mount 527, a right mount 528, and a center mount 529. In some embodiments, there may be a captive linear actuator that lifts and/or lowers the lower block 526, so that the attachment subsystem may attach and/or detach from the utility line. In some embodiments, the upper block 525 may be fixed, and the upper bearing 522 may be idle. In some embodiments, the upper bearing 522 may utilize a plastic bearing with glass balls to freely rotate.

In some embodiments, the attachment subsystem may further include a motor 524. FIG. 5A-C show different views of the attachment subsystem wherein the lower bearing 521 may be fixed to the lower block 526, and may be driven rotationally by motor 524. This rotational motion in turn may cause the apparatus to be driven along the utility, with the velocity and acceleration controlled by motor 524. In some embodiments, the motor may precisely control the velocity of the apparatus to ensure correct installation of the wrapped layers of material. In some embodiments, the motor may be a stepper motor, such as an electric stepper motor. In some embodiments the stepper motor may have a step angle of about 1.8 degrees. In some embodiments, the stepper motor may take about 200 steps for a full rotation. In some embodiments the stepper motor may weigh between about 0.5 and 10 pounds, such as about any one of 1, 2, 3, 4, 5, etc. pounds. In some embodiments, the stepper motor may be a NEMA 8 stepper motor.

In some embodiments, a captive linear actuator may be attached to the lower block 526 and may be fixed to the frame of the apparatus. The captive linear actuator may move +/−linearly by 2″, which may be used to connect the lower block 526 and lower bearing 521 to and/or from the utility line. In some embodiments, this movement may allow the entire apparatus to be installed and/or uninstalled from the utility line.

### B. Material-Wrapping Subsystem

In some embodiments, the apparatus may include a material-wrapping subsystem 312 as depicted in FIG. 3 that wraps layers of material onto a utility line.

In some embodiments, the material-wrapping mechanism may wrap various materials around a utility lines. In some embodiments, one material may be wrapped around the utility line at a time. In some embodiments, more than one material may be wrapped around the utility line at a time. In some embodiments, the utility lines may be wrapped once (one layer of material). In some embodiments, the utility lines may be wrapped more than once. In some embodiments, the utility lines may be wrapped once, twice, three times, four times, five times, and/or more times. In some embodiments, the utility lines may be wrapped in multiple layers of the same or similar material. In some embodiments, the utility lines may be wrapped in multiple layers of different materials.

In some embodiments, the material may be wrapped clockwise around the utility line. In some embodiments, the material may be wrapped counterclockwise around the utility line. In some embodiments, multiple layers of materials may be wrapped around the utility line in either clockwise and/or counterclockwise directions. In some embodiments, multiple layers of materials may be wrapped around the utility line in alternating clockwise and/or counterclockwise directions.

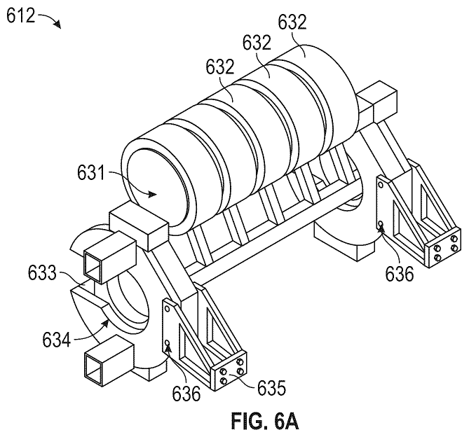

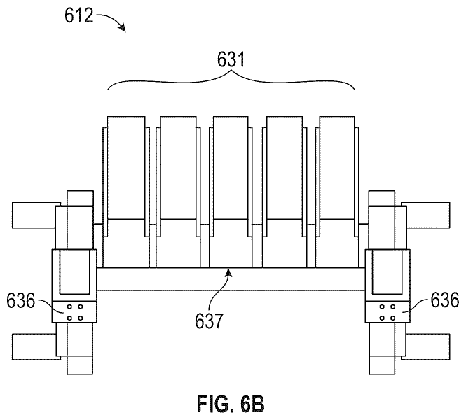

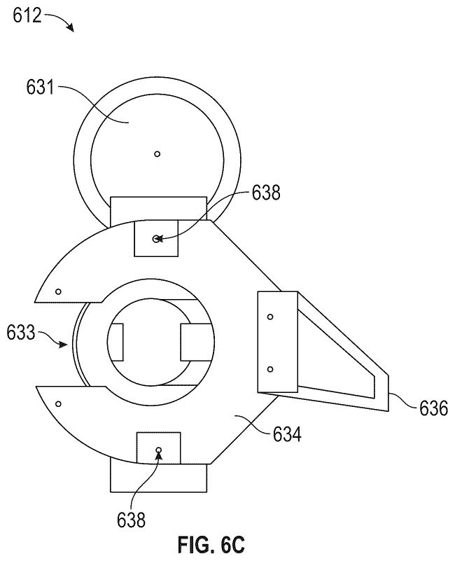

FIG. 6A depicts an exemplary material-wrapping subsystem 612 including a tape holder 631 that may have space for one or more rolls of material that may be wrapped around the utility line. In some embodiments, the tape holder may include space for 1, 2, 3, 4, 5, and/or more rolls of one or more materials 632. In a certain embodiment, the tape holder may include space for 5 rolls of material. The material-wrapping subsystem may be capable of wrapping either one or multiple materials around a utility line simultaneously. The tape holder housing the rolls of material may be connected to a “C” shaped geared rotating piece or inner gear 633. Inner gear 633 may be housed within an outer casing 634 and/or an inner casing 635. The material-wrapping subsystem may be attached to the apparatus via two brackets 636. FIG. 6B illustrates the location of a wrapping bar 637 of material-wrapping subsystem 612 that may hold the one or more rolls of material and may be connected on both ends to inner gear 633. In some embodiments, the turning of inner gear 633 may drive the rotational motion of wrapping bar 637.

FIG. 6C depicts the location of inner gear 633 of material-wrapping subsystem 612 in relation to one or more motors 638. In some embodiments, inner gear 633 may be driven by one or more gears that are attached to one or more motors 638. In some embodiments, the one or more gears may be made from nylon plastic. In some embodiments, the motor may be a stepper motor, such as an electric stepper motor. In some embodiments the stepper motor may have a step angle of about 1.8 degrees. In some embodiments, the stepper motor may take about 400 steps to complete a full rotation. In some embodiments the stepper motor may weigh between about 0.5 and 10 pounds, and/or may weight, for example at least 1, at least 2, at least 3, at least 4, and/or at least 5 pounds. In some embodiments, the one or more motors may include one or more NEMA 8 stepper motors that may be used to rotate the one or more gears.

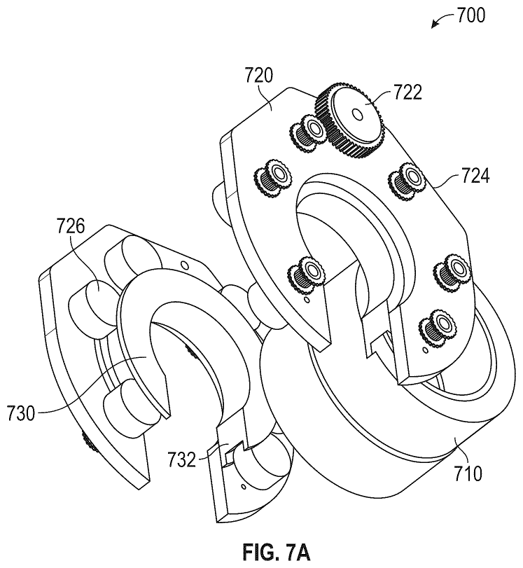

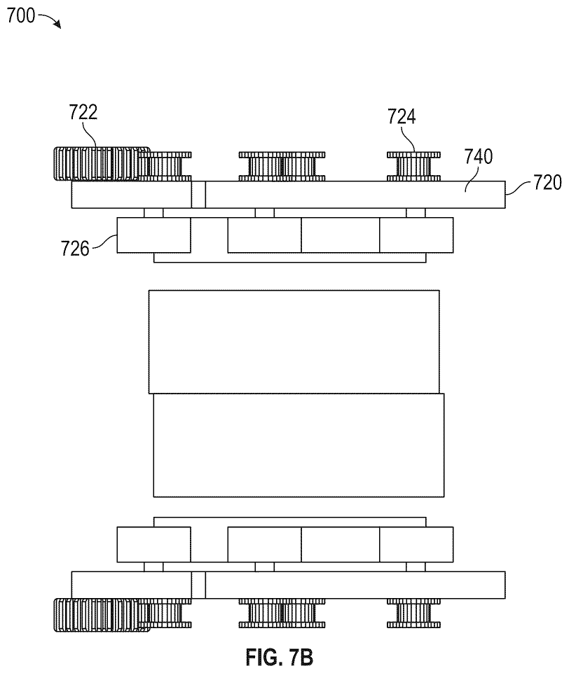

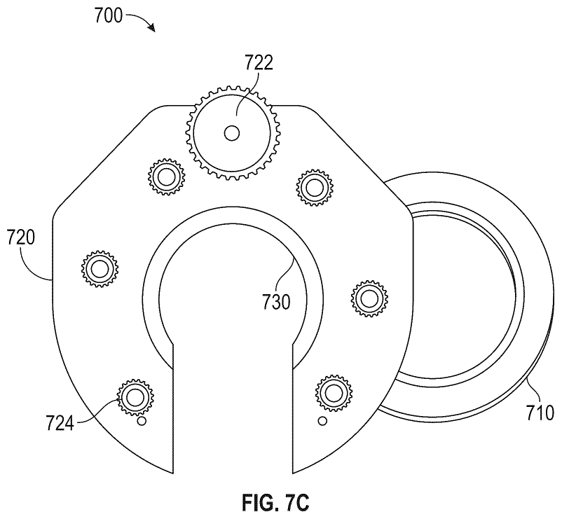

FIG. 7A depicts an exemplary material-wrapping subsystem 700 including one or more rolls such as roll 710 of one or more wrapping materials that may be mounted to one or more reels that may enable rotation of the rolls, two inner rotating plates such as rotating plate 730 that may be mounted to the one or more reels, and/or two outer plates such as outer plate 720. Each outer plate and each inner plate may include a cutout to allow the apparatus to be lowered such that the utility line may be placed at the center of material-wrapping subsystem 700. For example, the cutout of each rotating inner plate may be aligned with the cutout of each outer plate such that the utility line may be placed at the center of the subsystem without contacting either outer plate or either inner plate.

The one or more rolls of material may include one or more rolls of tape and may be mounted to one or more reels that may enable rotation of the rolls and that may in turn be mounted to the inner rotating plates. Attachment of the one or more reels to the inner rotating plates may thus enable the one or more rolls of material to be moved circumferentially around the utility line as inner rotating plates rotate and as the apparatus travels along the utility line, thereby wrapping the utility line with the one or more materials. This circumferential motion of the one or more rolls of material may involve motion in an orbital path around the utility line. Because the material-wrapping subsystem may be configured to be placed around the utility line, the one or more rolls of material may move in an orbital path around a center point of the material-wrapping subsystem to wrap material around the utility line. The outer face of each outer plate may include one or more drive pulley wheel such as drive pulley wheel 722 that may be connected to a motor. For example, two motors may be synchronized to operate in unison, each driving a respective drive pulley wheel mounted on each outer plate. For example, the two motors may be electrically synchronized via a shared controller and/or using closed-loop feedback. Alternatively or additionally, a single motor may be used to drive both drive pulley wheels, for example by connecting the motor to each drive pulley wheel using a gear and/or pulley-based system.

This drive pulley wheel may in turn be connected to a plurality of driven pulley wheels including, for example, driven pulley wheel 724 using a timing belt that is not depicted in FIG. 7A. For example, each outer plate may include at least two, at least four, at least six, at most ten, at most eight, at most six, and/or at most four driven pulley wheels. For example, each outer plate may include six driven pulley wheels. Each drive pulley wheel and/or each driven pulley wheel may include a plurality of teeth matching characteristics of the timing belt, for example teeth depth and/or spacing. Matching of these characteristics may ensure that rotation of the drive pulley wheel translates to rotation of the plurality of driven pulley wheels. This matching may further ensure a continuous connection between the belt and each drive pulley wheel and/or driven pulley wheel even while the material-wrapping system is subjected to the weight and/or resulting deformation of the one or more rolls of material.

Each of the plurality of driven pulley wheels may be connected to a plurality of guide wheels such as guide wheel 726 that may protrude from the inner face of each outer plate. These guide wheels may interface to a slot such as slot 732 in each inner rotating plate. Each slot may capture each guide wheel it contacts thereby limiting rotational movement of the assembly. In this way, synchronized rotation of each drive pulley wheel 722 may cause rotation, via timing belts, of a plurality of driven pulley wheels such as driven pulley wheel 724, that in turn may cause rotation of a plurality of connected guide wheels such as guide wheel 726. Rotation of the plurality of guide wheels may, via a frictional connection, in turn cause synchronized rotation of inner rotating plate such as plate 730 which may in turn cause the one or more rolls 710 of wrapping material to travel circumferentially around the utility line. In combination with the forward motion of the apparatus along the utility line caused by, for example, attachment subsystem as described above, the one or more materials may be incrementally wrapped around the utility line. By including a plurality of guide wheels interfacing to a slot on each inner rotating plate, the design of material-wrapping subsystem 700 may ensure each inner rotating plate and/or each roll of material may rotate with minimal deflection and/or friction despite being subjected to the weight of the one or more rolls of material. Inclusion of a plurality of guide wheels may additionally ensure that sufficient force is transferred to each inner rotating plate to enable the one or more rolls of material to be tensioned such that the one or more materials may be tightly wrapped around the utility line.

The one or more rolls of material may include at least one roll, at least two rolls, at least three rolls, at least four rolls, at least five rolls, at most five rolls, at most four rolls, at most three rolls, at most two rolls, and/or at most one roll.

FIG. 7B depicts a top view of material-wrapping subsystem 700. Each drive pulley wheel 722 and/or each driven pulley wheel 724 connected to a guide wheel 726 and mounted within an outer plate 720 may include a ball bearing such as ball bearing 740. Each ball bearing may allow the drive pulley wheel and/or driven pulley wheel to which it is connected to freely rotate thereby reducing friction within the timing belt pulley system.

FIG. 7C depicts a side view of material-wrapping subsystem 700. As discussed above, drive pulley wheels such as drive pulley wheel 722 may be rotated by one or more motors, for example one or more stepper motors, and may in turn rotate a plurality of driven pulley wheels such as driven pulley wheel 724 via a timing belt. Rotation of guide wheels connected to each driven pulley wheel may in turn rotate inner rotating plates such as plate 730 to which one or more rolls of wrapping material 710 may be connected. In this way, rotation of one or more motors connected to drive pulley wheels may control the rotation of one or more rolls of wrapping material. One or more rolls of wrapping material may include, as discussed below, one or more semi-conductive tapes, one or more insulating tapes, and/or one or more durable outer materials. For example, the one or more semi-conductive tapes may include a semi-conductive nylon tape, the one or more insulating tapes may include a polyimide material or a silicone material and/or the one or more durable outer materials may include one or more heat-shrinkable tapes and/or tapes comprising a fluoropolymer.

As discussed above, the material-wrapping subsystem may be placed within the apparatus such that a cutout in the apparatus, for example cutout 437 depicted in FIG. 4C, may enable the 360-degree rotation of the material-wrapping subsystem, including the one or more rolls of material, around the utility line. Adjacent to the material-wrapping subsystem may be one or more capabilities that may enable the one or more rolls of material to be attached to the utility line to initiate wrapping, and/or one or more subsystems that may enable the one or more rolls of material to be disconnected from the utility line when wrapping of a section of the line is complete. Such subsystems that may enable the one or more rolls of material to be disconnected from the line may include a material-clamping subsystem and/or a material-cutting subsystem. For example, a material-cutting subsystem may include an actuator with a blade to cut the one or more rolls of material when wrapping is complete and/or when the apparatus may otherwise be removed from the utility line.

In some embodiments, the material-wrapping subsystem comprises one or more laser diodes. In some embodiments, the material-wrapping subsystem comprises infrared (IR) lasers which heat the outermost layer of wrapped material. In some embodiments, the lasers heat the material of the outermost layer resulting in the material of the outermost layer bonding onto itself. The heating seals the outermost layer providing a waterproof seal around the layers of material wrapped around the utility line.

In some embodiments, the material-wrapping subsystem of the apparatus wraps the utility line with one or more layers of a film, wrap, or tubing. In some embodiments, the material-wrapping subsystem of the apparatus wraps one or more layers of a film, wrap, or tubing around pre-existing, already installed utility lines. In some embodiments, the material-wrapping subsystem of the apparatus is used to retrofit already installed utility lines. In some embodiments, the material-wrapping subsystem of the apparatus wraps one or more layers of a film, wrap, or tubing around live utility lines. In some embodiments, the material-wrapping subsystem of the apparatus wraps one or more layers of a film, wrap, or tubing around installed live utility lines. In some embodiments, the material-wrapping subsystem of the apparatus wraps one or more layers of a film, wrap, or tubing around installed live utility lines wherein the primary voltage of the live utility lines is over 100V, 200V, 300V, 400V, 500V, 600V, 700V, 800V, 900V, or 1000V. In some embodiments, the material-wrapping subsystem of the apparatus wraps one or more layers of a film, wrap, or tubing around installed live utility lines wherein the primary voltage of the live utility lines is over 600V.

### 1. Wrapping Material

In some embodiments, the material-wrapping subsystem may wrap the utility line with one or more layers of one or more different types of material. In some embodiments, a first layer of material may include a semi-electrically conductive tape, wherein the semi-electrically conductive tape may be used to control partial discharge. In some embodiments, the thickness of the semi-conductive tape may be between 0.05-0.15 mm, 0.1-0.20 mm, 0.15-0.3 mm, 0.25-50 mm, 0.5-50 mm, 1-50 mm, 2-50 mm, 5-50 mm, 10-50 mm, 15-50 mm, 20-50 mm, 25-50 mm, 30-50 mm, 35-50 mm, 40-50 mm, 45-50 mm, 5 -45 mm, 10-45 mm, 15-45 mm, 20-45 mm, 25-45 mm, 30-45 mm, 35-45 mm, 40-45 mm, 5-40 mm, 10-40 mm, 15-40 mm, 20-40 mm, 25-40 mm, 30-40 mm, 35-40 mm, 5 -35 mm, 10-35 mm, 15-35 mm, 20-35 mm, 25-35 mm, 30-35 mm, 5-30 mm, 10-30 mm, 15-30 mm, 20-30 mm, 25-30 mm, 5 -25 mm, 10-25 mm, 15-25 mm, 20-25 mm, 5-20 mm, 10-20 mm, 15-20 mm, 5 -15 mm, 10-15 mm, and/or 5-10 mm.

In some embodiments, the thickness of the semi-conductive layer may be between 0.05-0.15 mm, 0.1-0.20 mm, 0.15-0.3 mm, 0.25-50 mm, 0.5-50 mm, 1-50 mm, 2-50 mm, 5-50 mm, 10-50 mm, 15-50 mm, 20-50 mm, 25-50 mm, 30-50 mm, 35-50 mm, 40-50 mm, 45-50 mm, 5 -45 mm, 10-45 mm, 15-45 mm, 20-45 mm, 25-45 mm, 30-45 mm, 35-45 mm, 40-45 mm, 5-40 mm, 10-40 mm, 15-40 mm, 20-40 mm, 25-40 mm, 30-40 mm, 35-40 mm, 5 -35 mm, 10-35 mm, 15-35 mm, 20-35 mm, 25-35 mm, 30-35 mm, 5-30 mm, 10-30 mm, 15-30 mm, 20-30 mm, 25-30 mm, 5 -25 mm, 10-25 mm, 15-25 mm, 20-25 mm, 5-20 mm, 10-20 mm, 15-20 mm, 5 -15 mm, 10-15 mm, and/or 5-10 mm. In some embodiments, the semi-conductive layer may be between 10 and 40 mm thick. In some embodiments, the thickness of the semi-conductive layer may be about 5 mm, 10 mm, 15 mm, 20 mm, 25 mm, 30 mm, 35 mm, 40 mm, 45 mm, and/or 50 mm. In a specific embodiment, the thickness of the semi-conductive layer may be 30 mm.

In some embodiments, a material capable of blocking water is applied to the utility line before the first layer of wrapped material. In some embodiments, the water-blocking material is a silicone grease or a quick-curing compound. In some embodiments, the water-blocking material possesses low viscosity so it is capable of penetrating the strands of the utility line and quickly harden so that it can stay in place without dripping.

The point of this is to prevent water from getting in between the stands of the wire and getting trapped under the insulation. This sitting water will corrode the wire more rapidly.

In some embodiments the semi-conductive tape may be an electrical tape suitable for high-voltage applications and may include a semi-conductive shielding. In some embodiments, the semi-conductive tape may include a backing material and/or a semi-conductive layer. The semi-conductive tape in some embodiments further may include an adhesive layer and/or a release liner. The backing material may be a flexible material such as ethylene propylene rubber (EPR) and/or an ethylene propylene diene monomer (EPDM) rubber. In some embodiments, the semi-conductive tape comprises EPR. In some embodiments, the semi-conductive tape comprises a nylon tape. The semi-conductive layer may be made of a carbon-filled material and/or a conductive polymer compound, and/or a different material that permits a controlled level of conductivity across the surface of the tape. The adhesive layer may be a pressure-sensitive adhesive applied to one side of the backing material, such as a material that permits the tape to adhere to a surface. In some embodiments, the tape may include a release liner that may cover the adhesive layer until it is ready for application. In some embodiments, the semi-conductive tape may be 3M® Semi-Conducting Tape 13. In some embodiments, the semi-conductive tape may be a semi-conductive nylon tape.

In some embodiments, a second layer of material may include an electrically insulating layer. In some embodiments, the thickness of the insulating tape may be between 0.05-0.15 mm, 0.1-0.20 mm, 0.15-0.3 mm, 0.20-50 mm, 0.25-10 mm, 0.5-10 mm, 1-10 mm, 2-10 mm, 3-10 mm, 4-10 mm, 5-10 mm, 6-10 mm, 7-10 mm, 8-10 mm, 9-10 mm, 1-9 mm, 2-9 mm, 3-9 mm, 4-9 mm, 5-9 mm, 6-9 mm, 7-9 mm, 8-9 mm, 1-8 mm, 2-8 mm, 3-8 mm, 4-8 mm, 5-8 mm, 6-8 mm, 7-8 mm, 1-7 mm, 2-7 mm, 3-7 mm, 4-7 mm, 5-7 mm, 6-7 mm, 1-6 mm, 2-6 mm, 3-6 mm, 4-6 mm, 5-6 mm, 1-5 mm, 2-5 mm, 3-5 mm, 4-5 mm, 1-4 mm, 2-4 mm, 3-4 mm, 1-3 mm, 2-3 mm, and/or 1-2 mm. In some embodiments, the insulating tape may be between 2-5 mm thick. In some embodiments, the insulating tape may be between 0.1 and 0.5 mm thick. In some embodiments, the insulating tape may be between 0.2 and 0.3 mm thick.

In some embodiments, the thickness of the insulating layer may be between 0.05-0.15 mm, 0.1-0.20 mm, 0.15-0.3 mm, 0.20-50 mm, 0.25-10 mm, 0.5-10 mm, 1-10 mm, 2-10 mm, 3-10 mm, 4-10 mm, 5-10 mm, 6-10 mm, 7-10 mm, 8-10 mm, 9-10 mm, 1-9 mm, 2-9 mm, 3-9 mm, 4-9 mm, 5-9 mm, 6-9 mm, 7-9 mm, 8-9 mm, 1-8 mm, 2-8 mm, 3-8 mm, 4-8 mm, 5-8 mm, 6-8 mm, 7-8 mm, 1-7 mm, 2-7 mm, 3-7 mm, 4-7 mm, 5-7 mm, 6-7 mm, 1-6 mm, 2-6 mm, 3-6 mm, 4-6 mm, 5-6 mm, 1-5 mm, 2-5 mm, 3-5 mm, 4-5 mm, 1-4 mm, 2-4 mm, 3-4 mm, 1-3 mm, 2-3 mm, and/or 1-2 mm. In some embodiments, the insulating layer may be between 2-5 mm thick. In some embodiments, the insulating layer may be between 0.1 and 0.5 mm thick. In some embodiments, the insulating layer may be between 0.2 and 0.3 mm thick.

In some embodiments, the insulating tape may comprise, but is not limited to, rubber, polyethylene, silicone, fiberglass, aluminum, ethylene propylene, thermal-based ceramic powder, polyvinyl chloride, and/or polyimide. In some embodiments, the insulating tape may comprise an electrical tape comprising polyvinyl chloride. In some embodiments, the insulating tape may comprise a polyimide tape. In some embodiments, the polyimide tape may be combined with a thermally-conductive coating. In some embodiments, the combination of the polyimide tape and the thermally-conductive coating may increase the capacity of the utility line, while also insulating the utility line from foreign objects. In some embodiments, the insulating tape may comprise a silicone tape. In some embodiments, the silicone tape may be combined with a thermally-conductive coating.

In some embodiments, the insulating layer may comprise one or more layers of wrapped insulating material. In some embodiments, the insulating layer may comprise one layer of wrapped insulating material. In some embodiments, the insulating layer may comprise two layers of wrapped insulating material. In some embodiments, the insulating layer may comprise three layers of wrapped insulating material. In some embodiments, the insulating layer may comprise four or more layers of wrapped insulating material.

In some embodiments, the insulating layer comprises a silicone tape. In some embodiments, the silicone tape is layered on the utility line in at least one layer. In some embodiments, the silicone tape is layered on the utility line in at least two layers. In some embodiments, the silicone tape is layered on the utility line in at least three layers. In some embodiments, the silicone tape is layered on the utility line in at least four or more layers. In some embodiments, the higher the voltage through the utility line, the more layers of insulating material (i.e. silicone tape) may be applied to the utility line. As an example, a thinner insulating layer may be sufficient for a low voltage wire (e.g. 4kV), while a higher voltage wire (e.g. 21kV) may require a thicker insulating layer comprising two or more layers of insulating material such as the silicone tape.

The insulating material is applied by the apparatus as the apparatus travels down the utility line. To increase thickness of the insulating layer, the apparatus may travel down the utility line multiple times (multiple passes). With each pass down the utility line, the apparatus may wrap one layer of the insulating material around the utility line. In some embodiments, the apparatus makes two or more passes down the utility line wrapping one layer of insulating material each pass. This process results in multiple layers of insulating material wrapped around the utility line. In some embodiments, the apparatus makes two passes down the utility line wrapping one layer of insulating material each pass, resulting in two layers of insulating material being wrapped around the utility line. In some embodiments, the apparatus makes three passes down the utility line wrapping one layer of insulating material each pass, resulting in three layers of insulating material being wrapped around the utility line. In some embodiments, the apparatus makes three passes down the utility line wrapping one layer of insulating material each pass, resulting in three layers of insulating material being wrapped around the utility line. In some embodiments, the apparatus makes four passes down the utility line wrapping one layer of insulating material each pass, resulting in four layers of insulating material being wrapped around the utility line. In some embodiments, the apparatus makes five or more passes down the utility line wrapping one layer of insulating material each pass, resulting in five or more layers of insulating material being wrapped around the utility line.

In some embodiments, after the apparatus travels down the utility line while wrapping a first layer of material around the line, the apparatus reverses direction and travels back up the line while wrapping a second layer of material around the line. In some embodiments, the material of the first layer is the same as the material of the second layer. In some embodiments, the material of the first layer is different from the material of the second layer. In some embodiments, the apparatus travels up and down the utility line by reversing the direction of travel.

In some embodiments, the apparatus is lifted from the utility line by the aerial positioning device, rotated 180 degrees, and replaced on the utility line in order for the apparatus to change direction of travel.

In some embodiments, the thickness of the total insulating layer (the sum of all insulating layers) may be between 0.25-10 mm, 0.5-10 mm, 1-10 mm, 2-10 mm, 3-10 mm, 4-10 mm, 5-10 mm, 6-10 mm, 7-10 mm, 8-10 mm, 9-10 mm, 1-9 mm, 2-9 mm, 3-9 mm, 4-9 mm, 5-9 mm, 6-9 mm, 7-9 mm, 8-9 mm, 1-8 mm, 2-8 mm, 3-8 mm, 4-8 mm, 5-8 mm, 6-8 mm, 7-8 mm, 1-7 mm, 2-7 mm, 3-7 mm, 4-7 mm, 5-7 mm, 6-7 mm, 1-6 mm, 2-6 mm, 3-6 mm, 4-6 mm, 5-6 mm, 1-5 mm, 2-5 mm, 3-5 mm, 4-5 mm, 1-4 mm, 2-4 mm, 3-4 mm, 1-3 mm, 2-3 mm, and/or 1-2 mm. In some embodiments, the total insulating layer may be between 2-5 mm thick. In some embodiments, the total insulating layer may be between 1-3 mm thick. In some embodiments, the total insulating layer may be about 1 mm thick. In some embodiments, the total insulating layer may be about 2 mm thick. In some embodiments, the total insulating layer may be about 3 mm thick. In some embodiments, the total insulating layer may be about 4 mm thick. In some embodiments, the total insulating layer may be about 5 mm thick. In some embodiments, the total insulating layer may be between 0.1 and 0.5 mm thick. In some embodiments, the total insulating layer may be between 0.2 and 0.3 mm thick.

In some embodiments, a third layer of material may include a durable fabric material, such as a material with high tensile strength and/or suitable abrasion resistance. In some embodiments, the durable layer is the outermost layer of material layered on the utility line. In some embodiments, the durable layer is the outermost layer and serves as an environmental barrier. In some embodiments, the durable fabric material may include ultra-high molecule weight polyethylene (UHMWPE) fibers. In some embodiments, the durable fabric material may be a synthetic fabric, such as UHMWPE that may be coated with a thermoplastic laminating film, such as a transparent and/or translucent film including polyester and/or polyethylene. In some embodiments, the durable fabric material may further include an adhesive to bond the fibers, such as UHMWPE fibers, to the laminating film. In some embodiments, the durable fabric material may be coated and/or treated, such as a UHMWPE coated and/or treated with one or more materials to enhance abrasion resistance and/or provide water resistance or water proofing. In some embodiments, the durable outer layer may include a Dyneema® Composite Fabric (DCF) and/or a similar durable layer. In some embodiments, the durable fabric material may be waterproof. In some embodiments, the durable fabric material may include 1.43 oz Dyneema® Composite Fabric CT5K. 18, 0.51 oz Dyneema® Composite Fabric CT1E. 08, and/or 5.0 oz Dyneema® Composite Fabric Hybrid CT9HK.18/wov.6. In some embodiments, the durable outer layer may include an abrasion resistant material. In some embodiments, the durable outer layer may include a nylon fabric, which may be coated with one or more additional materials, such as materials to make the fabric water-resistant. In some embodiments, the durable outer layer may include a Cordura fabric layer. In some embodiments, the durable outer layer may include, but is not limited to, 1000D Cordura® MIL-SPEC and/or 6.5 oz Woven Melange with Dyneema® DDRWX090.

In some embodiments, a resin may be applied to the durable fabric material after wrapping onto the utility line. In some embodiments, the resin may cure into a hard material and/or may form an extruded polymer that may provide abrasion resistance.

In some embodiments, the durable outer layer may include one or more layers of wrapped durable fabric material. In some embodiments, the durable outer layer may include two layers of durable fabric material. In some embodiments, the durable outer layer may include three layers of durable fabric material. In some embodiments, the durable outer layer may include four or more layers of wrapped durable fabric material.

In some embodiments, the durable outer layer may include a thin layer of heat-shrinkable tape to serve as a waterproof barrier. In some embodiments, the durable outer layer may include a thicker heat-shrinkable tape or composite tape as a waterproof and/or durable outer layer. In some embodiments, the heat-shrinkable tape may include a polyethylene-backed taped with a synthetic rubber adhesive. In some embodiments, the thickness of the heat-shrinkable tape may be between 0.25-20 mm, 0.5-20 mm, 1-20 mm, 2 -12 mm, 3-20 mm, 4-20 mm, 5-20 mm, 6-20 mm, 7-20 mm, 8-20 mm, 9-20 mm, 10-20 mm, 11-20 mm, 12-20 mm, 13-20 mm, 14-20 mm, 15-20 mm, 16-20 mm, 17-20 mm, 18-20 mm, 19-20 mm, 1-15 mm, 1-10 mm, and/or 1-5 mm. In some embodiments, the insulating tape may be between 1-15 mm thick. Use of heat-shrinkable tape may be useful in ensuring that semi-conductive and/or insulating materials that may not bond readily with a metal utility line on their own may be held against and/or attached to the utility line.

In some embodiments, the durable outer layer comprises a material comprising a fluoropolymer. In some embodiments, the durable outer layer comprises a material comprising at least 10% or more fluoropolymer. In some embodiments, the durable outer layer comprises a fluoropolymer wrap. In some embodiments, the fluoropolymer wrap comprises at least 10%, 15%, 20%, 25%, 30%, 35%, 40%, 45%, 50%, 55%, 60%, 65%, 70%, 75%, 80%, 85%, 90%, 95%, or more fluoropolymer. In some embodiments, the fluoropolymer wrap comprises at least 10%-20%, 15%-25%, 20%-30%, 25%-35%, 30%-40%, 35%-45%, 40%-50%, 45%-55%, 50%-60%, 55%-65%, 60%-70%, 65%-75%, 70%-80%, 75%-85%, 80%-90%, 85%-95% fluoropolymer. In some embodiments, the fluoropolymer wrap comprises at least 50% or more fluoropolymer.

In some embodiments, the fluoropolymer wrap comprises one or more of PTFE (polytetrafluoroethylene), PFA (perfluoroalkoxy fluorocarbon), FEP (fluorinated ethylene-propylene), PCTFE (polychlorotrifluoroethylene), ETFE (ethylene tetrafluoroethylene), ECTFE (ethylene chlorotrifluoroethylene), and PVDF (polyvinylidene fluoride). In some embodiments, the fluoropolymer wrap comprises a perfluorinated fluoropolymer. In some embodiments, the fluoropolymer wrap comprises a partially fluorinated fluoropolymer.

In some embodiments, the durable outer layer comprises a fluoropolymer wrap comprising ETFE (ethylene tetrafluoroethylene). In some embodiments, the durable outer layer comprises a fluoropolymer wrap comprising at least 10% or more ETFE. In some embodiments, the fluoropolymer wrap comprises at least 10%, 15%, 20%, 25%, 30%, 35%, 40%, 45%, 50%, 55%, 60%, 65%, 70%, 75%, 80%, 85%, 90%, 95%, or more ETFE. In some embodiments, the fluoropolymer wrap comprises at least 10%-20%, 15%-25%, 20%-30%, 25%-35%, 30%-40%, 35%-45%, 40%-50%, 45%-55%, 50%-60%, 55%-65%, 60%-70%, 65%-75%, 70%-80%, 75%-85%, 80%-90%, 85%-95% ETFE. In some embodiments, the fluoropolymer wrap comprises at least 50% or more ETFE.

In some embodiments, the layers of material may be wrapped in any order around the utility line. In some embodiments, the semi-conductive tape may include the inner most layer of material (closest to the utility line). In some embodiments, the outer most layer(s) (furthest away from the utility line) may include a durable and/or waterproof material, and/or a durable and/or abrasion-resistant material. In some embodiments, one or more layers of insulating material may include the one or more layers between the innermost layer and the outermost layer(s). In this way, the order of layers of wrapped materials may be determined by the order in which the materials have been wrapped around the utility line. In some embodiments, the desired order that the materials be wrapped around the utility line may determine the order in which the rolls of the material be loaded into the apparatus.

In some embodiments, the layers of wrapped material comprise an inner most layer of material that may include a semi-conductive tape, four or more layers of material that comprises an insulating material, and/or one or two layers of durable outer material. In some embodiments, the semi-conductive layer comprises a nylon tape. In some embodiments, the insulating layer comprises a polyimide film. In some embodiments, the insulating layer comprises a silicone tape. In some embodiments, the durable outer material may include ultra-high molecule weight polyethylene (UHMWPE) fibers, such as UHMWPE that is coated with a thermoplastic laminating film, such as a transparent or translucent film that may include polyester or polyethylene, and/or a nylon fabric, which may optionally be coated with one or more additional materials, such as materials to make the fabric water-resistant. In some embodiments, the durable outer material may include a Dyneema® Composite Fabric material and/or a Cordura fabric material. In some embodiments, the durable outer layer comprises a material comprising a fluoropolymer. In some embodiments, the durable outer layer comprises a material comprising ETFE (ethylene tetrafluoroethylene).

In some embodiments, the layers of wrapped material comprise an inner most layer of material that may include a semi-conductive tape, three layers of material that comprise an insulating material, and/or one or two layers of durable outer material. In some embodiments, the semi-conductive layer comprises a nylon tape. In some embodiments, the insulating layer comprise a polyimide film. In some embodiments, the insulating layer comprises a silicone tape. In some embodiments, the durable outer material may include ultra-high molecule weight polyethylene (UHMWPE) fibers. In some embodiments, the durable outer material may include a Dyneema® Composite Fabric material and/or a Cordura fabric material. In some embodiments, the durable outer layer comprises a material comprising a fluoropolymer. In some embodiments, the durable outer layer comprises a material comprising ETFE (ethylene tetrafluoroethylene).

In some embodiments, the layers of wrapped material comprise an inner most layer of material that may include a semi-conductive tape, two layers of material that may include an insulating material, and/or one or two layers of durable outer material. In some embodiments, the semi-conductive layer comprises a nylon tape. In some embodiments, the insulating layer may comprise a polyimide film. In some embodiments, the insulating layer comprises a silicone tape. In some embodiments, the durable outer material may include ultra-high molecule weight polyethylene (UHMWPE) fibers. In some embodiments, the durable outer material may comprise Dyneema® Composite Fabric material and/or a Cordura fabric material. In some embodiments, the durable outer layer comprises a material comprising a fluoropolymer. In some embodiments, the durable outer layer comprises a material comprising ETFE (ethylene tetrafluoroethylene).

In some embodiments, the layers of wrapped material comprise an inner most layer of material that may include a semi-conductive tape, one layer of material comprising an insulating material, and/or one or two layers of durable outer material. In some embodiments, the insulating layer comprises a polyimide film. In some embodiments, the insulating layer may comprise a silicone tape. In some embodiments, the durable outer material may include Dyneema® Composite Fabric material and/or a Cordura fabric material. In some embodiments, the durable outer layer comprises a material comprising a fluoropolymer. In some embodiments, the durable outer layer comprises a material comprising ETFE (ethylene tetrafluoroethylene).

In some embodiments, the utility line may be wrapped with a layer of material that results in the cooling of the utility line. In some embodiments, a cooling layer may boost the capacity of the utility line. Because cooler power lines can carry more power, the use of a layer of cooling material may be used to increase power throughput of utility lines. In some embodiments, the cooling layer of material may be used instead of the insulating layer. In some embodiments, the cooling layer of material may be used in addition to the insulating layer. In some embodiments, the material of the cooling layer may include a Passive Radiative Cooling (PRC) film and/or a similar material based on passive-cooling technology to enable passive cooling of utility lines. In some embodiments, the material of the cooling layer may be layered on top of an inner most layer of a semi-conductive material. In some embodiments, the material of the cooling layer may be layered underneath one or more durable outer layers of material.

In this way, at least one material wrapped around the utility line to form a layer of material is selected from the set consisting of: electrically semi-conductive, electrically insulating, heat-shrinkable, durable, waterproof, and anti-abrasion.

In some embodiments, a small air gap may be included between the inner most layer of material and the utility line.

In some embodiments, the wrapped layers of materials may be kept in place by way of clamps and/or zip ties at the attachment point (beginning of the material wrap) and/or at a detachment point (end of material wrap). In some embodiments, an adhesive may be used to affix a layer of material to the utility line and/or affix a layer of material to a subsequent layer or material.

### A. Fluoropolymer Wrap

In some embodiments, the material-wrapping subsystem may wrap the utility line with one or more layers of a film, wrap, or tubing that comprises a fluoropolymer. In some embodiments, the fluoropolymer wrap is the outermost layer of material layered on the utility line. In some embodiments, the fluoropolymer wrap is the durable outer layer. In some embodiments, the fluoropolymer wrap is the outermost layer and serves as an environmental barrier. In some embodiments, the fluoropolymer wrap is used in combination with layers of other wrapped material. In some embodiments, the fluoropolymer wrap is used as the only material wrapped around the utility line. In some embodiments, the fluoropolymer wrap is used to wrap around pre-existing, installed utility lines. In some embodiments, the fluoropolymer wrap is used to retrofit already installed utility lines. In some embodiments, a fluoropolymer wrap is used to wrap around live utility lines. In some embodiments, a fluoropolymer wrap is used by the apparatus described herein to wrap installed live utility lines. In some embodiments, a fluoropolymer wrap is used by the apparatus described herein to wrap installed live utility lines wherein the primary voltage of the live utility lines is over 100V, 200V, 300V, 400V, 500V, 600V, 700V, 800V, 900V, or 1000V. In some embodiments, a fluoropolymer wrap is used by the apparatus described herein to wrap installed live utility lines wherein the primary voltage of the live utility lines is over 600V.

Fluoropolymers are a family of plastic materials that contain fluorine in their molecular structures. Fluoropolymers can be divided into two groups: perfluorinated fluoropolymers and partially fluorinated fluoropolymers. The perfluorinated fluoropolymers are homopolymers and copolymers of TFE (tetrafluoroethylene) including PTFE (polytetrafluoroethylene), PFA (perfluoroalkoxy fluorocarbon), and FEP (fluorinated ethylene-propylene). Partially fluorinated fluoropolymers, including PCTFE (polychlorotrifluoroethylene), ETFE (ethylene tetrafluoroethylene), ECTFE (ethylene chlorotrifluoroethylene), and PVDF (polyvinylidene fluoride), have hydrogen, chlorine, or other atoms in their molecular structures in addition to fluorine and carbon. In some embodiments, the fluoropolymer wrap comprises a perfluorinated fluoropolymer. In some embodiments, the fluoropolymer wrap comprises a partially fluorinated fluoropolymer.

In some embodiments, the fluoropolymer wrap used in the systems and methods described herein comprises at least 10% or more fluoropolymer. In some embodiments, the fluoropolymer wrap comprises at least 10%, 15%, 20%, 25%, 30%, 35%, 40%, 45%, 50%, 55%, 60%, 65%, 70%, 75%, 80%, 85%, 90%, 95%, or more fluoropolymer. In some embodiments, the fluoropolymer wrap comprises at least 10%-20%, 15%-25%, 20%-30%, 25%-35%, 30%-40%, 35%-45%, 40%-50%, 45%-55%, 50%-60%, 55%-65%, 60%-70%, 65%-75%, 70%-80%, 75%-85%, 80%-90%, 85%-95% fluoropolymer. In some embodiments, the fluoropolymer wrap comprises at least 50% or more fluoropolymer.

In some embodiments, the fluoropolymer wrap used in the systems and methods described herein comprises ETFE (ethylene tetrafluoroethylene). In some embodiments, the fluoropolymer wrap used in the systems and methods described herein comprises at least 10% or more ETFE. In some embodiments, the fluoropolymer wrap comprises at least 10%, 15%, 20%, 25%, 30%, 35%, 40%, 45%, 50%, 55%, 60%, 65%, 70%, 75%, 80%, 85%, 90%, 95%, or more ETFE. In some embodiments, the fluoropolymer wrap comprises at least 10%-20%, 15%-25%, 20%-30%, 25%-35%, 30%-40%, 35%-45%, 40%-50%, 45%-55%, 50%-60%, 55%-65%, 60%-70%, 65%-75%, 70%-80%, 75%-85%, 80%-90%, 85%-95% ETFE. In some embodiments, the fluoropolymer wrap comprises at least 50% or more ETFE.

In some embodiments, the fluoropolymer wrap used in the systems and methods described herein comprises a fluoropolymer formulated with an additive (e.g., glass, carbon).

In some embodiments, the fluoropolymer wrap used in the systems and methods described herein comprises one or more layers of an inorganic material. In some embodiments, the occurrence of partial discharge and electrical treeing is blocked or lessened by the addition of one or more layers of inorganic material into the fluoropolymer wrap. In some embodiments, the inorganic material layered into the fluoropolymer wrap may include, but is not limited to, mica, glass, synthetic mica, large flake muscovite made into a thin flexible film (hand laid mica on kapton), boron nitride, alumina, silica, titanium dioxide, silicon nitride, montmorillonite, calcium silicate, and zinc oxide. In some embodiments, the inorganic material layered into the fluoropolymer wrap is mica. In some embodiments, the inorganic material layered into the fluoropolymer wrap is synthetic mica. In some embodiments, the inorganic material is integrated into the fluoropolymer wrap as a composite.

In some embodiments, the inorganic material is prepared into thin layer, wherein the layer of inorganic material is layered on the surface of the fluoropolymer wrap. In some embodiments, the inorganic material layer is placed into the fluoropolymer wrap.

In some embodiments, the thickness of the inorganic material layer is between 0.25-7 mm, 0.5-7 mm, 1-7 mm, 2-7 mm, 3-7 mm, 4-7 mm, 5-7 mm, 6-7 mm, 1-6 mm, 2-6 mm, 3-6 mm, 4-6 mm, 5-6 mm, 1-5 mm, 2-5 mm, 3-5 mm, 4-5 mm, 1-4 mm, 2-4 mm, or 3-4 mm. In some embodiments, the inorganic material layer is between 3-5 mm thick. In some embodiments, the total insulating layer may be between 2-6 mm thick. In some embodiments, the inorganic material layer is about 1 mm thick. In some embodiments, the inorganic material layer is about 2 mm thick. In some embodiments, the inorganic material layer is about 3 mm thick. In some embodiments, the inorganic material layer is about 4 mm thick. In some embodiments, the inorganic material layer is about 5 mm thick. In some embodiments the inorganic material layer is about 6 mm thick.

In some embodiments, the fluoropolymer wrap used in the systems and methods described herein comprises one or more properties including, but not limited to, high chemical resistance, high thermal stability, low surface friction, non-stick properties, high impact resistance, high weather resistance, high UV resistance, purity and biocompatibility, high mechanical strength and durability, non-electrically-conductive (high dielectric strength and low dielectric constant), high dielectric breakdown voltage, and easy machining and fabrication. In some embodiments, the fluoropolymer wrap may provide protection of the utility line against corrosive chemicals, extreme temperatures, and harsh weather conditions.

In some embodiments, the fluoropolymer wrap used in the systems and methods described herein is resistant to acids, bases, solvents, and oils; is resistant to high heat; has low permeability; is resistant to moisture; is flame retardant; is low weight; has high light transmission in the visible as well as in the IR and UV range; has high durability; and has high longevity. In some embodiments, the fluoropolymer wrap does not rub, stick or break under tension; insulates against both electricity and heat; is resistant to UV light and corrosion; and is non-toxic, sterile, and inert. In some embodiments, the fluoropolymer wrap exhibits low leeching, low extractables, and low outgassing, and is resistant to bacteria and fungus buildup.

In some embodiments, the fluoropolymer wrap is heat-sealable (apply heat to seal the fluoropolymer wrap onto itself). The heat-sealed fluoropolymer wrap would result in a continuous weather-proof barrier around the utility line without using a separate adhesive. In some embodiments, the fluoropolymer wrap does not require a separate adhesive layer in order to affix the fluoropolymer wrap to the utility line or to itself. In some embodiments, the heat-sealed fluoropolymer wrap does not require clamps to affix the ends of the fluoropolymer wrap to the utility line.

In some embodiments, the fluoropolymer wrap used in the systems and methods described herein is very hard and also exhibits high elongation, low surface friction, and high impact resistance. This combination of characteristics allows the fluoropolymer wrap to stretch and contract with the heating and cooling of the utility line in addition to resisting abrasion due to vegetation rubbing.

In some embodiments, the fluoropolymer wrap used in the systems and methods described herein exhibits a high dielectric strength and low dissipation factor. In some embodiments, the fluoropolymer wrap has a dielectric strength of at least 100 volts, 200 volts, 300 volts, 400 volts, 500 volts, 600 volts, 700 volts, 800 volts, 900 volts, 1000 volts, 1100 volts, 1200 volts, 1300 volts, 1400 volts, 1500 volts, 1600 volts, 1700 volts, 1800 volts, 1900 volts, or 2000 volts. In some embodiments, the fluoropolymer wrap has a dielectric strength of at least 1kV, 2kV, 3kV, 4kV, 5kV, 6kV, 7kV, 8kV, 9kV, 10kV, 11kV, 12kV, 13kV, 14kV, 15kV, 16kV, 17kV, 18kV, 19kV, 20kV, 21kV, 22kV, 23kV, 24kV, 25kV, 26kV, 27kV, 28kV, 29kV, 30kV, 31kV, 32kV, 33kV, 34kV, 35kV, 36kV, 37kV, 38kV, 39kV, 40kV, 41kV, 42kV, 43kV, 44kV, 45kV, 46kV, 47kV, 48kV, 49kV, 50kV, 51kV, 52kV, 53kV, 54kV, 55kV, 56kV, 57kV, 58kV, 59kV, or 60kV.

In some embodiments, the fluoropolymer wrap has a dielectric strength of between 100 volts to 2kV, 1kV to 3kV, 2kV to 4kV, 3kV to 5kV, 4kV to 6kV, 5kV to 7kV, 6kV to 8kV, 7kV to 9kV, 8kV to 10kV, 9kV to 11kV, 10kV to 12kV, 11kV to 13kV, 12kV to 14kV, 13kV to 15kV, 14kV to 16kV, 15kV to 17kV, 16kV to 18kV, 17kV to 19kV, 18kV to 20kV, 19kV to 21kV, 20kV to 22kV, 21kV to 23kV, 22kV to 24kV, 23kV to 25kV, 24kV to 26kV, 25kV to 27kV, 26kV to 28kV, 27kV to 29kV, 28kV to 30kV, 29kV to 31kV, 30kV to 32kV, 31kV to 33kV, 32kV to 34kV, 33kV to 35kV, 34kV to 36kV, 35kV to 37kV, 36kV to 38kV, 37kV to 39kV, 38kV to 40kV, 39kV to 41kV, 40kV to 42kV, 41kV to 43kV, 42kV to 44kV, 43kV to 45kV, 44kV to 46kV, 45kV to 47kV, 46kV to 48kV, 47kV to 49kV, 48kV to 50kV, 49kV to 51kV, 50kV to 52kV, 51kV to 53kV, 52kV to 54kV, 53kV to 55kV, 54kV to 56kV, 55kV to 57kV, 56kV to 58kV, 57kV to 59kV, or 58kV to 60kV.

In some embodiments, the thickness of the fluoropolymer wrap used in the systems and methods described herein is between 1 mil and 100 mil. In some embodiments, the thickness of the fluoropolymer wrap is between 1 mil and 15 mil, 5 mil and 20 mil, 10 mil and 25 mil, 15 mil and 30 mil, 20 mil and 35 mil, 25 mil and 40 mil, 30 mil and 45 mil, 35 mil and 50 mil, 40 mil and 55 mil, 45 mil and 60 mil, 50 mil and 65 mil, 55 mil and 70 mil, 60 mil and 75 mil, 65 mil and 80 mil, 70 mil and 85 mil, 75 mil and 90 mil, 80 mil and 95 mil, or 85 mil and 100 mil. In some embodiments, the thickness of the fluoropolymer wrap is 1 mil, 2 mil, 3 mil, 4 mil, 5 mil, 6 mil, 7 mil, 8 mil, 9 mil, 10 mil, 11 mil, 12 mil, 13 mil, 14 mil, 15 mil, 16 mil, 17 mil, 18 mil, 19 mil, 20 mil, 21 mil, 22 mil, 23 mil, 24 mil, 25 mil, 26 mil, 27 mil, 28 mil, 29 mil, 30 mil, 35 mil, 40 mil, 45 mil, 50 mil, 55 mil, 56 mil, 57 mil, 58 mil, 59 mil, 60 mil, 61 mil, 62 mil, 63 mil, 64 mil, 65 mil, 66 mil, 67 mil, 68 mil, 69 mil, 70 mil, 71 mil, 72 mil, 73 mil, 74 mil, 75 mil, 76 mil, 77 mil, 78 mil, 79 mil, 80 mil, 81 mil, 82 mil, 83 mil, 84 mil, 85 mil, 90 mil, 95 mil, or 100 mil.

In some embodiments, the fluoropolymer wrap may be wrapped in a uniform thickness around the utility line. In some embodiments, the fluoropolymer wrap may be wrapped in layers of various thickness around the utility line. In some embodiments, the layer of fluoropolymer wrap around a first section of the utility line is thicker than the layer of fluoropolymer wrap around a second section of the utility line. In some embodiments, the layer of fluoropolymer wrap around a first section of the utility line is thinner than the layer of fluoropolymer wrap around a second section of the utility line.

In some embodiments, the fluoropolymer wrap is wrapped around the length of the utility line between the utility poles. In some embodiments, the fluoropolymer wrap is not wrapped around the insulators (the connection points where the utility line meets the utility pole). In some embodiments, the fluoropolymer wrap is used in sections of the utility line where there are no extreme electric fields. This avoids premature breakdown of the fluoropolymer wrap due to partial discharge. In some embodiments, the fluoropolymer wrap is wrapped around the insulators.

In some embodiments, one or more laser diodes are used to heat the fluoropolymer wrap. In some embodiments, the infrared (IR) lasers heat the fluoropolymer wrap resulting in the fluoropolymer wrap bonding onto itself. The heating seals the fluoropolymer wrap providing a waterproof seal around the inner layers of material wrapped around the utility line. In some embodiments, one or more lasers (i.e. radiation) are used to heat the fluoropolymer wrap.

In some embodiments, resistance wire (i.e. convective heating) is used to heat the fluoropolymer wrap, resulting in the fluoropolymer wrap bonding onto itself.

In some embodiments, the fluoropolymer wrap used in the systems and methods described herein exhibits a low dielectric constant (the ability of the fluoropolymer wrap to store electrical energy). The low dielectric constant of the fluoropolymer wrap means it is less susceptible to partial discharge, which is critical for the longevity of the fluoropolymer wrap used in the systems and methods described herein. In some embodiments, the fluoropolymer wrap is applied to pre-existing, installed (i.e. aged) utility line wires that may have impurities, water, and/or air trapped between the utility line and the fluoropolymer wrap which makes a low dielectric constant important. The low dielectric constant means less extreme electric fields, which decreases the chances of partial discharge and increases the service life of the material.

Non-limiting examples of fluoropolymer wrap that may be used in the systems and methods described herein include, but are not limited to, ENSIKEM® (Ensinger); KYNAR® (Ensinger); TECAFIL® (Ensinger); TECAFLON® (Ensinger); TECASINT® (Ensinger); Fluorosint™ (Mitsubishi Chemical Advanced Materials); Semitron™ (Mitsubishi Chemical Advanced Materials); Semitron™ ESd (Mitsubishi Chemical Advanced Materials); ESD (RTP Company); RTP (RTP Company); TriSteel (TriStar)™; Clariflex™ (Westlake Plastics); Fluorolux™ (Westlake Plastics); Halar® (Westlake Plastics); Kynar® (Westlake Plastics); Tefzel™ (Westlake Plastics); Dyneon™ (3M); Novec™ (3M); TFM™ (3M Dyneon); THV™ (3M Dyneon); Adalon® (Adamas); Lakinor® (Adamas); F-Clean™ (AGC); Fluon™ (AGC); Smokeguard™ (AlphaGary); APSOplast® (Angst+Pfister); APSOseal® (Angst+Pfister); NOVAFLON® (Angst+Pfister); TEADIT® (Angst+Pfister); UCAR-323® (Angst+Pfister); KYNAR FLEX® (Arkema Group); Kynar Super Flex® (Arkema Group); Kynar Superflex® (Arkema Group); Kynar® (Arkema Group); VOLTALEF® (Arkema Group); TARFLEN® (Zaklady Azotowe); CENTROFLON™ (CENTROPLAST Engineering Plastics GMBH); ECCtreme™ ECA (Chemours); ECCtreme™ (Chemours); Teflon™ (Chemours); Teflon™ C PFA (Chemours); Teflon™ PFA (Chemours); Teflon™ PTFE (Chemours); Teflon™ FEPD (Chemours); Teflon™ PFAD (Chemours); Tefzel™ (Chemours); Viton™ (Chemours); Zonyl™ (Chemours); Valvelon® (Chesterton); Cri-plastMP™ (Cri-Tech); DAI-EL® (Daikin Industries); NEOFLON® (Daikin Industries); POLYFLON™ (Daikin Industries); Dalcon™ (Dalau); Tedlar® (DuPont); Tedlar® SP (DuPont); Vespel® (DuPont Mobility and Materials); Dyflor® (Evonik Corporation); GYLON® (Garlock Rubber Technologies); STRESS SAVER® (Garlock Rubber Technologies; TENFIL (Guarniflon); ACLAR® (Honeywell); Halar® (Honeywell); UltRx® (Honeywell); Teflon™ (Isoflon); Tisoflon® (Isoflon); Klinger® (Klinger Thermoseal); Thermocomp™ (LNP); RULON® (Manifattura Cattaneo spa); Michem® Glide (Michelman); MikroFLON® (Mikro-Technik); Reproflon® (Mikro-Technik); Murflor® (Murtfeldt Kunststoffe GmbH & Co); Murinyl® (Murtfeldt Kunststoffe GmbH & Co); OKULEN® (Okulen); Nelco® (Park Aerospace); EFALON® (Polikim Polimer ve Kimya Sanay); POLITEF® (Polimersan Plastics); RamLloy (Polyram); Teflon® (Process Technologies Inc); Tyfluor™ (Process Technologies Inc); Symalit® (Quadrant Engineering Plastics Products); Redco™ (Redwood Plastics); Fibracon® (Röchling); Polystone® (Röchling); SUSTA ECTFE (Röchling); SUSTAPVDF (Röchling); Waywodec® (Röchling); CuClad® (Rogers Arlon); DiClad® (Rogers Arlon); IsoClad® (Rogers Arlon); Secure (Rogers Arlon); RT/duroid® (Rogers Corporation); LNP™ LUBRICOMP™ (SABIC); LNP™ LUBRICOMP™ Compound (SABIC); LNP STAT-KON™ (SABIC); LNP STAT-KON™ Compound; (SABIC); LNP™ THERMOCOMP™ (SABIC); LNP™ THERMOCOMP™ Compound; (SABIC); Chemlam® (Saint-Gobain Performance Plastics); Chemlam® RL (Saint-Gobain Performance Plastics); Fluoroloy® (Saint-Gobain Performance Plastics); Norglide® (Saint-Gobain Performance Plastics); Norton® (Saint-Gobain Performance Plastics); Norton® Chemfilm® (Saint-Gobain Performance Plastics); Norton® Fluorglas® Chemfilm® (Saint-Gobain Performance Plastics); Rulon® (Saint-Gobain Performance Plastics); Tygon® (Saint-Gobain Performance Plastics); Kanthal® (Sandvik); ISOray (Shakespeare Company); Fluoro T (Shamrock Technologies); MicroFLON® (Shamrock Technologies); NanoFLON® (Shamrock Technologies); Ajedium™ (Syensqo (Solvay Specialty Polymers)); Ajedium Film™ (Syensqo (Solvay Specialty Polymers)); Ajedium Film-Halar™ (Syensqo (Solvay Specialty Polymers)); Ajedium Film™-Solef (Syensqo (Solvay Specialty Polymers)); SIMONA (SIMONA America); Algoflon® (Syensqo (Solvay Specialty Polymers)); and Aquivion® (Syensqo (Solvay Specialty Polymers)).

In some embodiments, the wrapped utility lines described herein may be manufactured as uninstalled utility lines. In some embodiments, the wrapped utility lines described herein may be manufactured in a factory setting before being installed in the field. In some embodiments, the wrapping is performed on existing utility lines.

### 2. Adhesive Application

In some embodiments, adhesives may be used to adhere the layers of film to the utility line and/or to adhere the one or more layers of film to each other. Adhesives used may include, but are not limited to, epoxies (e.g. UV curable epoxy, flexible epoxy, rigid epoxy, 3M DP125 epoxy, and/or Loctite AA 30305), polyurethanes, acrylics, anaerobics, cyanoacrylates, polyesters, polyvinyls, phenolic resins, polyimides, pressure-sensitive adhesives, hot-melt adhesives, ultraviolet-cured adhesives, contact adhesives, structural adhesives, synthetic adhesives, and/or natural adhesives (e.g. glue, starch, dextrin, and/or natural gums). In certain embodiments, the adhesive may include Loctite AA 3035. In certain embodiments, the adhesive may include 3 M DP125 epoxy.

In some embodiments, the adhesive may be layered between the utility line and the first film layer. In some embodiments, the adhesive may be layered between the first film layer and the second film layer. In some embodiments, the adhesive may be layered between the second film layer and the third film layer. In some embodiments, the adhesive may be layered between the third film layer and the fourth film layer. In some embodiments, the adhesive may be layered between the fourth film layer and the fifth film layer.

In some embodiments, adhesives may be used to affix the one or more layers of material to the utility line and/or to other layers of material.

In some embodiments, epoxy may be used instead of layers of materials. In some embodiments, a first layer of epoxy may be applied to the utility line (e.g. UV-cured epoxies and/or other quick-curing epoxies). In some embodiments, the first layer may include an epoxy that may include a conductive additive that may form a hard semi-conducting layer. In some embodiments, a second layer of epoxy (e.g. UV-cured epoxies and/or other quick-curing epoxies) may be applied over the first layer of epoxy. In some embodiments, the second layer may include an epoxy that may include an additive to increase the electrical insulating properties of the epoxy.

In some embodiments, candidates for additives include, but are not limited to, barium titanate, aluminum oxide (alumina), and/or magnesium oxide. In some embodiments, barium titanate nanoparticles may be dispersed within UV-curable vinyl epoxy matrices to enhance dielectric constant and/or insulation resistance. In some embodiments, aluminum oxide may be added to UV-curable vinyl epoxy formulations to increase insulation resistance and/or improve overall electrical performance. In some embodiments, magnesium oxide may be added to UV-curable vinyl epoxy matrices to enhance dielectric strength and/or improve insulation resistance. In some embodiments, the additives may be premixed in the epoxy prior to administration.

In some embodiments, the apparatus may include a system to apply the adhesive. In some embodiments, the application of adhesive may be performed by a system that may include a motorized and/or electronically controlled two-part epoxy applicator. In some embodiments, the system may include an epoxy canister and/or a plunger. In some embodiments, the system may deploy a two-part epoxy adhesive onto the outermost layer of material and/or the outermost layer of epoxy such that the final outermost layer of epoxy may bond to itself. In some embodiments, this bonding may form a durable and/or waterproof seal. In some embodiments, the movement of the plunger may be controlled by a linear actuator. In some embodiments, the linear actuator may include a NEMA 8 linear actuator. The plunger may be guided into the housing surrounding the epoxy canister and/or may be pressed against the rear of the epoxy canister. In some embodiments, the actuator may pull the plunger into the epoxy canister enabling the epoxy to be dispensed.

### C. Material-Heating Subsystem

In some embodiments, the apparatus may include a material-heating subsystem. In some embodiments, the material-heating subsystem may be used to expedite the curing process of an adhesive, and/or to activate a heat-shrinkable tape outer layer. In some embodiments, the material-heating subsystem may include one or more components, for example a heat gun and/or an extension nozzle, and/or a heat sealing oven. In some embodiments, the material-heating subsystem comprises one or more laser diodes. In some embodiments, the material-heating subsystem comprises infrared (IR) lasers which heat the outermost layer of wrapped material. In some embodiments, the lasers heat the material of the outermost layer resulting in the material of the outermost layer bonding onto itself. The heating seals the outermost layer providing a waterproof seal around the layers of material wrapped around the utility line. In some embodiments, one or more lasers (i.e. radiation) are used to heat the outermost layer. In some embodiments, one or more lasers are used to heat the outermost layer, wherein the outermost layer comprises a fluoropolymer wrap. In some embodiments, the heat from the one or more lasers causes the fluoropolymer wrap to seal on itself.

In some embodiments, the material-heating subsystem comprises resistance wire. In some embodiments, resistance wire (i.e. convective heating) is used to heat the outermost layer. In some embodiments, resistance wire is used to heat the outermost layer, wherein the outermost layer comprises a fluoropolymer wrap. In some embodiments, the heat from the resistance wire causes the fluoropolymer wrap to seal on itself.

In some embodiments, the material-heating subsystem may operate by way of a heat gun generating hot air. The hot air may move through the extension nozzle and onto the target area. In some embodiments, the target area may include adhesive (e.g. epoxy) placed under and/or over wrapped layers of material located along the length of a utility line. In some embodiments, the target area may include any area along the length of the utility line where heat tape may be present. In some embodiments, the extension nozzle may be made from PEEK to withstand the heat produced by the heat gun while remaining electrically insulative. In some embodiments, the extension nozzle may include a heat reflector at the target end to apply and/or control the heat transfer process more effectively.

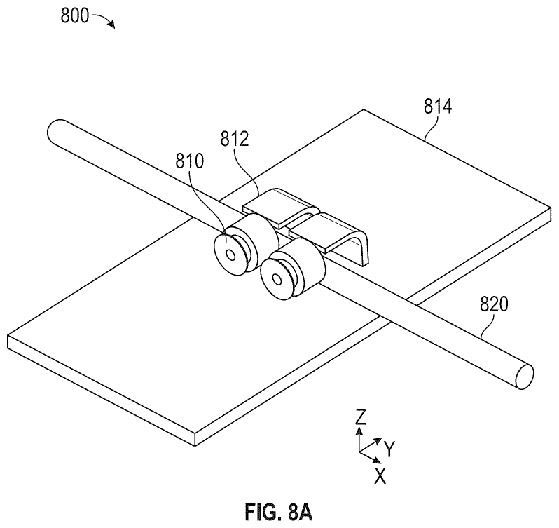

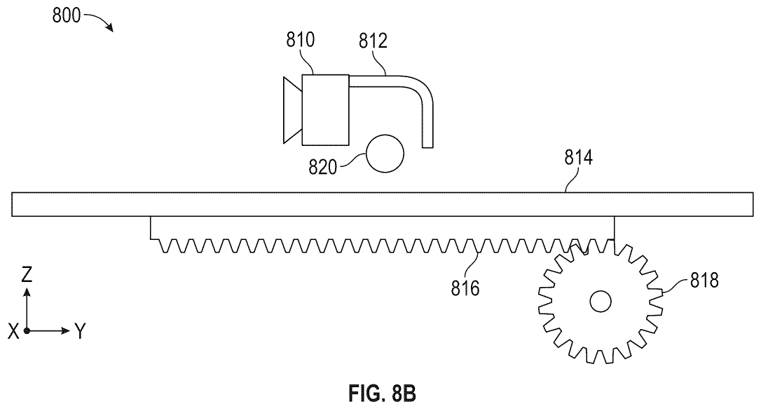

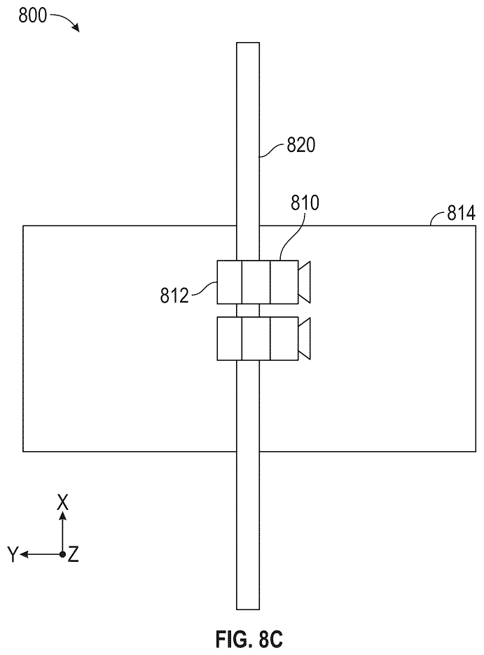

FIG. 8A depicts a perspective view of an exemplary material-heating subsystem 800 that may include one or more heating assemblies 810 and/or one or more mounts 812. Material-heating subsystem 800 may be placed downstream of the material-wrapping subsystem thereby heating the material wrapped around the utility line by the material-wrapping subsystem. Material-heating subsystem may include one or more heating assemblies. For example, material-heating subsystem may include two heating assemblies 810 and/or two mounts 812. Mount 812 may be configured to mount heating assembly 810 above a utility line 820 without contacting the line. Heating assembly 810 may include one or more heating elements, for example one or more resistance heaters, and/or one or more fans that may direct air over the one or more heating elements. This heated air may be blown through a nozzle designed to force the heated air onto the top of utility line, for example a semi-circular nozzle. Material-heating subsystem 800 may further include a plate 814 below line 820 that may extend along the Y-axis using a rack-and-pinion system as described below. In this way, plate 814 may be configured to be moved into and out of proximity with the utility line. Plate 814 may include a material with a high thermal reflectivity and/or low thermal emissivity to reflect more heat radiating from the heating element and/or nearby surfaces, for example to reflect more infrared radiation, relative to a material of higher emissivity. Because plate 814 may be located on a side of the utility line that is opposite to the heating element and/or heating assembly 810, plate 814 may also trap heated air blown onto utility line 820 by heating assembly 810, thereby increasing the temperature of the utility line. In these ways, plate 814 may ensure heated air blown from heating assembly 810 may reach, and heat, the bottom of line 820, thereby increasing the uniformity of the heating applied by material-heating subsystem 800.

In some embodiments, the material-heating subsystem comprises one or more laser diodes. In some embodiments, the material-heating subsystem comprises infrared (IR) lasers which heat the outermost layer of wrapped material.

Thus, material-heating subsystem 800 may heat line 820 and/or the one or more materials that have been wrapped onto the line by the material-wrapping subsystem. As described above, these materials may include one or more semi-conductive tapes, one or more insulating tapes, and/or one or more durable outer materials. For example, if the one or more durable outer materials include heat-shrinkable tape, heat applied by material-heating subsystem 800 may serve to shrink the tape onto the one or more materials that have been wrapped below it, for example one or more semi-conductive tapes and/or one or more insulating tapes. This shrinking in turn may ensure the one or more semi-conductive tapes and/or one or more insulating tapes are held against line 820 thereby electrically insulating the line. In some embodiments, the material-heating subsystem comprises one or more laser diodes. In some embodiments, the material-heating subsystem comprises infrared (IR) lasers which heat the outer layer of wrapped material resulting in the material of the outer layer bonding onto itself. The heating seals the outer layer providing a waterproof seal around the layers of material wrapped around the utility line.

FIG. 8B depicts a side view of material-heating subsystem 800, including heating assembly 810 and/or mount 812. Mount 812 may be configured to connect to the apparatus to such that it is centered over utility line 820, and may be shaped to further direct heated air or other heat source onto line 820. For example, as shown in FIG. 8B, mount 812 may form a bend that is about 90 degrees and that in conjunction with then nozzle of heating assembly 810 serves to direct heated air onto line 820. Plate 814 may include a reflective coating and/or the presence of 814 may ensure heated air is trapped next to line 820 thereby increasing the temperature of line 820 and/or the efficiency of material-heating subsystem 800. A gap between mount 812 and plate 814 may exist to enable plate 814 to translate along the Y-axis. Such translation may be important, for example, to allow plate 814 to translate sufficiently along the Y-axis to line 820 to pass by during installation of the apparatus onto the line and/or during removal of the apparatus from the line.

To enable translation of plate 814, a rack 816 with gear teeth may be attached to plate 814, and may be translated by rotation of a pinion gear 818 with gear teeth that may match those of rack 816. A motor, for example a stepper motor, may be attached to gear 818 thereby allowing the rotation of the motor to control the translation of plate 814.

FIG. 8C depicts a top view of material-heating subsystem 800, including heating assembly 810, mount 812, and/or plate 814. As described above, following translation of plate 814, heating assemblies 810 may be located above line 820 and/or plate 814 may be located below line 820, thereby trapping heated air. This trapped air effect, created as the apparatus is traveling along 820 may generate a “heat tunnel” that may serve to reduce the dimensions of heat-shrinkable material applied by the material-wrapping subsystem, thereby ensuring that wrapped materials remain reliably attached to line 820.

In some embodiments, the apparatus may comprise a heat sealing oven which activates the heat-shrinkable tape outer layer and results in the outer layer sealing on itself. In some embodiments, the apparatus comprises one or more laser diodes which heats the heat-shrinkable outermost layer of wrapped material. In some embodiments, the heating results in the material of the heat-shrinkable outermost layer bonding onto itself. The heating seals the outermost layer providing a waterproof seal around the layers of material wrapped around the utility line.

### D. Material-clamping Subsystem

In some embodiments, the apparatus may include material-clamping subsystem 313 as depicted in FIG. 3. In some embodiments, the material-clamping subsystem may apply a clamp around a utility line that has been wrapped in one or more layers of material by the material-wrapping subsystem to hold the layers or wrapped material in place. In some embodiments, the material-clamping subsystem may apply a clamp to the beginning of the wrapped layers on the utility line and/or to the end of the wrapped layers on the utility line in order to affix the layers of material to the entire length of the utility line. In some embodiments, the clamps may be made from materials that may include, but not limited to, Nylon 12, polyketone, Nylon 6.6, polyproplylene, polyphenylene, and/or acetal (polyoxymethylene or POM). In some embodiments, the clamps may be heat resistant and/or may not be electrically conductive. In some embodiments, the clamp may include a HCL clip (e.g. Herbie clips provided by HCL fasteners). In some embodiments, the clamps may include zip-ties and/or another type of fastener. In some embodiments, the clamps (e.g. HCL clips) may have two rows of teeth to hold the layers of material films onto the utility line. In some embodiments, the material-clamping subsystem may include clamps in a range of sizes. The appropriate size clamp may be selected based on the diameter of the utility line that the material layers have been wrapped around.

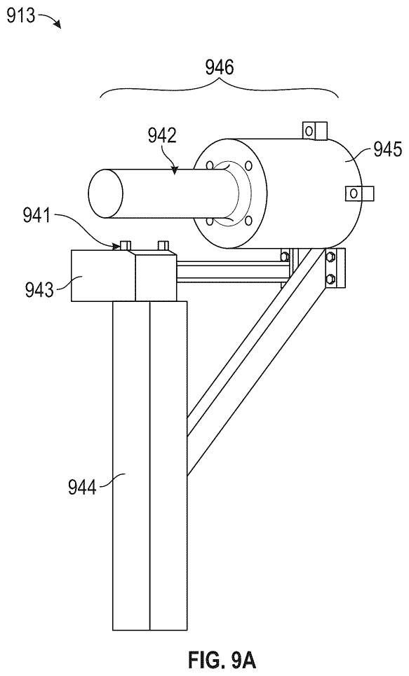

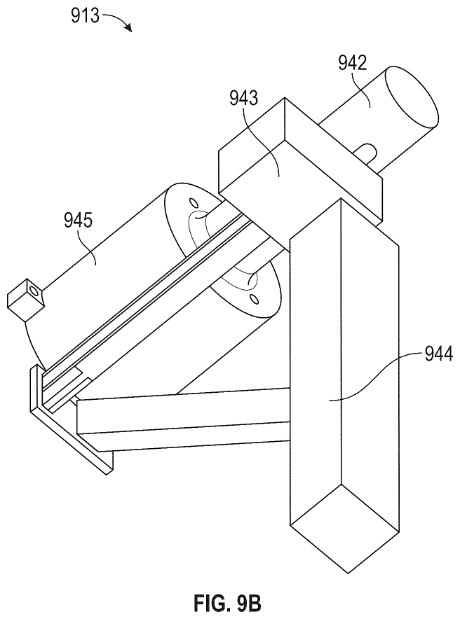

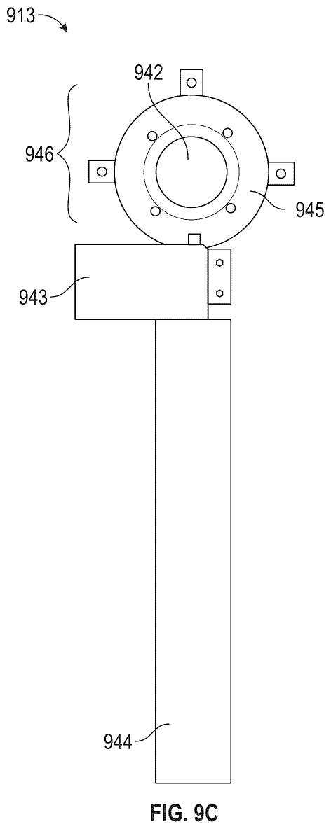

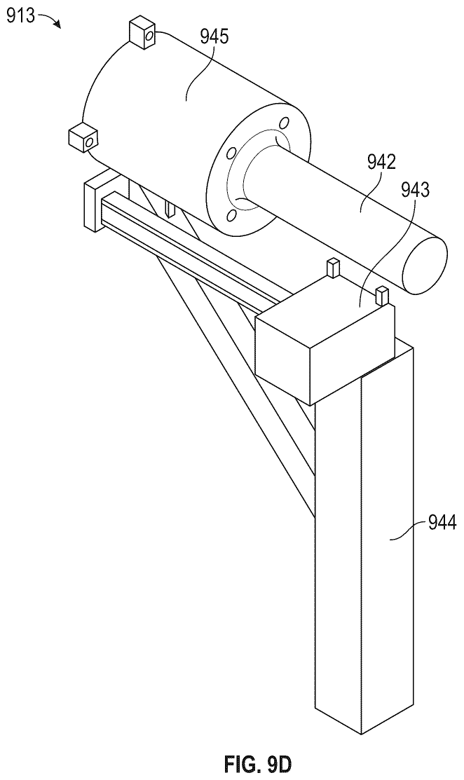

An exemplary material-clamping subsystem may apply a clamp to the utility line over the outermost layers of material that was wrapped onto the utility line by the material-wrapping subsystem to hold one or more of the material layers in place. In some embodiments, the material-clamping subsystem 913 may include two main components as shown in FIG. 9A-D. In some embodiments, a first main component of the material-clamping subsystem may include a Clamp Pusher component 941. In some embodiments, a second main component of the material-clamping subsystem may include a Clamp Tightener component 946.

In some embodiments, the Clamp Pusher component 941 may house a magazine 943 of one or more clamps (e.g. HCL clips). The magazine 943 may include 1, 2, 3, 4, 5, 6, 7, 8, 9, 10, and/or more clamps. In some embodiments, the magazine may include about 6 clamps. In some embodiments, the Clamp Pusher 941 may use a captive linear actuator 944 to lift the HCL clip (which is in the open position) onto the utility line. In some embodiments, the magazine 943 that may house the clamps may be spring loaded. In some embodiments, spring loading the magazine may ensure that after a clamp is pushed onto and around the utility line, the next clamp (e.g. HCL clip) may be located in the correct position for the next application to a utility line.

In some embodiments, the material-clamping subsystem may include a Clamp Tightener 946. In some embodiments, the Clamp Tightener 946 may include a tubing 942 with a small slit for a clamp (e.g. HCL clip), in addition to a captive linear actuator 945. In some embodiments, the Clamp Pusher 941 may lift the clamp (e.g. HCL clip) into position over the power line, and into the slit in the Clamp Tightener housing. In some embodiments, once the clamp (e.g. an HCL clip) is in position, the captive linear actuator 945 may push on the clamp and tighten it by squeezing the clamp shut around the outer layer of material. In certain embodiments, the captive linear actuator may be a NEMA 17 captive linear actuator.

### E. Material-Cutting Subsystem

In some embodiments, the apparatus may include a material-cutting subsystem 1050 as depicted in FIG. 10. In some embodiments, the material-cutting subsystem may cut the layers of material once the wrapping of the utility line has been completed. In some embodiments, the material-cutting subsystem may cut the layers of material if the apparatus needs to be disconnected by the UAV.

In some embodiments, the material-cutting subsystem may include a linear actuator (not shown) attached to a cutting blade 1051. In some embodiments, the linear actuator may be a NEMA 8 linear actuator. In some embodiments, the cutting blade 1051 may be attached to the attachment point for the actuator 1052 by a lead screw 1053. As illustrated in FIG. 10, the linear actuator may control the position of the blade. In the rest position, the cutting blade 1051 may sit at the starting point of the actuator (the “0 ” position on the lead screw). When cutting is initiated, the actuator may drive the cutting blade across one or more layers of material cutting them.

In some embodiments, the material-cutting subsystem may be used in addition to the material-clamping subsystem. In some embodiments, the material-cutting subsystem may be used in place of the material-clamping subsystem.

### III. MODULAR EXTENSION ARMS

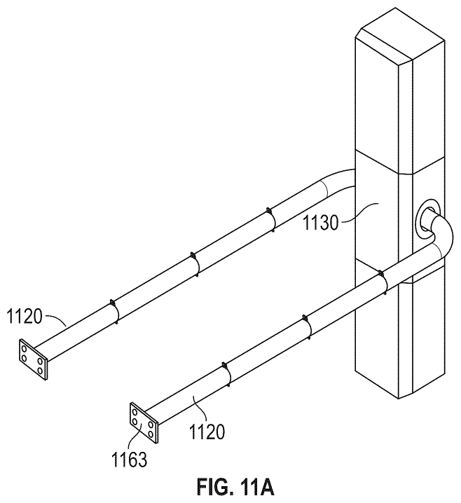

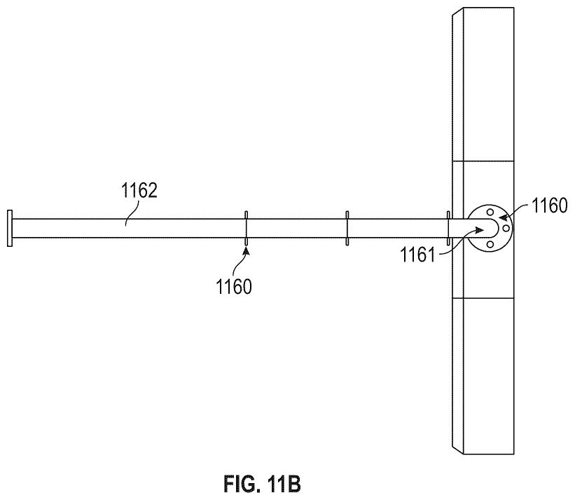

In some embodiments, the electromechanical system may include one or more modular extension arm(s) 320 as depicted in FIG. 3. In some embodiments, the one or more extension arms may attach the UAV to the apparatus. In some embodiments, the UAV may be attached to the apparatus by two extension arms 1120, as illustrated in FIG. 11A. Extension arms 1120 may attach to the UAV by connecting to the electronics box 1130 which is located on the bottom of the UAV. The electronics box 1130 may be mounted to a mounting plate, wherein the mounting plate is connected to the UAV. The electronics box 1130 may house the electronics that drive the electromechanical system. In certain embodiments, the electronics include, but are not limited to, a microcontroller and/or one or more motor controllers. In some embodiments, the microcontroller may include an Arduino Uno. In some embodiments, the one or more motor controllers may include a CNC Arduino shield for driving four motors. In some embodiments, the electronics box 1130 may house no voltage regulators. In some embodiments, all voltage regulation may be performed on the UAV.

In some embodiments, extension arms 1120 may be fixed to the electronics box 1130 using bolts 1160. In some embodiments, the bolts 1160 may be M4 bolts. Extension arms 1120 may connect the apparatus to the electronics box 1130 of the UAV. In some embodiments, the angle of the attachment between the arms and the electronics box and/or the arms and the apparatus may be altered. This alteration of the angle of attachment may allow the UAV to place the apparatus in tighter spaces and/or different configurations of utility lines. In some embodiments, the alteration of the angle of attachment may be accomplished by two servo motors located on either end of the extension arms, for example where the arms attach to the electronics box and where the arms attach to the apparatus. In some embodiments, the electronics box 1130 may include a first servo motor 1161 as shown in FIG. 11B. In some embodiments, the electronics box 1130 may include a second servo motor 1163 as shown in FIG. 11A. Second servo motor 1163 may be located at the attachment point of the extension arms to the apparatus.

In some embodiments, extension arms 1120 may be hollow and/or modular. In some embodiments, this may allow different lengths of the extension arms to be used. In some embodiments, the arms may be hollow which may allow wires to be run between the apparatus and the electronics box 1130. The extension arms may come in six inch sections which may slide together using a dovetail cut 1162 and/or two bolts 1160. In some embodiments, the bolts 1160 may be M4 bolts.

In some embodiments, the extension arms 1120 may be capable of extension and retraction, for example telescopic extension. Upon takeoff, while the UAV may be attached to the apparatus by way of the retractable extension arms (e.g. from ground take-off to the utility line), the extension arms may be in a retracted (shortened) configuration in order to keep the apparatus as close as possible to the UAV (e.g. 8 -18 inches). The shorter extension arms may increase the stability of the entire electromechanical system while it files by allowing for the center of mass of the total electromechanical system to be closer to the UAV, resulting in easier piloting of the UAV and directing of the apparatus on to the utility line or while landing with the apparatus attached.

When approaching the utility line, the modular arms may extend (e.g. 30-40 inches) to place the apparatus on to the utility line. In some embodiments, the extension arms may allow for placement of the apparatus on the utility line while maintaining an appropriate distance between the UAV and the utility line, ensuring the UAV does not enter the electrical field of, for example, one or more live utility lines.

In some embodiments, the UAV may remain attached to the apparatus while the apparatus is traveling down the utility line and wrapping the line in layers of material. In some embodiments, the UAV may detach from the apparatus after the apparatus has been clamped onto the utility line and/or reattach at a later time, for example to allow the UAV to move the apparatus to the next section of utility line. In some embodiments, the UAV may reattach and/or relocate the apparatus when the apparatus is done operating, runs out of wrapping material, and/or encounters an obstacle. By allowing for detachment and/or reattachment of the apparatus by way of the extension arm, one UAV may drop off and pick up multiple apparatuses and/or allow work to be done at multiple sites along a utility line simultaneously.

In some embodiments, the attachment of the extension arm to the UAV may require a UAV landing pad that may allow the UAV to land with a modular extension arm attached. In some embodiments, the system may include a landing pad that may allow the UAV to land with the extension arm attached.

### IV. ROTATIONAL BATTERY SYSTEM

In some embodiments, the electromechanical system may include a rotational battery system. In some embodiments, the rotational battery system may enable the UAV and/or apparatus to operate and/or charge at the same time. In some embodiments, the rotational battery system may include a stem of three batteries. In some embodiments, a first battery may be charged while a second battery cools in advance of charging. A third battery may power the apparatus or UAV.

In some embodiments, the electromechanical system and/or apparatus may include a charging circuit that may draw parasitic power from the utility line to charge the UAV and/or the apparatus while the UAV and/or the apparatus is operating. In some embodiments, the circuit may convert the magnetic field energy produced by the live utility line into an electrical current that may be used to charge the battery. In some embodiments, a metallic rod may be fixed a set distance from the utility line, converting the strong magnetic field around the power line into a current inside the metallic rod, for example a magnetic field converter. The rod may be connected to a fuse and/or a voltage/current controller, for example circuitry that may control the charging of the battery. In some embodiments, the fuse and/or voltage/current controller may be housed in the electronics box, in addition to two batteries. In some embodiments, the electromechanical system may include three batteries in total, wherein two batteries may be housed in the electronics box under the UAV and/or one may be stored on board the UAV.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

### V. AERIAL POSITIONING DEVICE

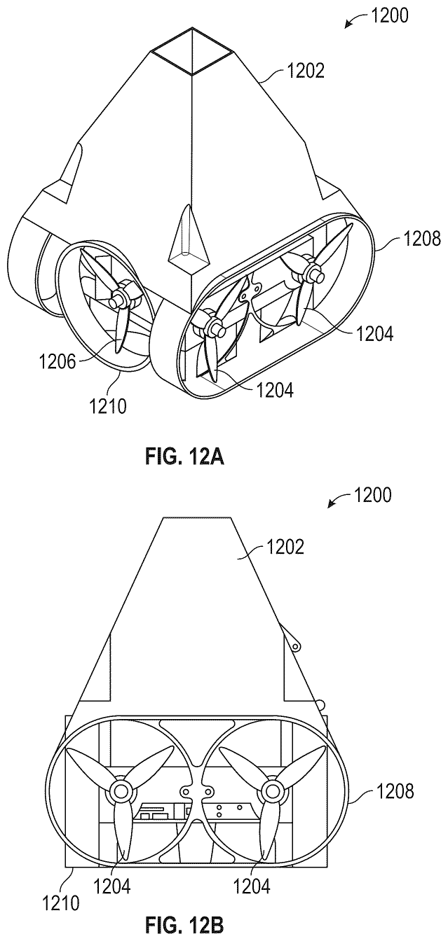

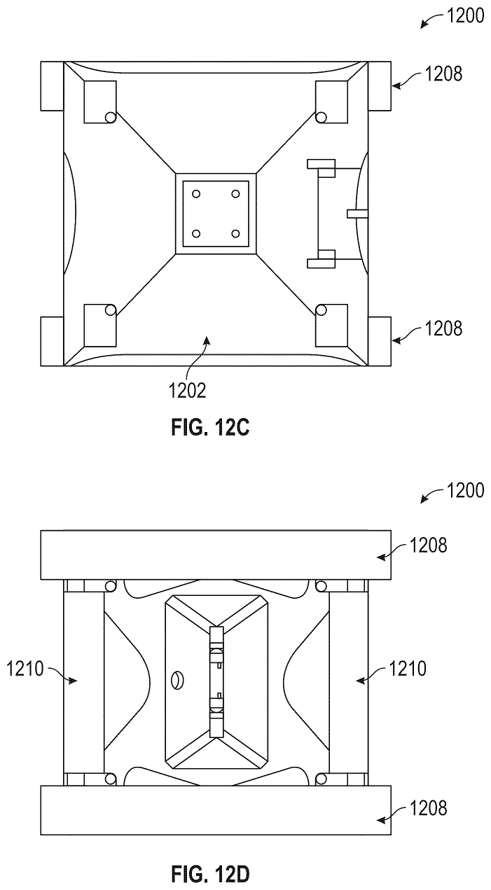

FIGS. 12A, 12B, 12C, and 12D depict an aerial positioning device 1200, in accordance with some embodiments. Specifically, FIG. 12A depicts a perspective view; FIG. 12B depicts a side view; FIG. 12C depicts an overhead view; and FIG. 12D depicts a bottom view.

Aerial positioning device 1200 may share any one or more characteristics in common with aerial positioning device 256 as described above with reference to FIGS. 2A and 2B.

Aerial positioning device 1200 may be disposed within system 240 and may function in the manner described above with respect to aerial positioning device 256 and system 240. For example, aerial positioning device 1200 may be suspended by a cable beneath UAV 250 and may be releasably attached to apparatus 260 which is itself suspended beneath aerial positioning device 1200. While the UAV from which aerial positioning device 1200 is suspended may provide primary (up to and including all) vertical lift for positioning system 240 above a power line and may also provide lateral positioning capabilities to move system 240 side to side and forward and backward, aerial positioning device 1200 may provide lateral thrust and/or rotational force that can be used to make adjustments to the lateral position and/or orientation of the assembly comprising aerial positioning device 1200 and apparatus 260 with respect to the lateral position and orientation of UAV 250. In this manner, aerial positioning device 1200 may be used to “fine tune” the lateral position and orientation of apparatus 260 as it is suspended over a power line, allowing for apparatus 260 to be laterally positioned and oriented in a precise manner before it is lowered onto the power line. In some embodiments, aerial positioning device 1200 may have no vertical thrust capabilities.

One advantage of this arrangement is that aerial positioning device 1200 is positioned at or near the bottom of the cable that extends downward from UAV 250. As noted above, suspending the assembly comprising apparatus 260 and aerial positioning device 1200 from a cable that extends down from UAV 250 may allow for UAV 250 to maintain a greater and safer distance from power lines.

However, a disadvantage of suspension apparatus 260 is that the lateral position of apparatus 260 will be less responsive to lateral position adjustments made by UAV 250. That is, when the lateral position of UAV 250 is adjusted, corresponding adjustment of the lateral position of apparatus 260 will temporally lag due to a pendulum effect induced by the lateral motion. Furthermore, the induced pendulum effect will cause unpredictable motion and make it difficult to precisely position apparatus 260. A similar disadvantageous effect applies with respect to rotational adjustments that are made by UAV 250. As with lateral position adjustments, rotational orientation adjustments by UAV 250 will induce a rotational response in the suspended apparatus 260 that temporally lags behind the rotation of UAV 250 and that induces a periodic torsional pendulum effect as the rotational motional is transmitted through the cable which will rotate with a spring-like torsional effect. These temporally lagging and periodic motion effects are difficult to predict and control if the only point of control is UAV 250 itself.

Accordingly, to address the disadvantageous effects explained above, aerial positioning device 1200 is positioned near or at the bottom of the cable suspended from UAV 250, and aerial positioning device 1200 is rigidly connected to apparatus 260. This allows for aerial positioning device 1200 to make lateral position and rotational orientation adjustments that are transmitted to apparatus 260 via the rigid connection between aerial positioning device 1200 and apparatus 260, rather than being transmitted through a flexible suspended cable. Thus, adjustments made to lateral position and rotational orientation of aerial positioning device 1200 are transmitted to apparatus 260 in an essentially immediate manner, and in a manner that does not induce any substantial undesirable pendulum effects.

Aerial positioning device 1200 may include one or more location sensors, positioning devices, gyroscopes, orientation sensors, altimeters, proximity sensors, and/or the like.

FIGS. 12A, 12B, 12C, and 12D show an exemplary configuration of aerial positioning device 1200. As shown, aerial positioning device 1200 may have a housing 1202 that may be made of a rigid material such as metal and/or plastic. Housing 1202 may have a generally conical shape, tapering from a broader base to a narrower top. The conical shape may allow for housing 1202 to house propulsion, control, and attachment subsystems near the bottom of aerial positioning device 1200 and may help to ensure that aerial positioning device 1200 has a low center of gravity, which may aid aerial positioning device 1200 in maintaining a level orientation with respect to the ground. The conical shape may in some embodiments serve to limit shaking of aerial positioning device 1200 under highly turbulent air conditions below UAV 250.

Aerial positioning device 1200 may include any suitable propulsion system(s) configured to provide lateral thrust and/or rotational torque. In the example shown in FIGS. 12A, 12B, 12C, and 12D, aerial positioning device 1200 is provided with lateral thrust and rotational torque by a set of propellors including side propellors 1204 and end propellors 1206.

End propellors 1206 may be oriented in the axial direction with respect to apparatus 260 when aerial positioning device 1200 is attached to aerial positioning device 1200, and end propellors 1206 may be positioned along an axial-direction center-line of aerial positioning device 1200. Thus, end propellors 1206 may provide for axial-direction thrust that provides axial direction adjustment of lateral position of aerial positioning device 1200 and apparatus 260. End propellors may be protected (and prevented from damaging other system components and/or power lines) by end propellor guards 1210, which may be formed as a part of housing 1202.

Side propellors 1204 may be oriented perpendicular to the axial direction with respect to apparatus 260 when aerial positioning device 1200 is attached to aerial positioning device 1200. Side propellors 1204 may be provided in pairs of two on each side. The side propellors 1204 in each pair may be mutually offset from a perpendicular-to-axial-direction center-line of aerial positioning device 1200. Thus, side propellors 1204 may provide for perpendicular-to-axial-direction thrust that provides perpendicular-to-axial direction adjustment of lateral position of aerial positioning device 1200 and apparatus 260. Side propellors 1204 may also provide for rotational adjustment of aerial positioning device 1200 by taking advantage of their offset-from-centerline positioning. For example, if two of side propellors 1204 that are positioned diagonally opposite one another are counter-rotated with respect to one another, rotation of aerial positioning device 1200 may be induced. Side propellors 1204 may be protected (and prevented from damaging other system components and/or power lines) by side propellor guards 1208, which may be formed as a part of housing 1202.

The example propellors described above contemplate fixed-orientation propellors, all of which are oriented parallel or perpendicular to the axial direction of apparatus 260 when it is attached to aerial positioning device 1200. However, in some embodiments, one or more propellors of aerial positioning device 1200 may have an adjustable orientation (in the vertical and/or horizontal direction) with respect to aerial positioning device 1200.

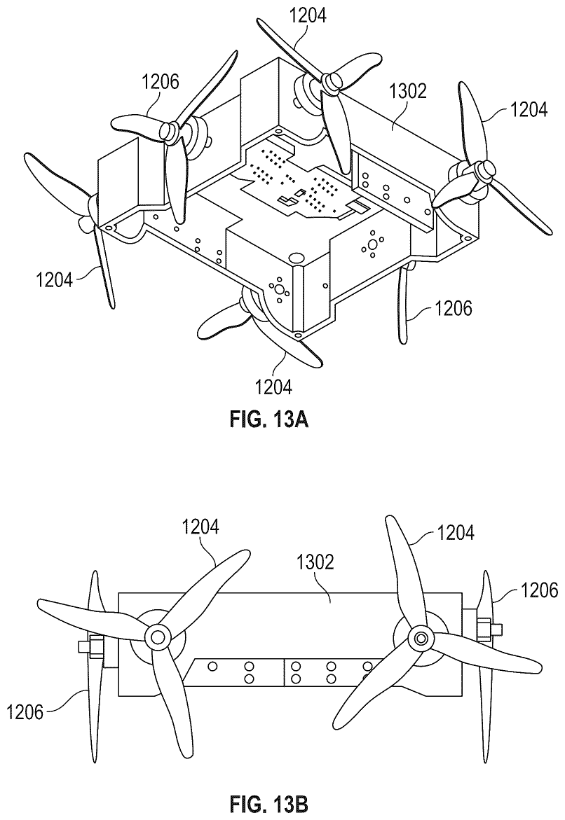

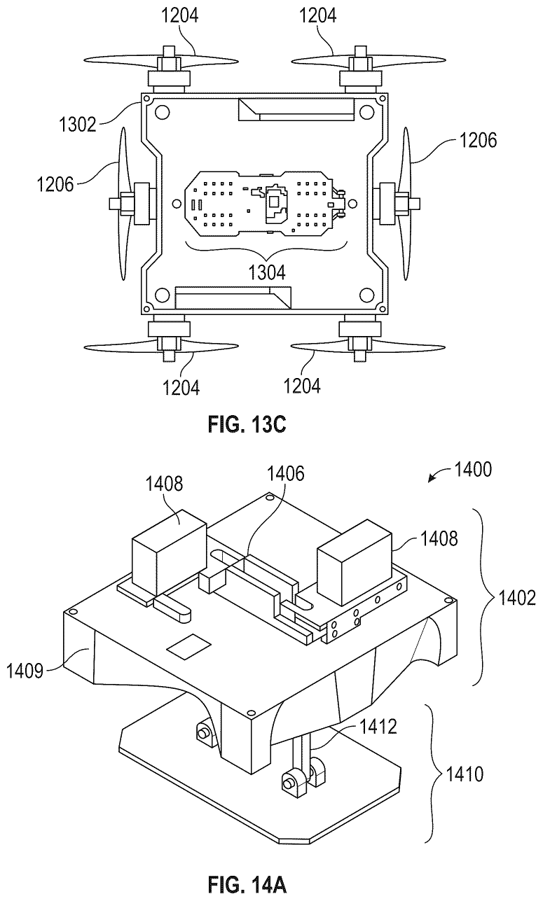

FIGS. 13A, 13B, and 13C depict an internal frame, propellors, and electronic controller systems of aerial positioning device 1200. Specifically, FIG. 12A depicts a perspective view; FIG. 13B depicts a side view; and FIG. 13C depicts an overhead view.

As shown in FIGS. 13A, 13B, and 13C, aerial positioning device 1200 may include frame 1302 to which propellors 1204 and 1206 may be mounted. Frame 1302 may be made of a rigid material, such as metal or plastic. Frame 1302 may be formed unitarily.

Aerial positioning device may also include electronic controller systems 1304, which may be directly or indirectly physically mounted to frame 1302 and which may be electrically connected to propellors 1204 and/or 1206 and configured to control rotation of propellors 1204 and/or 1206. In some embodiments, each propellor 1204 and/or 1206 may be individually driven by a motor that may be controlled by a speed controller of electronic controller systems 1304. In some embodiments electronic controller systems 1304 may also include a controller that performs motion mixing of the various motors and associated propellors to achieve the desired lateral and rotational control.

While FIGS. 12A, 12B, 12C, 12D, 13A, 13B, and 13C illustrate an embodiment of aerial positioning device 1200 in which propellor-based propulsion is used, additional or alternative means of generating propulsion and/or torque for aerial positioning device 1200 may be utilized in some embodiments. For example, in some embodiments, a momentum wheel, reaction wheel, or other angular-momentum-based device may be used to adjust orientation of aerial positioning device.

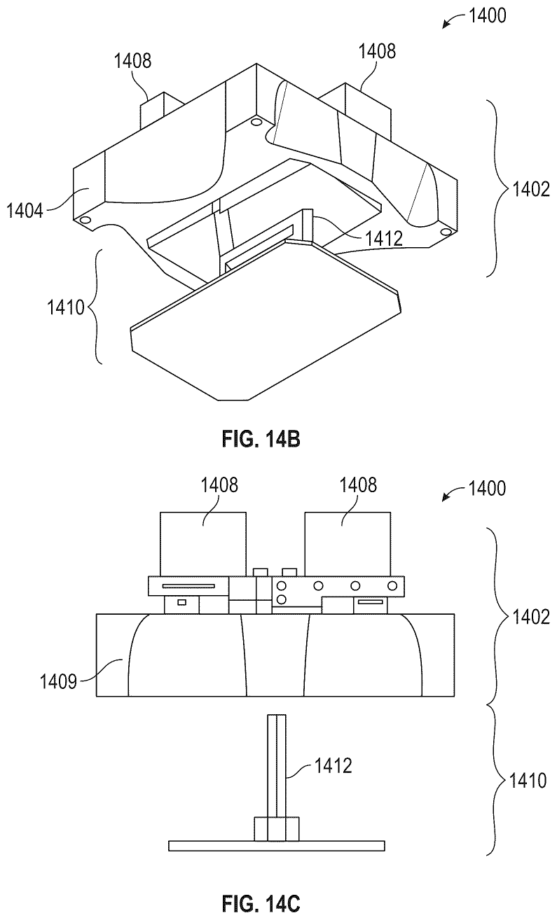

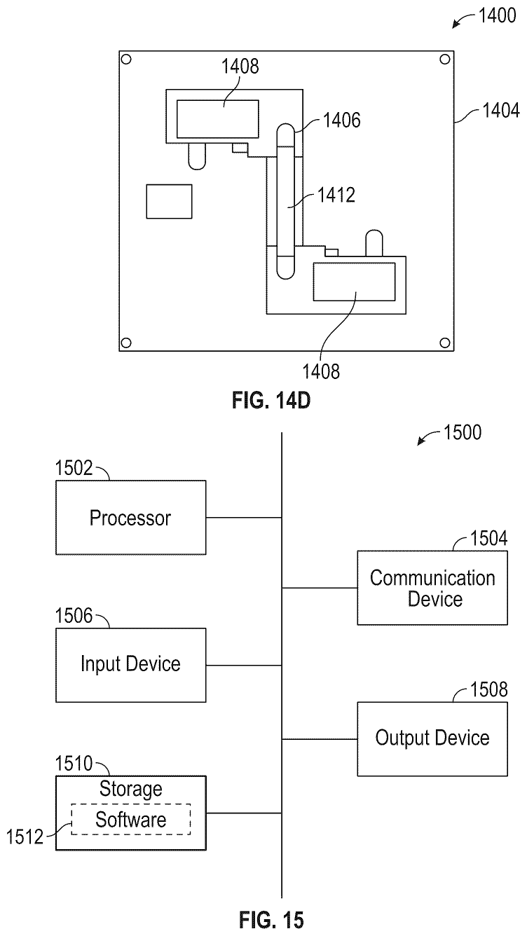

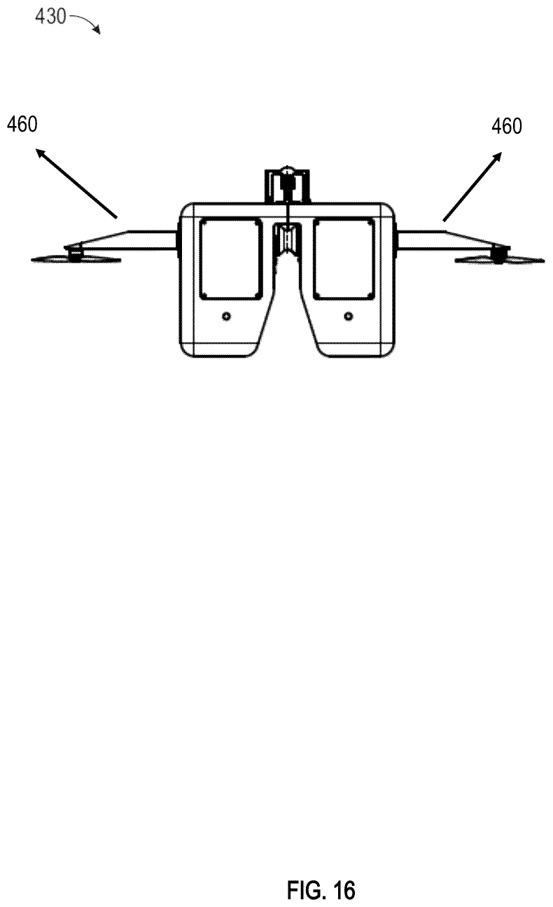

FIGS. 14A, 14B, 14C, and 14D depict attachment system 1400, in accordance with some embodiments. Specifically, FIG. 14A depicts a top perspective view; FIG. 14B depicts a bottom perspective view ; FIG. 14C depicts a side view; and FIG. 14D depicts a top view.

Attachment system 1400 may serve to rigidly and releasably attach an aerial positioning device such as aerial positioning device 256 or aerial positioning device 1200 (the following description will refer to aerial positioning device 1200 by way of example) to an apparatus such as apparatus 260.

As shown in FIGS. 14A, 14B, and 14C, attachment system 1400 may include aerial positioning device attachment subsystem 1402, which may form an upper portion of attachment system 1400; and may include apparatus positioning subsystem 1410, which may form a lower portion of attachment system 1400. Aerial positioning device attachment subsystem 1402 may be provided as part of aerial positioning device 1200, and apparatus positioning subsystem 1410 may be provided as part of apparatus 260. The two subsystems 1402 and 1410 may be configured to releasably and rigidly attach to one another. In the example shown, the subsystems may releasably attach to one another by physical mating of components, including handle 1412 inserting into slot 1406. After insertion of handle 1412 into slot 1406, attachment system servomechanism 1408 may drive pins, latches, bolts, cams, or the like to secure handle 1412 in place in slot 1406.

Attachment system 1400 may include alignment base 1404, which may comprise sloped alignment surfaces that help to control orientation of aerial positioning device 1200 relative to apparatus positioning subsystem 1410 as the two subsystems 1402 and 1410 prepare to mate, by guiding the two subsystems into the desired alignment with one another as the sloped surface of alignment base 1404 presses and slides against a portion of apparatus positioning subsystem 1410.

In some embodiments, alternative or additional means for rigidly and releasably attaching the two subsystems 1402 and 1410 may be utilized. For example, electromagnetic attachment, hook-and-loop attachment, suction attachment, and/or other mechanical attachment means may be used.

In some embodiments, attachment system 1400 may comprise a breakaway safety mechanism that allows for subsystems 1402 and 1410 to decouple under a threshold amount of mechanical force or in response to the detection (e.g., by electronic sensors) of one or more conditions. Including a safety breakaway mechanism may allow for detachment under unexpected or emergency conditions in order to prevent or minimize damage or harm to components of system 240 and/or to surrounding persons, devices, buildings, or systems.

### VI. COMPUTER SYSTEM

FIG. 15 depicts a computer system 1500, in accordance with some embodiments. Computing system 1500 can be a client or a server. As shown in FIG. 15, computing system 1500 can be any suitable type of processor-based system, such as a personal computer, workstation, server, handheld computing device (portable electronic device) such as a phone or tablet, or dedicated device. The computing system 1500 can include, for example, one or more of input device 1520, output device 1530, one or more processors 1510, storage 1540, and communication device 1560. Input device 1520 and output device 1530 can either be connectable or integrated with computing system 1500.

Input device 1520 can be any suitable device that provides input, such as a touch screen, keyboard or keypad, mouse, gesture recognition component of a virtual/augmented reality system, or voice-recognition device. Output device 1530 can be or include any suitable device that provides output, such as a display, touch screen, haptics device, virtual/augmented reality display, or speaker.

Storage 1540 can be any suitable device that provides storage, such as an electrical, magnetic, or optical memory including a RAM, cache, hard drive, removable storage disk, or other non-transitory computer readable medium. Communication device 1560 can include any suitable device capable of transmitting and receiving signals over a network, such as a network interface chip or device. The components of the computing system 1500 can be connected in any suitable manner, such as via a physical bus or wirelessly.

Processor(s) 1510 can be any suitable processor or combination of processors, including any of, or any combination of, a central processing unit (CPU), field programmable gate array (FPGA), and application-specific integrated circuit (ASIC). Software 1550, which can be stored in storage 1540 and executed by one or more processors 1510, can include, for example, the programming that provides the functionality or portions of the functionality of the present disclosure (e.g., as described with respect to the systems and methods, as described above).

Software 1550 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1540, that can contain or store programming for use by or in connection with an instruction execution system, apparatus, or device.

Software 1550 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport computer-readable medium can include, but is not limited to, an electronic, magnetic, optical, electromagnetic, or infrared wired or wireless propagation medium.

Computing system 1500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computing system 1500 can implement any operating system suitable for operating on the network. Software 1550 can be written in any suitable programming language, such as C, C++, Java, or Python. In various aspects, application software providing the functionality of the present disclosure can be deployed in different configurations, such as in a client/server arrangement or through a Web browser as a Web-based application or Web service, for example.

### VI. EXEMPLARY EMBODIMENTS

The following embodiments are exemplary and are not intended to limit the scope of the invention or inventions described herein. Exemplary embodiments include:

Embodiment 1. An apparatus for insulating live utility lines, the apparatus comprising one or more subsystems comprising:
(a) an attachment subsystem;
(b) a material-wrapping subsystem;
(c) a material-clamping subsystem; and/or
(d) a material-cutting subsystem;
   wherein the apparatus is delivered to the utility line by an unmanned aerial vehicle (UAV).

Embodiment 2. The apparatus of embodiment 1, wherein the apparatus is attached to the UAV by one or more extension arms.

Embodiment 3. The apparatus of embodiment 2, wherein the extension arms are capable of extension and retraction.

Embodiment 4. The apparatus of claim 2 or 3, wherein the extension arms are retracted during the flight of the UAV and extend to position the apparatus on the utility line.

Embodiment 5. The apparatus of any one of embodiments 2-4, wherein the angle of attachment between the extension arms and an electronics box of the UAV and/or the extension arms and the apparatus can be altered.

Embodiment 6. The apparatus of any of embodiments 1-5, wherein the attachment subsystem comprises an upper bearing and a lower bearing, wherein the upper bearing and the lower bearing come together to clamp the utility line between them.

Embodiment 7. The apparatus of embodiment 6, wherein the upper bearing and lower bearing are aligned by way of one or more guide rails.

Embodiment 8. The apparatus of embodiment 6 or 7, wherein the clamping of the utility line between the upper bearing and the lower bearing serves to affix the apparatus to the utility line.

Embodiment 9. The apparatus of any of embodiments 6-8, wherein the upper bearing is affixed to the rest of the subsystem by way of an upper block and the lower bearing is affixed to the rest of the subsystem by way of a lower block.

Embodiment 10. The apparatus of any of embodiments 6-9, wherein the lower block is lifted and lowered by an actuator that attaches and detaches the apparatus from the utility line.

Embodiment 11. The apparatus of any of embodiments 1-10, wherein the apparatus travels the length of the utility line by way of a motor.

Embodiment 12. The apparatus of any of embodiments 1-11, wherein the material-wrapping subsystem comprises a tape holder comprising one or more rolls of one or more types of material to be wrapped around the utility line.

Embodiment 13. The apparatus of embodiment 12, wherein the one or more types of material comprises a semi-conductive material, an insulating material, durable fabric material, a waterproof material, and/or an anti-abrasion material.

Embodiment 14. The apparatus of embodiment 12 or 13, wherein the material-wrapping subsystem comprises a “C” shaped gear rotating piece.

Embodiment 15. The apparatus of any of embodiments 12-14, wherein the “C” shaped gear is driven by one or more gears that are attached to one or more motors.

Embodiment 16. The apparatus of any of embodiments 12-15, wherein the turning of the “C” shaped gear wraps the one or more rolls of material around the utility line as the apparatus travels the length of the utility line.

Embodiment 17. The apparatus of any of embodiments 12-16, wherein the material-wrapping subsystem wraps the utility line in one or more layers of material.

Embodiment 18. The apparatus of any of embodiments 12-17, wherein the layers of material comprise one or more layers of a semi-conductive material, one or more layers of an insulating material, and one or more layers of a durable fabric material.

Embodiment 19. The apparatus of embodiment 18, wherein the durable fabric material is a waterproof material and/or an anti-abrasion material.

Embodiment 20. The apparatus of embodiment 13, wherein the insulating material comprises polyimide.

Embodiment 21. The apparatus of embodiment 12, wherein the one or more types of material comprises a film or tubing that comprises a fluoropolymer.

Embodiment 22. The apparatus of embodiment 21, wherein the film or tubing comprises at least 50% or more fluoropolymer.

Embodiment 23. The apparatus of any of embodiments 1-22, wherein clamps are placed over the layers of wrapped material on the utility line by the material-clamping subsystem.

Embodiment 24. The apparatus of embodiment 23, wherein the material-clamping subsystem applies a clamp around the wrapped utility line at the beginning of the wrapped layers of material and at the end of the wrapped layers of material.

Embodiment 25. The apparatus of embodiment 23 or 24, wherein the material-clamping subsystem comprises:
(a) a clamp pusher comprising a spring-loaded magazine housing the clamps and a linear actuator to lift the clamp onto and around the utility line; and
(b) a clamp tightener comprising a tubing and an actuator to squeeze and tighten the claim around the outer layer of material wrapped around the utility line.

Embodiment 26. The apparatus of embodiment 1, wherein the material-cutting subsystem comprises a linear actuator and a cutting blade, wherein the material-cutting subsystem cuts the layers of material that have been wrapped around the utility line.

Embodiment 27. The apparatus of embodiment 26, wherein the material-cutting subsystem is used in place of the material-clamping subsystem.

Embodiment 28. An apparatus for cooling live utility lines, the apparatus comprising one or more subsystems comprising:
(a) an attachment subsystem;
(b) a material-wrapping subsystem;
(c) a material-clamping subsystem; and/or
(d) a material-cutting subsystem; wherein the apparatus is delivered to the utility line by an unmanned aerial vehicle (UAV).

Embodiment 29. The apparatus of embodiment 28, wherein the material-wrapping subsystem comprises wrapping the utility line in a film or tubing that comprises a fluoropolymer.

Embodiment 30. The apparatus of embodiment 29, wherein the film or tubing comprises at least 50% or more fluoropolymer.

Embodiment 31. The apparatus of embodiment 28, wherein the material-wrapping subsystem comprises wrapping the utility line in a layer of material that serves to passively cool the utility line.

Embodiment 32. The apparatus of embodiments 28 or 31, wherein the material comprising the cooling layer comprises a Passive Radiative Cooling (PRC) film or similar passive-cooling technology.

Embodiment 33. The apparatus of any of embodiments 1-32, wherein the apparatus comprises a charging circuit that draws parasitic power from the utility line to charge the apparatus while operating.

Embodiment 34. The apparatus of any of embodiments 1-33, wherein the apparatus comprises a rotational battery system, wherein the system comprises three batteries wherein the first battery is charged, a second battery cools in advance of charging, and a third battery powers the apparatus or UAV simultaneously.

Embodiment 35. A method for reducing wildfire risk caused by the contacting of live utility lines with vegetation, wherein the method comprises the wrapping of live utility lines with one or more layers of material by an apparatus, wherein the apparatus comprises one or more subsystems comprising:
(a) an attachment subsystem;
(b) a material-wrapping subsystem;
(c) a material-clamping subsystem; and/or
(d) a material-cutting subsystem; wherein the apparatus is delivered to the utility line by an unmanned aerial vehicle (UAV).

Embodiment 36. The method of embodiment 35, wherein the apparatus is attached to the UAV by one or more extension arms.

Embodiment 37. The method of embodiment 36, wherein the extension arms are capable of extension and retraction.

Embodiment 38. The method of any one of embodiments 36 or 37, wherein the extension arms are retracted during the flight of the UAV and extend to position the apparatus on the utility line.

Embodiment 39. The method of any one of embodiments 36-38, wherein the angle of attachment between the extension arms and the electronics box and/or the extension arms and the apparatus can be altered.

Embodiment 40. The method of any of embodiments 35-39, wherein the attachment subsystem comprises an upper bearing and a lower bearing, wherein the upper bearing and the lower bearing come together to clamp the utility line between them.

Embodiment 41. The method of embodiment 40, wherein the upper bearing and lower bearing are aligned by way of one or more guide rails.

Embodiment 42. The method of embodiment 40 or 41, wherein the clamping of the utility line between the upper bearing and the lower bearing serves to affix the apparatus to the utility line.

Embodiment 43. The method of any of embodiments 40-42, wherein the upper bearing is affixed to the rest of the subsystem by way of an upper block and the lower bearing is affixed to the rest of the subsystem by way of a lower block.

Embodiment 44. The method of any of embodiments 40-43, wherein the lower block is lifted and lowered by an actuator that attaches and detaches the apparatus from the utility line.

Embodiment 45. The method of any of embodiments 35-44, wherein the apparatus travels the length of the utility line by way of a motor.

Embodiment 46. The method of embodiment 35, wherein the material-wrapping subsystem comprises a tape holder comprising one or more rolls of one or more types of material to be wrapped around the utility line.

Embodiment 47. The method of embodiment 46, wherein the one or more types of material comprises a semi-conductive material, an insulating material, durable fabric material, a waterproof material, and/or an anti-abrasion material.

Embodiment 48. The method of embodiment 46 or 47, wherein the material-wrapping subsystem comprises a “C” shaped geared rotating piece.

Embodiment 49. The method of any of embodiments 46-48, wherein the “C” shaped gear is driven by one or more gears that are attached to one or more motors.

Embodiment 50. The method of any of embodiments 46-49, wherein the turning of the “C” shaped gear wraps the one or more rolls of material around the utility line as the apparatus travels the length of the utility line.

Embodiment 51. The method of any of embodiments 46-49, wherein the material-wrapping subsystem wraps the utility line in one or more layers of material.

Embodiment 52. The method of any of embodiments 46-51, wherein the layers of material comprise one or more layers of a semi-conductive material, one or more layers of an insulating material, and one or more layers of a durable fabric material.

Embodiment 53. The method of embodiment 52, wherein the durable fabric material is a waterproof material and/or an anti-abrasion material.

Embodiment 54. The method of embodiment 47, wherein the insulating material comprises polyimide.

Embodiment 55. The method of embodiment 47, wherein the one or more types of material comprises a film or tubing that comprises a fluoropolymer.

Embodiment 56. The method of embodiment 55, wherein the film or tubing comprises at least 50% or more fluoropolymer.

Embodiment 57. The method of any of embodiments 35-56, wherein clamps are placed over the layers of wrapped material on the utility line by the material-clamping subsystem.

Embodiment 58. The method of embodiment 57, wherein the material-clamping subsystem applies a clamp around the wrapped utility line at the beginning of the wrapped layers of material and at the end of the wrapped layers of material.

Embodiment 59. The method of embodiment 57 or 58, wherein the material-clamping subsystem comprises:
(a) a clamp pusher comprising a spring-loaded magazine housing the clamps and a linear actuator to lift the clamp onto and around the utility line; and
(b) a clamp tightener comprising a tubing and an actuator to squeeze and tighten the claim around the outer layer of material wrapped around the utility line.

Embodiment 60. The method of embodiment 35, wherein the material-cutting subsystem comprises a linear actuator and a cutting blade, wherein the material-cutting subsystem cuts the layers of material that have been wrapped around the utility line.

Embodiment 61. The method of embodiment 60, wherein the material-cutting subsystem is used in place of the material-clamping subsystem.

Embodiment 62. The method of embodiment 35, wherein the material-wrapping subsystem comprises wrapping the utility line in a layer of material that serves to passively cool the utility line.

Embodiment 63. The method of embodiment 62, wherein the material comprising the cooling layer comprises a Passive Radiative Cooling (PRC) film or similar passive-cooling technology.

Embodiment 64. The method of any of embodiments 35-63, wherein the apparatus comprises a charging circuit that draws parasitic power from the utility line to charge the apparatus while operating.

Embodiment 65. The method of any of embodiments 35-64, wherein the apparatus comprises a rotational battery system, wherein the system comprises three batteries wherein the first battery is charged, a second battery cools in advance of charging, and a third battery powers the apparatus or UAV simultaneously.

Embodiment 66. An apparatus for wrapping material around a utility line, the apparatus comprising:
one or more wheels configured to engage with the utility line and facilitate controlled movement of the apparatus along a length of the utility line; and
a material-wrapping subsystem, wherein the material-wrapping subsystem comprises:
   at least one reel configured to hold at least one roll of material; and
   at least one motor configured to move the at least one reel in an orbital path around the utility line to wrap the utility line using the at least one roll of material as the apparatus moves along the length of the utility line.

Embodiment 67. The apparatus of embodiment 66, wherein the apparatus further comprises:
an attachment subsystem comprising an upper bearing and a lower bearing, wherein at least one of the upper bearing or the lower bearing is moveable to clamp the utility line between the upper bearing and the lower bearing.

Embodiment 68. The apparatus of embodiment 67, wherein the apparatus further comprises one or more guide rails for aligning the upper bearing and the lower bearing.

Embodiment 69. The apparatus of embodiment 67, wherein the clamping of the utility line between the upper bearing and the lower bearing removably attaches the apparatus to the utility line.

Embodiment 70. The apparatus of embodiment 67, Wherein:
the upper bearing is attached to an upper block and the lower bearing is attached to a lower block; and
   the lower block is moved using an actuator to clamp the utility line between the upper bearing and the lower bearing.

Embodiment 71. The apparatus of any of embodiments 67-70, wherein at least one of the lower bearing or the upper bearing is rotated by a motor to move the apparatus along the length of the utility line.

Embodiment 72. The apparatus of embodiment 66, wherein the material-wrapping subsystem further comprises:
a drive pulley wheel coupled to the at least one motor;
   a plurality of driven pulley wheels coupled to the drive wheel; and
   a plurality of guide wheels attached to the plurality of driven pulley wheels and coupled to a plate mounted to the at least one reel;
   wherein rotation of the at least one motor causes rotation of the drive pulley wheel, the plurality of driven pulley wheels, the plurality of guide wheels, and the plate mounted to the at least one reel; and
   wherein rotation of the plate mounted to the at least one reel causes the at least one reel to move in an orbital path around a center point of the material-wrapping subsystem to wrap the utility line using the at least one roll of material.

Embodiment 73. The apparatus of embodiment 72, wherein:
the material-wrapping subsystem further comprises a timing belt that couples the drive pulley wheel to the plurality of driven pulley wheels; and
the plurality of guide wheels, to couple to the plate mounted to the at least one reel, contact a slot within the plate.

Embodiment 74. The apparatus of embodiment 66, wherein the at least one material of the at least one roll of material is selected from the set consisting of: electrically semi-conductive, electrically insulating, heat-shrinkable durable, waterproof, and anti-abrasion.

Embodiment 75. The apparatus of embodiment 74, wherein the at least one material comprises a film or tubing that comprises a fluoropolymer.

Embodiment 76. The apparatus of embodiment 75, wherein the film or tubing comprises at least 50% or more fluoropolymer.

Embodiment 77. The apparatus of embodiment 74, wherein the at least one material comprises at least one of a polyimide or a Passive Radiative Cooling (PRC) film.

Embodiment 78. The apparatus of embodiment 66, wherein the material-wrapping subsystem is configured to wrap the utility line in one or more layers of material.

Embodiment 79. The apparatus of embodiment 78, wherein the one or more materials of the one or more layers of material is selected from the set consisting of: electrically semi-conductive, electrically insulating, heat-shrinkable, durable, waterproof, and anti-abrasion.

Embodiment 80. The apparatus of embodiment 79, wherein the one or more materials comprise a film or tubing that comprises a fluoropolymer.

Embodiment 81. The apparatus of embodiment 80, wherein the film or tubing comprises at least 50% or more fluoropolymer.

Embodiment 82. The apparatus of embodiment 79, wherein the one or more materials comprise at least one of a polyimide or a Passive Radiative Cooling (PRC) film.

Embodiment 83. The apparatus of embodiment 66, wherein the apparatus further comprises:
a material-heating subsystem placed downstream of the material-wrapping subsystem.

Embodiment 84. The apparatus of embodiment 83, wherein the material-heating subsystem comprises one or more laser diodes to heat the material wrapped around the utility line.

Embodiment 85. The apparatus of embodiment 83, wherein the material-heating subsystem comprises resistance wire to heat the material wrapped around the utility line.

Embodiment 86. The apparatus of embodiment 83, wherein material-heating subsystem comprises a fan, a heating element, and a nozzle, wherein the fan is configured to blow air across the heating element and through a nozzle; and wherein the nozzle is configured to direct heated air onto the material wrapped around the utility line by the material-wrapping subsystem.

Embodiment 87. The apparatus of embodiment 66, wherein the apparatus further comprises a material-clamping subsystem configured to place one or more clamps around the material wrapped around the utility line.

Embodiment 88. The apparatus of embodiment 87, wherein the material-clamping subsystem is configured to apply the one or more clamps around at least one of a beginning of the material wrapped around the utility line or an end of the material wrapped around the utility line.

Embodiment 89. The apparatus of embodiment 87, wherein the material-clamping subsystem comprises:
a clamp pusher comprising:
a spring-loaded magazine housing one or more clamps; and
a linear actuator configured to lift the one or more clamps onto the utility line; and
a clamp tightener comprising:
a tubing; and
an actuator configured to squeeze and tighten the one or more clamps around the material wrapped around the utility line.

Embodiment 90. The apparatus of embodiment 66, wherein the apparatus further comprises a material-cutting subsystem, wherein:
the material-cutting subsystem comprises a linear actuator and a cutting blade; and
the material-cutting subsystem is configured to cut the material wrapped around the utility line.

Embodiment 91. The apparatus of embodiment 66, wherein the apparatus further comprises a charging circuit configured to draw parasitic power from the utility line to charge the apparatus.

Embodiment 92. The apparatus of embodiment 66, wherein the apparatus further comprises a rotational battery system, wherein:
the rotational battery system comprises three batteries;
each battery is assigned one state selected from a group comprising: charging, cooling, and powering the apparatus; and
the state of each battery is dependent on the state of the other batteries in the rotational battery system.

Embodiment 93. A system for transporting and aligning an apparatus for wrapping material around a utility line, the system comprising:
an unmanned aerial vehicle for transporting the apparatus to the utility line;
an aerial positioning device connected to the unmanned aerial vehicle and configured to align the apparatus with the utility line; and
one or more couplings for connecting to the apparatus.

Embodiment 94. The system of embodiment 93, wherein the aerial positioning device comprises one or more propellers configured to move the apparatus in at least one horizontal direction to align the apparatus with the utility line.

Embodiment 95. The system of embodiment 94, wherein the one or more propellors have a fixed orientation with respect to the aerial positioning device.

Embodiment 96. The system of embodiment 94, wherein the one or more propellors have an adjustable orientation with respect to the aerial positioning device.

Embodiment 97. The system of embodiment 93, wherein the aerial positioning device comprises one or more propellers configured to move the apparatus in at least two horizontal directions to align the apparatus with the utility line.

Embodiment 98. The system of embodiment 93, wherein the aerial positioning device comprises one or more propellers configured to adjust a rotational orientation of the apparatus with the utility line.

Embodiment 99. The system of embodiment 96, wherein the one or more propellers are oriented perpendicular with respect to an operative axial center-line of the aerial positioning device that is configured to be aligned with the utility line for placement of the apparatus on the utility line, and wherein the one or more propellers are off-center with respect to an operative perpendicular-to-axial center-line of the aerial positioning device.

Embodiment 100. The system of embodiment 93, wherein the aerial positioning device comprises a wheel device wheel configured to adjust a rotational orientation of the apparatus with the utility line, the wheel device selected from the set consisting of: a reaction wheel and a momentum wheel.

Embodiment 101. The system of embodiment 93, wherein the aerial positioning device provides no vertical thrust.

Embodiment 102. The system of embodiment 93, wherein the aerial positioning device has a conical shape.

Embodiment 103. The system of embodiment 93, wherein the aerial positioning device further comprises a winch connected to the unmanned aerial vehicle and the aerial positioning device and configured to move the apparatus in a vertical direction to install the apparatus on the utility line or uninstall the apparatus from the utility line.

Embodiment 104. The system of embodiment 93, wherein the one or more couplings comprise at least one of a hook-and-loop coupling or an electromagnetic coupling.

Embodiment 105. The system of embodiment 93, wherein the one or more couplings comprise one or more pins driven by a servomechanism.

Embodiment 106. The system of embodiment 93, wherein the one or more couplings are provided as part of the aerial positioning device.

Embodiment 107. A method of operating a system for transporting and aligning an apparatus for wrapping material around a utility line, the method comprising:
operating an unmanned aerial vehicle to transport the apparatus to the utility line;
operating an aerial positioning device connected to the unmanned aerial vehicle to align the apparatus with the utility line and install the apparatus onto the utility line; and
detaching one or more couplings connecting the apparatus to the aerial positioning device.

Embodiment 108. The method of embodiment 107, wherein at least one of operating the unmanned aerial vehicle or operating the aerial positioning device is based on at least one of an operator's eyesight or a camera located on at least one of the unmanned aerial vehicle or the aerial positioning device.

Embodiment 109. The method of embodiment 107, wherein operating an aerial positioning device comprises moving the apparatus in at least one horizontal direction to align the apparatus with the utility line.

Embodiment 110. The method of embodiment 107, wherein operating an aerial positioning device comprises moving the apparatus in at least two horizontal directions to align the apparatus with the utility line.

Embodiment 111. The method of embodiment 107, wherein operating an aerial positioning device comprises moving the apparatus in a vertical direction to install the apparatus on the utility line or uninstall the apparatus from the utility line.

Embodiment 112. The method of embodiment 107, wherein detaching the one or more couplings connecting the apparatus to the aerial positioning device comprises moving the aerial positioning device to detach at least one hook-and-loop coupling.

Embodiment 113. The method of embodiment 107, wherein detaching the one or more couplings connecting the apparatus to the aerial positioning device comprises modifying an electrical current flowing to at least one electromagnetic coupling.

Embodiment 114. The method of embodiment 107, the method further comprising operating the apparatus to:
move the apparatus along the utility line;
wrap at least one material around the utility line; and
heat the at least one material to attach it to the utility line.

Embodiment 115. The method of embodiment 107, the method further comprising:
operating the unmanned aerial vehicle to transport the aerial positioning device to the utility line;
operating the aerial positioning device connected to the unmanned aerial vehicle to align the aerial positioning device with the apparatus;
attaching the one or more couplings connecting the apparatus to the aerial positioning device; and
operating the unmanned aerial vehicle to transport the apparatus to a second utility line or a maintenance station.

Embodiment 116. The method of embodiment 114, wherein the at least one material comprises a film, wrap, or tubing comprising a fluoropolymer.

Embodiment 117. The method of embodiment 116, wherein the film, wrap, or tubing comprises at least 50% or more fluoropolymer.

Embodiment 118. A utility line covered with layers of material, wherein the layers comprise
(i) one or more layers comprising a semi-conductive material;
(ii) one or more layers comprising an insulating material; and
(iii) one or more layers comprising a durable, waterproof, and/or anti-abrasion material, wherein the semi-conductive material comprises an innermost layer closest to the utility line, and the durable, waterproof, and/or anti-abrasion material comprises an outermost layer furthest from the utility line.

Embodiment 119. The utility line of embodiment 118, wherein the semi-conductive material, the insulating material, and/or the durable, waterproof, and/or anti-abrasion material is a tape or wrap capable of being wrapped around the utility line.

Embodiment 120. The utility line of embodiments 118 or 119, wherein the layers of material prevent or reduce the occurrence of wildfires by lessening the contact of the utility line with vegetation.

Embodiment 121. The utility line of any of embodiments 118-120, wherein the utility line is an installed utility line.

Embodiment 122. The utility line of any of embodiments 118-121, wherein the utility line is a live utility line.

Embodiment 123. The utility line of any of embodiments 118-122, wherein the outermost layer comprises a material comprising at least 10%, 15%, 20%, 25%, 30%, 35%, 40%, 45%, 50%, 55%, 60%, 65%, 70%, 75%, 80%, 85%, 90%, 95% fluoropolymer.

Embodiment 124. The utility line of embodiment 123, wherein the fluoropolymer comprises one or more of PTFE (polytetrafluoroethylene), PFA (perfluoroalkoxy fluorocarbon), FEP (fluorinated ethylene-propylene), PCTFE (polychlorotrifluoroethylene), ETFE (ethylene tetrafluoroethylene), ECTFE (ethylene chlorotrifluoroethylene), and PVDF (polyvinylidene fluoride).

Embodiment 125. The utility line of embodiment 123 or 124, wherein the fluoropolymer comprises ETFE (ethylene tetrafluoroethylene).

Embodiment 126. The utility line of any of embodiments 118-125, wherein the outermost layer comprises a material comprising at least 10%, 15%, 20%, 25%, 30%, 35%, 40%, 45%, 50%, 55%, 60%, 65%, 70%, 75%, 80%, 85%, 90%, 95% ETFE.

Embodiment 127. A utility line covered with layers of material, wherein the layers comprise
(i) one layer comprising a semi-conductive nylon tape;
(ii) three layers comprising a silicone tape; and
(iii) one layer comprising a fluoropolymer, wherein the semi-conductive nylon tape comprises the innermost layer closest to the utility line, and the fluoropolymer layer comprises the outermost layer furthest from the utility line.

Embodiment 128. The utility line of embodiment 127, wherein the order of the layers of the material from closest to the utility line to furthest from the utility line is: one layer of the semi-conductive nylon tape, three layers comprising a silicone tape, and one layer comprising a fluoropolymer.

Embodiment 129. The utility line of any of embodiments 118-128, wherein an inorganic material is integrated into the outermost layer.

Embodiment 130. The utility line of any of embodiments 118-128, wherein an inorganic material is layered into the outermost layer.

Embodiment 131. The utility line of embodiments 129 or 130, wherein the inorganic material comprises one or more of mica, glass, synthetic mica, large flake muscovite made into a thin flexible film (hand laid mica on kapton), boron nitride, alumina, silica, titanium dioxide, silicon nitride, montmorillonite, calcium silicate, and zinc oxide.

Embodiment 132. The utility line of any of embodiments 118-131, wherein the outermost layer is heated to activate self-sealing.

Embodiment 133. The utility line of any of embodiments 118-132, wherein the outermost layer is waterproof and abrasion-resistant.

Embodiment 134. A method for reducing the fire danger of a utility line, comprising wrapping one or more layers of materials around the utility line, wherein at least one of the layers of material comprises a material comprising a fluoropolymer.

Embodiment 135. The method of embodiment 134, wherein the material comprising a fluoropolymer comprises a material comprising at least 10%, 15%, 20%, 25%, 30%, 35%, 40%, 45%, 50%, 55%, 60%, 65%, 70%, 75%, 80%, 85%, 90%, 95% fluoropolymer.

Embodiment 136. The method of embodiment 134 or 135, wherein the fluoropolymer comprises one or more of PTFE (polytetrafluoroethylene), PFA (perfluoroalkoxy fluorocarbon), FEP (fluorinated ethylene-propylene), PCTFE (polychlorotrifluoroethylene), ETFE (ethylene tetrafluoroethylene), ECTFE (ethylene chlorotrifluoroethylene), and PVDF (polyvinylidene fluoride).

Embodiment 137. The method of any one of embodiments 134-136, wherein the fluoropolymer comprises ETFE (ethylene tetrafluoroethylene).

Embodiment 138. The method of any one of embodiments 134-137, wherein the one or more layers of material further comprise one or more layers of a semi-conductive material and one or more layers of insulating material.

Embodiment 139. The method of embodiment 138, wherein the semi-conductive material is selected from the set consisting of: ethylene propylene rubber (EPR); ethylene propylene diene monomer (EPDM) rubber; and nylon.

Embodiment 140. The method of embodiment 138 or 139, wherein the insulating material is selected from the set consisting of: rubber, polyethylene, silicone, fiberglass, aluminum, ethylene propylene, thermal-based ceramic powder, polyvinyl chloride, and polyimide.

Embodiment 141. The method of any one of embodiments 134-140, wherein an inorganic material is integrated into the fluoropolymer layer.

Embodiment 142. The method of any one of embodiments 134-140, wherein an inorganic material is layered into the fluoropolymer layer.

Embodiment 143. The method of embodiment 141 or 142, wherein the inorganic material comprises one or more of mica, glass, synthetic mica, large flake muscovite made into a thin flexible film (hand laid mica on kapton), boron nitride, alumina, silica, titanium dioxide, silicon nitride, montmorillonite, calcium silicate, and zinc oxide.

Embodiment 144. The method of any one of embodiments 134-143, wherein the fluoropolymer layer is heated to activate self-sealing.

Embodiment 145. The method of any of embodiments 134-144, wherein the fluoropolymer layer is waterproof and abrasion-resistant.

Embodiment 146. The method of any one of embodiments 134-145, wherein the wrapping of the materials around the utility line is performed in a factory setting.

Embodiment 147. The method of any one of embodiments 134-145, wherein the wrapping of the materials around the utility line is performed on a pre-existing, installed utility line.

Embodiment 148. The method of any one of embodiments 134-145, wherein the wrapping of the materials around the utility line is performed on a live pre-existing, installed utility line.

Embodiment 149. The method of embodiment 148, wherein the primary voltage of the live utility line is over 100V, 200V, 300V, 400V, 500V, 600V, 700V, 800V, 900V, or 1000V.

Embodiment 150. The method of embodiment 148 or 149, wherein the primary voltage of the live utility line is over 600V.

Embodiment 151. The method of any one of embodiments 134-150, wherein the wrapping is performed by an apparatus, wherein the apparatus comprises:
one or more wheels configured to engage with the utility line and facilitate controlled movement of the apparatus along a length of the utility line; and
a material-wrapping subsystem, wherein the material-wrapping subsystem comprises:
   at least one reel configured to hold at least one roll of material; and
   at least one motor configured to move the at least one reel in an orbital path around the utility line to wrap the utility line using the at least one roll of material as the apparatus moves along the length of the utility line.

1. A method for wrapping a material around a utility line, the method comprising providing control instructions for:
operating an unmanned aerial vehicle to transport an apparatus to the utility line;
aligning the apparatus with the utility line;
and installing the apparatus onto the utility line;
detaching one or more couplings connecting the apparatus to the unmanned aerial vehicle;
wrapping the material, using the apparatus, around the utility line in a live state;
removing the apparatus from the utility line after cutting the material.

2. The method of claim 1, wherein operating the unmanned aerial vehicle comprises moving the apparatus in at least one horizontal direction to align the apparatus with the utility line.

3. The method of claim 1, wherein operating the unmanned aerial vehicle comprises moving the apparatus in a vertical direction to install the apparatus on the utility line or uninstall the apparatus from the utility line by unmanned aerial vehicle.

4. The method of claim 1, wherein detaching the one or more couplings comprises moving the unmanned aerial vehicle to detach at least one hook-and-loop coupling.

5. The method of claim 1, wherein detaching the one or more couplings comprises modifying an electrical current flowing to at least one electromagnetic coupling.

6. The method of claim 1, the method further comprising providing control instructions for operating the apparatus to:
move the apparatus along the utility line; and
heat the material to attach it to the utility line.

7. The method of claim 1, the method further comprising:
operating the unmanned aerial vehicle to align an aerial positioning device with the apparatus;
attaching the apparatus to the aerial positioning device; and
operating the unmanned aerial vehicle to transport the apparatus to a second utility line or a maintenance station.

8. The method of claim 6, wherein the material comprises a film, wrap, or tubing.

9. A method for reducing the fire danger of a live utility line, comprising wrapping a thin flexible tape composed of a material around the live utility line, using an apparatus delivered to the live utility line by unmanned aerial vehicle.

10. The method of claim 9, wherein the material comprises at least 10%, 15%, 20%, 25%, 30%, 35%, 40%, 45%, 50%, 55%, 60%, 65%, 70%, 75%, 80%, 85%, 90%, 95% fluoropolymer.

11. The method of claim 9, wherein the fluoropolymer comprises one or more of PTFE (polytetrafluoroethylene), PFA (perfluoroalkoxy fluorocarbon), FEP (fluorinated ethylene-propylene), PCTFE (polychlorotrifluoroethylene), ETFE (ethylene tetrafluoroethylene), ECTFE (ethylene chlorotrifluoroethylene), and PVDF (polyvinylidene fluoride).

12. The method of claim 9 further comprising wrapping, using the apparatus, one or more layers of a semi-conductive material and one or more layers of insulating material about the live utility line.

13. The method of claim 12, wherein the semi-conductive material is selected from the set consisting of: ethylene propylene rubber (EPR); ethylene propylene diene monomer (EPDM) rubber; and nylon.

14. The method of claim 12, wherein the insulating material is selected from the set consisting of: rubber, polyethylene, silicone, fiberglass, aluminum, ethylene propylene, thermal-based ceramic powder, polyvinyl chloride, and polyimide.

15. The method of claim 9, wherein the thin flexible tape has a thickness from 1-10 millimeters.

16. The method of claim 9, wherein the live utility line comprises a distribution system utility line.

17. The method of claim 16, wherein the primary voltage of the live utility line is over 600V.

18. The method of claim 9, wherein the apparatus comprises:
one or more wheels configured to engage with the live utility line and facilitate controlled movement of the apparatus along a length of the live utility line; and
a material-wrapping subsystem, wherein the material-wrapping subsystem comprises:
at least one reel configured to hold at least one roll of material; and
at least one motor configured to move the at least one reel in an orbital path around the utility line to wrap the utility line using the at least one roll of material as the apparatus moves along the length of the utility line.

19. A method comprising: controlling partial discharge associated with a live utility line, by wrapping a set of thin flexible tapes composed of one or more materials around the live utility line.

20. The method of claim 19, wherein the set of thin flexible tapes comprises a first semi-conductive tape, a second insulating tape, and a third environmental barrier tape.
